(19) United States
(12) Patent Application Publication
(10) Pub. No.: US 2004/0078326 A1
(43) Pub. Date: Apr. 22, 2004

(54) Data processing system

(76) Inventors: Johan Lamprecht Theron Strydom, Cape Town (ZA); David Thomas Oosthuizen, Durban (ZA); Lidija Popvic, Sandton (ZA); Liesl Ehlers, Cape Town (ZA); Johan Theodorus Grobler, Cape Town (ZA); Anthony Moss, Cape Town (ZA)

Correspondence Address: JOEL D. SKINNER, JR., SKINNER AND ASSOCIATES, 212 COMMERCIAL ST., HUDSON, WI, 54016, US

(21) Appl. No.: 10/416,142

(22) PCT Filed: Nov. 6, 2001
(86) PCT No.: PCT/IB01/02076

(30) Foreign Application Priority Data
Nov. 6, 2000 (ZA) 2000/6346

(51) Int. Cl. G06F 17/60

(52) U.S. Cl. 705/39; 705/40

(57) ABSTRACT

A web-based data processing system providing subscribers with a facility to open an Internet bank account directly, an online shopping facility and various other services. The system includes a central computing facility including a transaction manager server (12) and a client administration system (CAS) server (14) which are connected to banking servers (16, 18) of a banking institution (20). The transaction manager server (12) is connected to various merchants, via an online shopping facility (22) and a plurality of different e-commerce websites (24). The server (14) handles client user interfaces, whereas the server (12) interfaces with the banking servers and online shopping facility (22) and the e-commerce websites (24). The transaction manager handles all transactions and external communications between the various servers. The central computing facility monitors data processing carried out between remote client devices and the merchants and the banking institution and records the data in a client administration database.

### FIELD OF INVENTION

THIS INVENTION relates to a data processing system and to a method of controlling data processing in the system. It also relates to a method of establishing a bank account in an automated fashion and to a data processing system for displaying consolidated client data for a plurality of clients.

Data processing systems for conducting online services, such as those for the purchase of goods and/or services over the internet, are well known. In order to purchase the goods and/or services, the user of the data processing system must have a credit card and feeds in the appropriate credit card details to purchase goods and/or services. Further, the user typically visits a particular web site to purchase services and the transaction is then carried out between the user and the online service provider. Thereafter, the online service provider obtains the funds for the purchase from a bank with which the credit card is associated. Thus, the user interacts with a particular service provider which then, in turn, processes the transactions with the credit card authorities. In a similar fashion, the user may carry out financial transactions and process bank details. Each individual service provider may independently track user transactions but does not provide a consolidated user position as the user visits each service provider independently.

It is to be appreciated that the invention described in this specification may be applied in an internet environment, an interactive television (TV) environment, a WAP environment, a PDA environment, or the like. Further, for the purposes of this specification, the term “merchant” should be interpreted broadly to include any provider of goods and/or services via an electronic medium herein referred to as “online”.

### SUMMARY OF INVENTION

According to a first aspect of the invention there is provided a data processing system which includes

a plurality of remote merchant servers of at least one merchant, which are operable to offer at least one of predetermined goods and services, to users of remote devices, online;

at least one remote banking institution server of at least one banking institution, which is operable to facilitate payment for goods and services which are purchased online from the merchant by users of the remote devices; and

a central computing facility including at least one central server which is operable to communicate with the remote devices and with the merchant servers and the banking institution server, the central server including a banking institution interface for interfacing with the banking institution server and a merchant interface for interfacing with the merchant servers, thereby to facilitate online transactions and communications between the banking institution, the merchant and the users of the remote devices, the central computing facility being operable to monitor data processing carried out between each remote device and the banking institution server and to retrieve user banking data relating to a particular user, from the banking institution and merchant transaction data from merchant with whom the user transacts and to communicate the banking data and the merchant transaction data to a remote device that is accessible to the user, thereby to provide the user with a consolidated data position.

The central computing facility may be operable to maintain a record of transactions carried out by users with the merchant servers and the banking institution server, the central computing facility including a user administration database in which said banking data and merchant transaction data pertaining to each user, is stored.

The merchant servers and the banking institution server may be arranged in modules, thereby allowing merchant servers of different merchants and banking institution servers of different banking institutions to be added and removed from the system with relative ease.

Each merchant server may have a system payment facility which when selected by a user to pay for goods or services, directs the user to the central server of the central computing facility which is operable to transmit an instructional message to the banking institution server to instruct the banking institution to reserve funds for the transaction.

The users typically have debit-type bank accounts. It is to be appreciated, however, that the user accounts may be any type of account associated with monetary value, e.g. credit card, saving or the like.

The remote devices may be in the form of personal computers (PC's). It is, however, important to appreciate that the system is not restricted to remote devices in the form of PC's but may also include WAP devices, interactive TV devices, PDA devices, or the like. In order to facilitate the description of the invention, it is described predominantly with reference to an internet environment.

Typically, the merchants provide investment details, insurance details, shopping facilities, or the like. The central computing facility may thus retrieve selected financial transaction data stored within the system and retrieve or poll remote merchant servers to obtain further transaction data for display. The central computing facility typically provides a web site to provide this functionality.

According to a second aspect of the invention there is provided a data processing system which includes

a plurality of remote merchant servers of at least one merchant, which are operable to offer at least one of predetermined goods and services, to users of remote devices, online;

at least one remote banking institution server of at least one banking institution, which is operable to facilitate payment for goods and services which are purchased online from the merchant by users of the remote devices; and

a central computing facility including at least one central server which is operable to communicate with the remote devices and with the merchant servers and the banking institution server, the central server including a banking institution interface for interfacing with the banking institution server and a merchant interface for interfacing with the merchant servers, each merchant server having a system payment facility which when selected by a user to pay for goods or services, directs the user to the central server of the central computing facility which is operable to transmit an instructional message to the banking institution server to instruct the banking institution to reserve funds for the transaction.

According to a third aspect of the invention there is provided a method of controlling data processing in a data processing system including a plurality of remote merchant servers of at least one merchant, which are operable to offer at least one of predetermined goods and services, to users of remote devices, online; at least one remote banking institution server of at least one banking institution, which is operable to facilitate payment for goods and services which are purchased online from the merchant by users of the remote devices; and a central computing facility including at least one central server which is operable to communicate with the remote devices and with the merchant servers and the banking institution server, the method including providing on each merchant server a system payment facility which, when selected by a user to pay for goods or services, directs the user to the central server of the central computing facility which then communicates with the banking institution server to reserve funds for the transaction.

The central computing facility may transmit an instructional message to the banking institution server to reserve funds for the transaction, whereafter the banking institution verifies the availability of funds for the transaction and if sufficient funds are available, reserves the funds required for the transaction and thereafter releases the funds to a designated payee to complete the transaction.

According to a fourth aspect of the invention there is provided a central computing facility which includes at least one central server which is operable to communicate with

a) a plurality of remote devices,

b) a plurality of remote merchant servers of at least one merchant which are operable to offer at least one of predetermined goods and services, to users of the remote devices, online,

c) at least one remote banking institution server of at least one banking institution, which is operable to facility payment for goods and services which are purchased online from the merchant by users of the remote devices,

the central server including a banking institution interface for interfacing with the banking institution server and a merchant interface for interfacing with the merchant servers, thereby to facilitate online transactions and communications between the banking institution, the merchant and the users of the remote devices, the central computing facility being operable to monitor data processing carried out between each remote device and the banking institution server and each merchant server, and to retrieve banking data relating to a particular user, from the banking institution and merchant transaction data from merchant with whom the user transacts and to communicate that banking data and the merchant transaction data to a remote device that is accessible to the user, thereby to provide the user with a consolidated data position.

The central computing facility may be operable to maintain a record of transactions carried out by users, with the merchant servers and the banking institution server, the central computing facility including a user administration database in which said banking data and merchant transaction data pertaining to each user, is stored

### BRIEF DESCRIPTION OF THE DRAWINGS

The invention is now described, by way of example, with reference to the accompanying diagrammatic drawings. In the drawings:

FIG. 1 shows a schematic block diagram of a web-based data processing system in accordance with the invention;

FIG. 2 shows a schematic block diagram of the service interaction provided by a web site of the system;

FIG. 3 shows a schematic block diagram of a client consolidated page of the system;

FIG. 4 shows a schematic block diagram of a voucher facility of the system;

FIG. 5 shows a schematic block diagram of various modules of functional areas of the system;

FIG. 6 shows a schematic block diagram of an operational overview of the system;

FIG. 7 shows a schematic block diagram of the location of various servers of the system interconnected via the Internet;

FIG. 8 shows a high level schematic block diagram of the interaction between a CAS server and various clients;

FIG. 9 shows a more detailed schematic block diagram of the interaction between the CAS server and the various clients;

FIG. 10 shows a schematic block diagram of a message data dictionary of the system;

FIG. 11 shows a high level schematic block diagram of a message formatter;

FIG. 12 shows a further schematic block diagram of the message formatter;

FIG. 13 shows a schematic block diagram of the TBM system environment;

FIG. 14 shows the transaction manager processes;

FIGS. 15 to 22 provide details on various processes and their associated actions;

FIG. 23 shows a schematic entity relationship diagram of the transaction manager;

FIG. 24 shows a high level schematic block diagram of how an account is opened at the banking institution for a new client;

FIG. 25 shows a schematic flow chart of the client access, registration, and maintenance procedures;

FIG. 26 shows a schematic flow chart of the client registration procedure;

FIG. 27 shows a schematic flow chart of the logon process;

FIGS. 27A to 27H show various logon screens of the system;

FIG. 28 shows a screen display of the client registration procedure;

FIG. 28A shows a screen display of an Internet banking logon procedure;

FIG. 29 shows a schematic block diagram of the flow process during registration of a user at the banking institution;

FIG. 30 shows a schematic block diagram of the client registration procedure during first time logon;

FIG. 31 shows a screen display generated by the system for client profile customisation;

FIG. 32 shows a further screen layout for client profile customisation;

FIG. 33 shows a screen layout of a consolidated position of various services or facilities offered by the system;

FIG. 34 shows a schematic block diagram of the client consolidation process;

FIGS. 35 and 36 show screen layouts used in the client customisation process;

FIG. 37 shows an example of a screen layout of the facility to customise a profile and, in particular, to delete an address;

FIG. 38 shows an example of a screen layout of a banking aspect of the system;

FIG. 39 shows a further example of a screen layout of the banking aspect;

FIG. 40 shows a screen layout for creating a further account;

FIG. 41 shows a screen layout of a client profile customisation facility;

FIG. 42 shows a schematic block diagram of the process for validating a user name and for tracking clients;

FIG. 43 shows a schematic block diagram of the tracking process of FIG. 42;

FIG. 44 shows the CAS administration process for bank maintenance;

FIG. 45 shows a screen layout when the bank tab on the web site is selected;

FIG. 46 shows a screen layout of the form for creating a bank;

FIG. 47 shows a screen layout of a bank detail confirmation screen;

FIG. 48 shows a screen layout for creating a bank product;

FIG. 49 shows a screen layout for confirming a bank product;

FIG. 50 shows a screen layout for creating a bank card;

FIG. 51 shows a screen layout for confirming a bank card;

FIG. 52 shows a screen layout of a form for obtaining contact details;

FIG. 53 shows a screen layout for creating a branch of a bank;

FIG. 54 shows a screen layout for editing a bank;

FIG. 55 shows a screen layout of a bank product list;

FIG. 56 shows a screen layout for editing a bank product;

FIG. 57 shows a screen layout for editing a bank card;

FIG. 58 shows a screen layout for confirming a bank card change;

FIG. 59 shows a screen layout for editing bank product contact person details;

FIG. 60 shows screen layouts of further branch lists;

FIG. 61 shows a screen layout for editing a bank branch;

FIG. 62 shows a screen layout for confirming removal of a bank;

FIG. 63 shows a schematic block diagram of the CAS administration product maintenance process;

FIG. 64 shows a screen layout of a product category list;

FIG. 65 shows a screen layout for creating a new product category;

FIG. 66 shows a screen layout of a product provider list;

FIG. 67 shows a screen layout for creating a new product provider;

FIG. 68 shows a further screen layout of the product list including product maintenance facilities;

FIG. 69 shows a screen layout for creating a new product;

FIG. 70 shows a screen layout for confirmation a new product;

FIG. 71 shows a screen layout for creating a product contact;

FIG. 72 shows a screen layout for creating/editing a product (bank transfer);

FIGS. 73A and 73B show screen layouts for editing a category of a provider or merchant;

FIG. 74 shows a further screen layout for editing a product;

FIG. 75 shows a screen layout of a bank transfer list for a particular product;

FIG. 76 shows a screen layout of a contact list for a particular product;

FIG. 77 shows a screen layout for creating/editing contact details of a particular product;

FIG. 78 shows screen layout listing outlets of a particular product;

FIG. 79 shows a screen layout for creating/editing an outlet;

FIG. 80 shows a screen layout showing voucher types;

FIG. 81 shows the CAS administration process for client maintenance;

FIGS. 82A to 821 show screen layouts of functions that may be executed in regard to clients;

FIG. 83 shows a merchant's screen layout relating to the vouchers;

FIG. 84 shows a screen layout of a form for a merchant to change contact details;

FIG. 85 shows a screen layout of a summary of transactions provided to a merchant which have taken place;

FIG. 86 shows a screen layout of voucher details which the merchant may inspect;

FIGS. 87 to 95 show various screen layouts of the stock brokerage web site;

FIGS. 96 to 98 show various screen layouts of a comparative insurance web site of the system;

FIG. 99 shows a schematic process overview of the housekeeping module or eBroom;

FIG. 100 shows an example of a screen display of the eBroom;

FIG. 101 shows a screen layout of a report function selection form;

FIG. 102 shows a schematic flow chart of the process for creating a report;

FIG. 103 shows a schematic block diagram of the process for running a report; and

FIG. 104 shows a schematic block diagram of the process for editing a report.

### DESCRIPTION OF THE PREFERRED EMBODIMENTS

Referring to the drawings, reference numeral 10 generally indicates a web-based data processing system in accordance with the invention.

The system 10 provides a web site providing subscribers or registered users with enhanced services/facilities. As described in more detail below, a facility to open an. Internet bank account directly, a shopping facility, a facility to purchase/view/sell stock online, a facility to obtain comparative insurance, and links to various other web sites are provided. The system 10 generates vouchers for use by the subscribers or registered users which may be used at any merchant in the system, vouchers which may only be used at a specific merchant/participant, generic discount vouchers, or the like. Thus, the system 10 allows a registered user to create a bank account at one or more banking institutions and then perform financial transactions with or without the use of vouchers. Further, the system 10 provides the registered user with consolidated financial data showing the current status of the user with all the merchants i.e. statements relating to the bank account, purchases, or the like. The data processing system 10 is also referred to herein as the TBM or icanonline system.

The system 10 includes a transaction manager server 12 and a client administration system (CAS) server 14. The servers 12, 14 are connected to a remote Internet banking server 16 and a remote banking system server 18 of a banking institution 20. Further, the transaction manager server 12 is connected to remote merchant servers of an online shopping facility 22 and a plurality of different web sites 24. Likewise, the CAS server 14 is connected to the web sites 24 which, in particular, include a stockbrokerage web site 26, a comparative insurance web site 28, and various other web sites generally indicated by reference numeral 30. The stockbrokerage web site 26 is connected to a financial institution 29. The CAS server 14 includes a CAS module 32 which is connected to a user front end 34. The user front end 34 is connected to a plurality of users via the Internet. In use, a user logs into a web site provided by the system 10 and is allowed selective access to various data processing functions or services offered by the system 10. Access to certain aspects of the web site are restricted to registered users.

The specific embodiment of the invention is described with reference to personal computers connected to the Internet. It is however important to appreciate that the invention may be applied in a WAP environment, interactive TV environment, POA environment or the like.

The client administration system server 14 handles the client user interfaces and the client registration process which occurs via the Internet. The transaction manager server 12 handles all transactions and external communications between the various servers forming part of the system 10. Accordingly, the transaction manager server 12 includes a communications module 36 and a transaction controller 38. The banking institution 20 includes back office systems that handle bank account and financial transactions and the Internet banking server 16 provides a facility so that a client can access his/her bank account and perform standard Internet banking tasks. Merchants forming part of the shopping facility 22 optionally elect to provide their clients with the facility to use the system 10 as an alternative payment method. Accordingly, there is a direct interface between “icanonline”, generally indicated by reference numeral 40 and the conventional Transact System, which is the currently known order management system used by Internet shopping web sites. The financial institution 29 is a stockbroker connected to the stockbrokerage web site 26 which allows a user to invest on a stock exchange, for example, the Johannesburg Stock Exchange in South Africa.

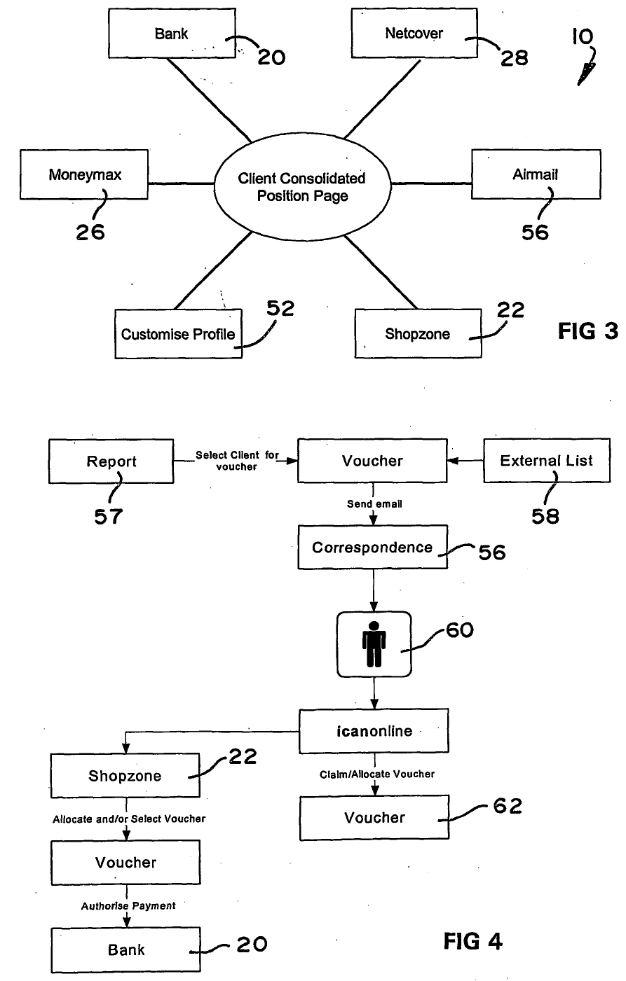

Referring in particular to FIG. 2 of the drawings, reference numeral 42 generally indicates the service interaction provided by the icanonline web site of the system 10. The web site allows users to be added as shown at 44, a facility to update details of a user as shown at 46, a facility to allow authentication of a user as shown at 48, and selected additional requests as shown at 49. In FIG. 3, a client consolidated position of the various facilities or services offered by the system 10 is shown. The user has access to the banking institution 20, the comparative insurance web site 28, the stockbrokerage web site 26, the online shopping facility 22, a facility to customise the user's profile as shown at 51, and an airmail facility 56 which allows mail, e.g. e-mail, or the like to be sent to the user.

As described in more detail below, the system 10 selectively rewards a user with vouchers which may be used to purchase services and/or goods via the system 10. Vouchers may be generated from a report as shown at 54 or from an external list as shown at 55. The voucher generated is then sent via e-mail to the user 57 who can then claim or allocate a voucher as shown at 59 or use the voucher in the online shopping facility 22. The user 57 may allocate and/or select a voucher which may or may not be of sufficient value to purchase goods or, in addition, may use the voucher as partial payment and authorise payment for the balance by the banking institution 20.

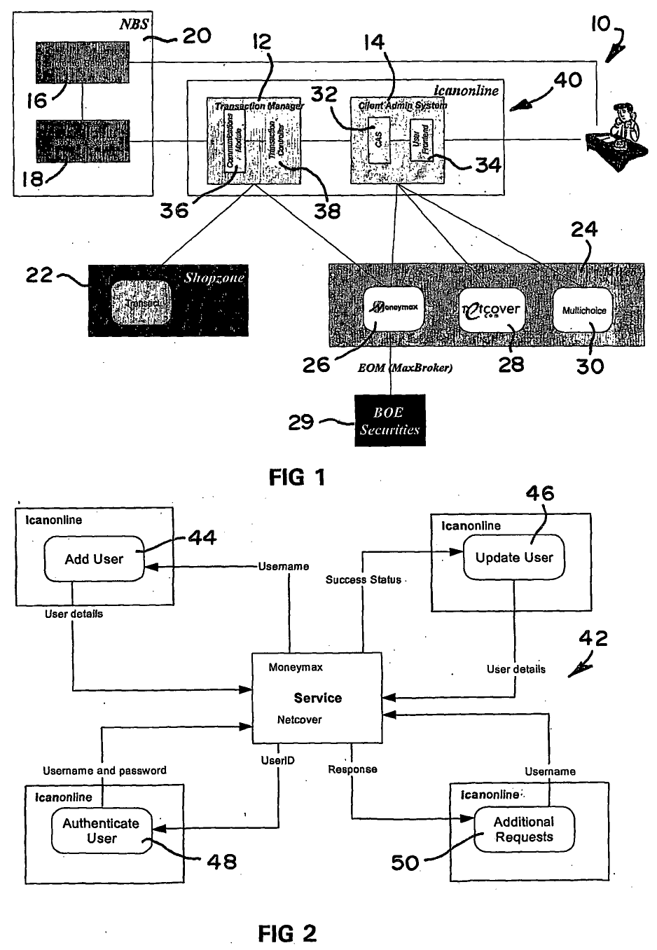

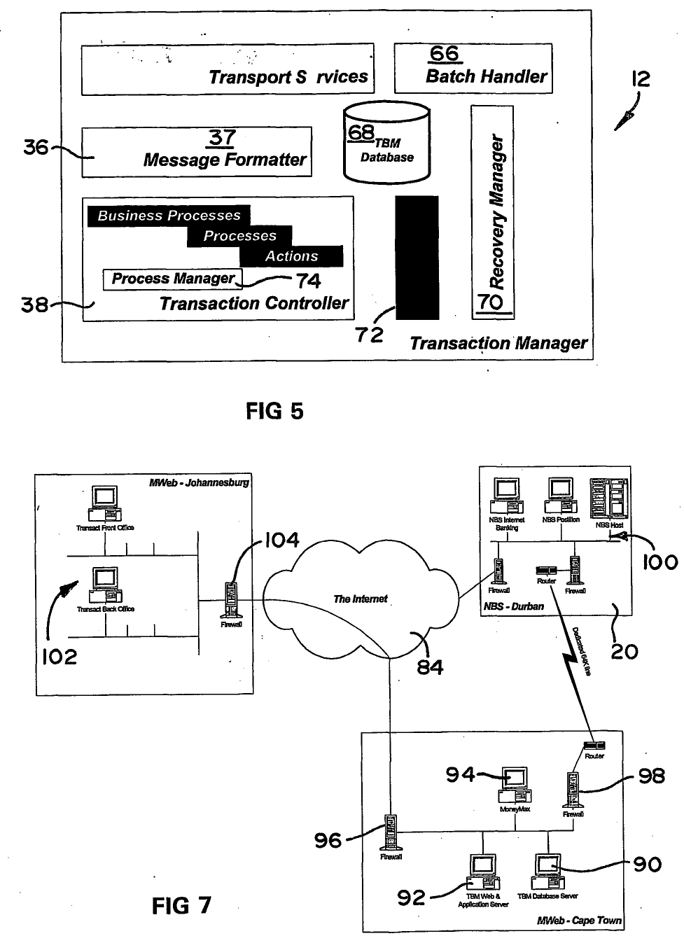

The transaction manager server 12 includes various modules of functional areas (see FIG. 5). In particular, the transaction manager server 12 includes a transport services module 61, a batch handler module 66, a system database 65, a recovery manager module 70, and XML utilities 69. The transaction controller 38 provides business processes, general processes and various actions which are executed by a process manager 71. The transport services module 61 forms part of the communications module 36 (see FIG. 1) and is responsible for the sending and receiving of messages and information to any external server connected to the system 10. In the embodiment depicted in the drawings, the transport services module 61 uses TCP/IP protocols to communicate with the banking institution 20 and the Transact System of the online shopping facility 22. The communications module 36 includes a message formatter 37 which defines each particular message dependant upon its recipient server. In particular, the messages are formatted to correspond with various message layouts from XML (which is used for the internal format) to specific formats required e.g. by the banking institution 20, the Transact System, or the like. Messages received from the various external servers are also formatted into an XML format for internal processing. Accordingly, the XML utility 69 is provided to handle the XML data for internal use. The recovery manager module 70 is arranged to bring the system 10 to the state in which it was prior to a system crash. The batch handler module 66 uploads all batch files received and schedules the corresponding batch processing of data in the system 10. The transaction controller 28 (see FIG. 1) handles the execution of all transactions in the system 10 and is also the mechanism through which external applications interface with the functionality of the system 10 with the assistance of the process manager 71. As described in more detail below, the transaction manager server 12 keeps a record or audit of transactions to allow a client consolidated position to be displayed.

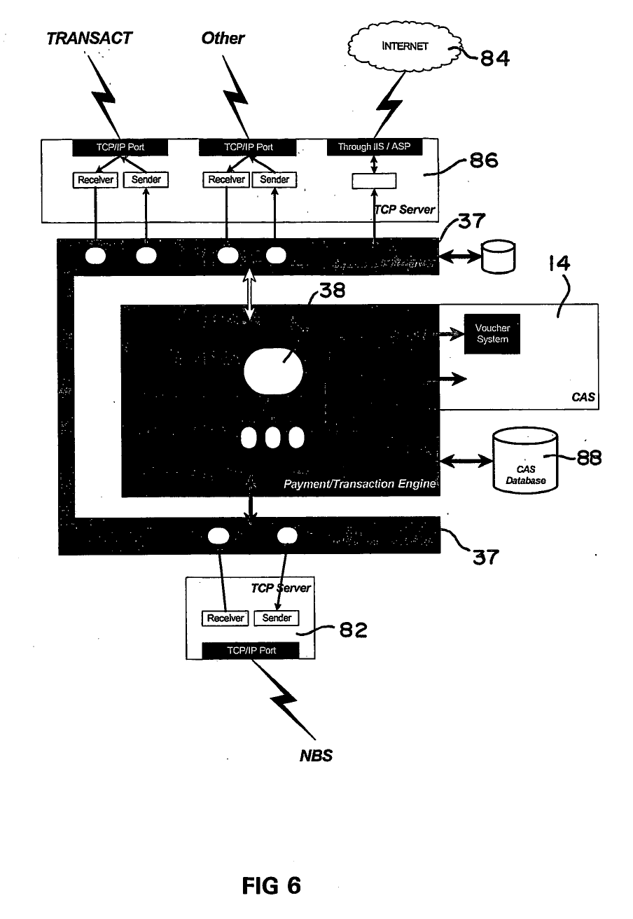

Referring in particular to FIG. 6 of the drawings, reference numeral 80 generally indicates an operational overview of the system 10. As can be seen from the overview 80, the transaction controller 38 is interfaced via the message formatter 37 to the banking institution 20 via a TCP server 82, and to the Internet 84, other interfaces, and the Transact System via a further TCP server 86. The transaction controller 38 is also connected to the CAS server 14 and to a CAS database 88. FIG. 7 shows the location of the various servers connected via the Internet 84. In the present embodiment, a TBM database server 90 including the CAS database 88 is provided in Cape Town together with an application server 92 which hosts the icanonline web site. The servers 90, 92 are connected to a server 94 which hosts the stockbrokerage web site 26. The servers 90, 92, 94 are connected via firewalls 96, 98 to the Internet 84 and to the banking institution 20 which is typically located in Durban. Accordingly, the banking institution 20 includes firewalls and associated computer equipment generally indicated by reference numeral 100. Computer equipment 102 of the Transact System is connected via a firewall 104 to the Internet 84.

The transport services module 64 (see FIG. 5), as mentioned above, is responsible for communication between the system 10 and all other external systems, mainly using TCP/IP and FTP as the communication protocols. For security purposes, the banking institution 20 does not allow outside entities to connect to their network and, therefore, connection between the Internet banking server 16 and the banking system server 18 (see FIG. 1), and the transaction manager server 12 and the CAS server 14 is initiated by the banking institution 20. The CAS server 14 includes the TCP servers 82, 86 with Microsoft VisualBasic 6.0 and a Windows 2000 platform. The TCP servers 82, 86 are responsible for sending and receiving messages between the CAS server 14 and the financial institution 20 and the Transact System of the online shopping facility 22 via a raw TCP/IP connection. The TCP servers 82, 86 expect acknowledgments from each client every five minutes, and should the TCP servers 82, 86 not receive an acknowledgment, the TCP servers 82, 86 will then notify the CAS server 14 that communication between the CAS server 14 and the financial institution 20 no longer exists. In response to the aforementioned, all outgoing messages to the financial institution will be stored until the client has picked up an uncompleted transaction and completed it.

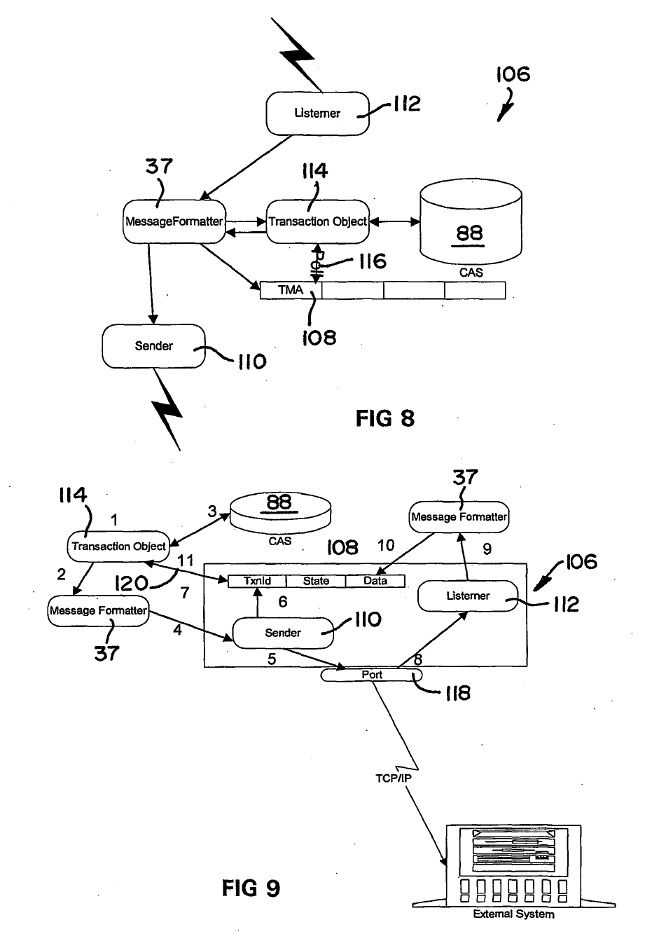

Reference numeral 106 (see FIG. 8) generally indicates a high level design of the TCP servers 82, 86. Temporary memory area 108 is provided using an array or collection and is used to communicate between a sender 110 and a listener 112. The listener 112 listens on a specified port for incoming connection requests and communicates with the message formatter 37. In a similar fashion, the sender 110 writes the necessary data to the temporary memory area 108 and sends a message via TCP/IP protocol to a requested destination. The message formatter 37 takes the data and the message format and merges them into a message with the correct format required by the listener 112. The message formatter 37 communicates with the sender 110 and is operable to strip out any data from a message and forward the data to various modules of the system 10. A transaction object module 114 communicates with both the message formatter 37 and the CAS database 88 and forms part of a payment engine which processes the data and writes the data to the CAS database 88. As shown by line 116, the transaction object module 114 polls the temporary memory area 108 for any status changes.

FIG. 9 shows a more detailed schematic block diagram of the interaction between the CAS server 14 and its various clients. Interaction between the various clients and the CAS server 14 is effected in a two phase process which relates to the sending and receiving of messages respectively. In phase one, the transaction object module 114 is instantiated by the payment engine or message formatter 37. Thereafter, the transaction object module 114 writes the necessary transactions into the CAS database 88 and calls the message formatter 37 to create a specific message. If a message has been created successfully, it is then passed on to the sender 110. During this process an incoming string has a requested message applied to it using a predefined or specified message format. The message format differs dependent upon the specific destination of the message. Thereafter, an instance of the sender object is created and a message is sent. Messages are received from a message store in memory. The sender 110 sends the message to the destination via communications mediums supporting the TCP/IP protocol and the transaction identification, message status, or the like is written into the temporary memory area 108. Failed and sent message statuses are defined depending on the status of the message.

In phase two of the process, the TCP servers 82, 86 have a listener object and, only one object can listen at a time once a connection request is received via a port 118. Data from the message is stripped by the message formatter 37 and thereafter stored in the temporary memory area 108. The message transaction identification data is passed into a message echo data section so that the message formatter 37 can link the message to the correct place in the temporary memory area 108. The transaction object module 114 picks up the change in status, as shown by line 120, and processes the data and updates the CAS database 88 accordingly. The system 10 is arranged to deal with communication failures as well as unplanned disconnects.

The communication protocol is arranged so that if the TCP servers 82, 86 do not receive an acknowledgment from the client, the TCP servers 82, 86 then send a request acknowledgment to the client and, in the event of the client failing to respond to the request acknowledgment after two minutes, the TCP servers 82, 86 will then close the connection to the port 118 and listen on the port 118 for a connection requested from the client. Notification to an administrator module of the CAS system 14 and to the client is sent. Further, every five minutes, the content of the temporary memory area 108 is committed to the CAS database 88 for recovery purposes which is performed by a recovery system. Under normal shutdown, the temporary memory area 108 is committed to the CAS database 88 before shutdown. However, on normal shutdown all transactions are completed and no new transactions can be initiated. Accordingly, on normal shutdown of the CAS server 14, the shutdown procedure reads data from the temporary memory area 108 to ensure that no transactions are in a sent state. Should any transactions with a sent state be found, the shutdown procedure waits until the transaction has been received prior to performing a shutdown. Further, during the shutdown procedure, the transaction object module 114 may not initiate any new transactions. Accordingly, only once all the transactions have been completed can the CAS server 14 be shut down. Upon an abnormal or unplanned shutdown, the recovery procedure reads from the recovery database and places the temporary memory area 108 into the same state that it was in prior to the abnormal shutdown and, further, the temporary memory area 108 is read and matched to the transactions in the CAS payment engine database. The CAS server 14 is arranged to notify the client during a subsequent logon of the status of the last transaction i.e. whether or not is was successful or failed.

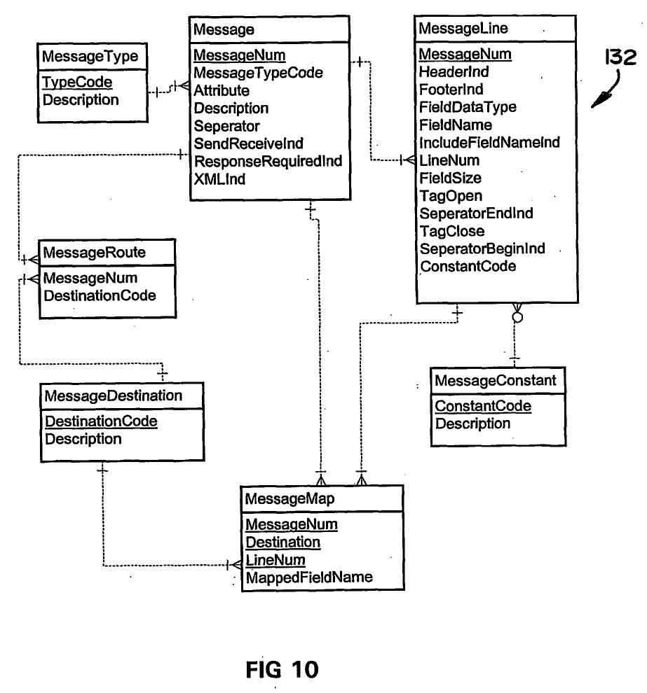

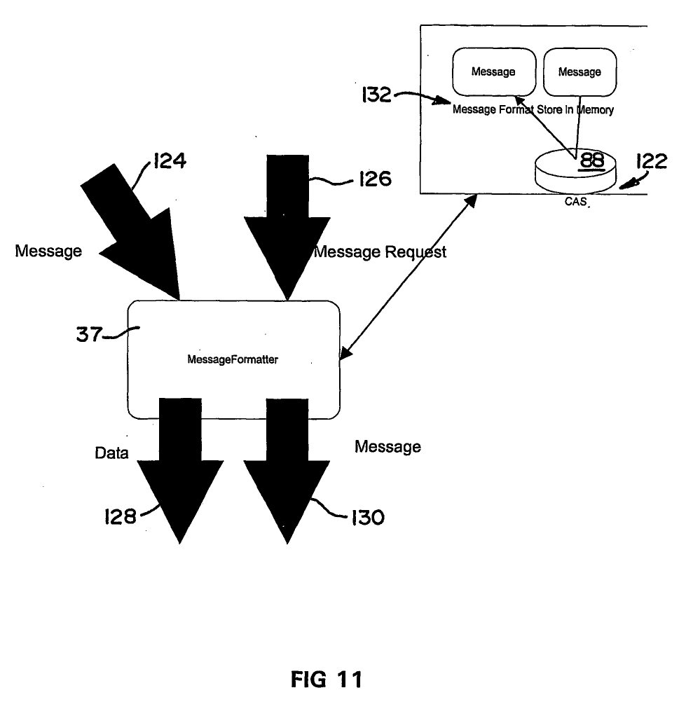

The message formatter 37 provides flexibility to the system 10 by keeping the message layouts in the database and formats the messages as required dependent upon the requirements of the various clients (see FIG. 10). Reference numeral 122 (see FIG. 11) generally indicates the high level design of the functionality of the message formatter 37. As can be seen from the drawing, the message formatter 37 receives messages 124 and message requests 126 which are then processed to generate data 128 and messages 130. The message formatter 37 includes a message data dictionary 132 as shown in FIGS. 10 and 11. The messages 124 may be incoming or outgoing messages from or to any source. The message requests 126 instruct the message formatter 37 to produce a message and a message identifier, destination data, and other data are required as inputs in an XML format. The message formatter 37 then reads the message request 126 and removes the data 128 which is output in an XML format. The message formatter 37 is arranged so that it can handle various different message formats and holds all the logic to create and read messages. Each message, its format and destination are stored in the CAS database 88.

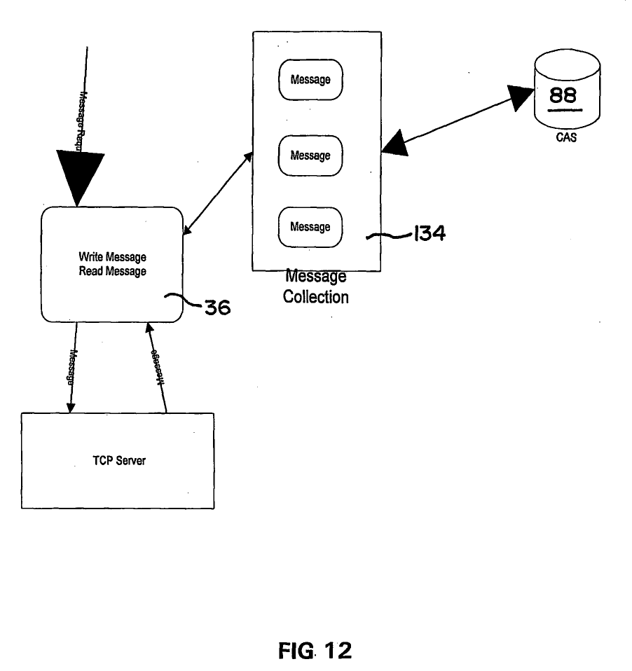

The messages are created using the message formatter 37 and a message format collection 134 (see FIG. 12). The message format collection 134 includes instances of the message object and each message object represents a message. Initially, the message format collection 134 is empty and as messages are requested the collection is checked, and if a particular message does not exist in the message collection, it is then added. To add a message to the collection, the message structure is read from the database 88 and a message object is then created. As hereinbefore described, the message formatter 37 includes a message request function and a read message function. The message request function returns messages and the read message function takes an incoming message and places the data either in the temporary memory area 108 or as an XML string depending on various predetermined criteria.

The recovery manager module 70 (see FIG. 5) includes three components. Firstly, a recovery component restores the state of the application after a server failure has occurred. Secondly, a shutdown component is used to handle a normal shutdown process ensuring that the application is in a stable state and can be shutdown and, thirdly, a startup component which is used to load all the system variables and check all components of the system 10 on system startup.

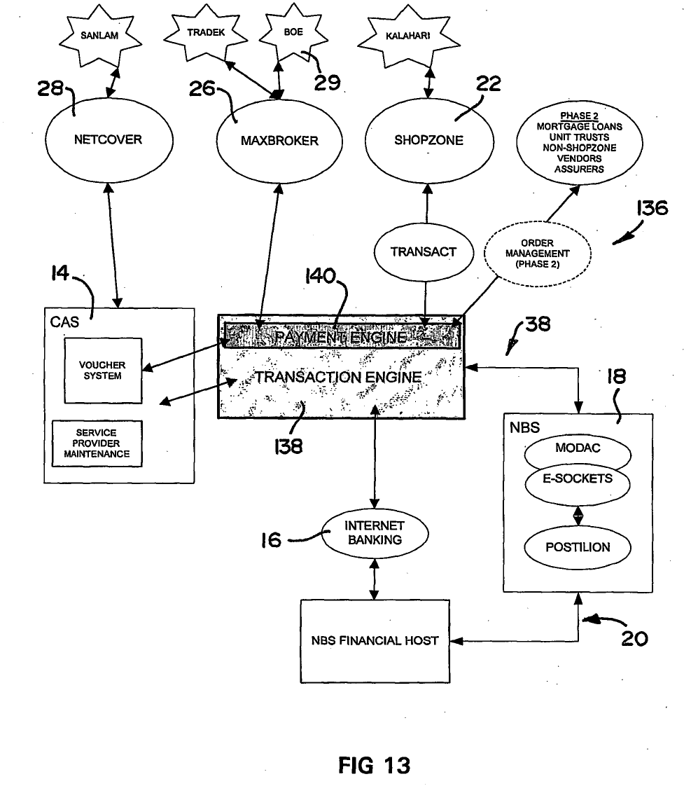

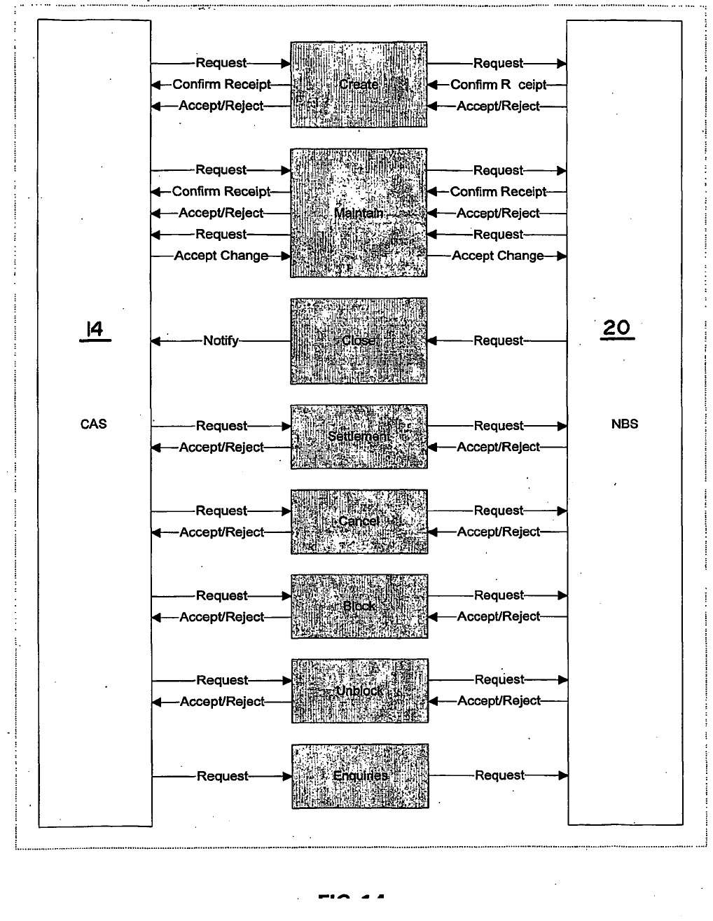

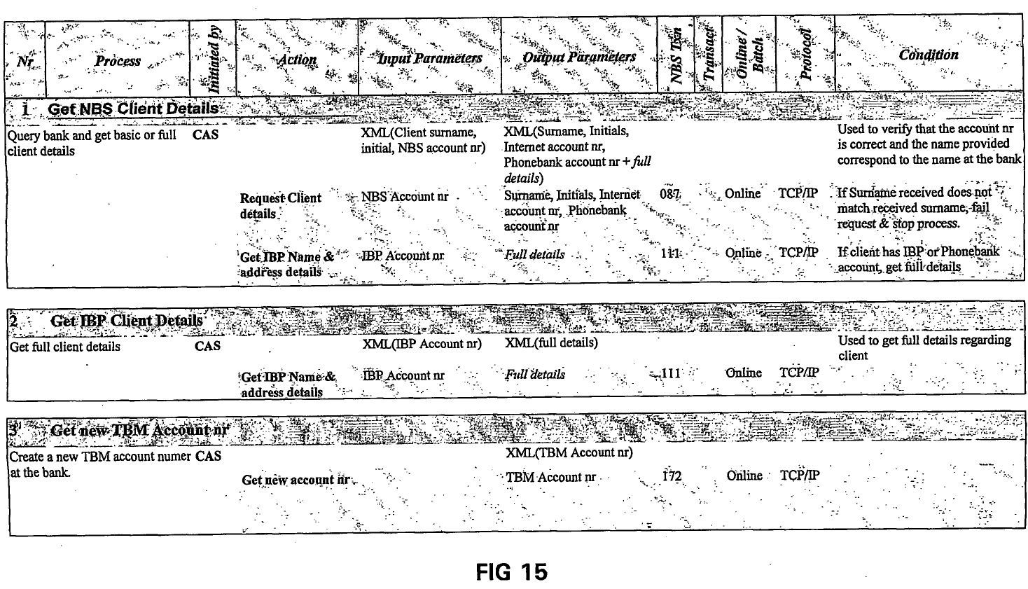

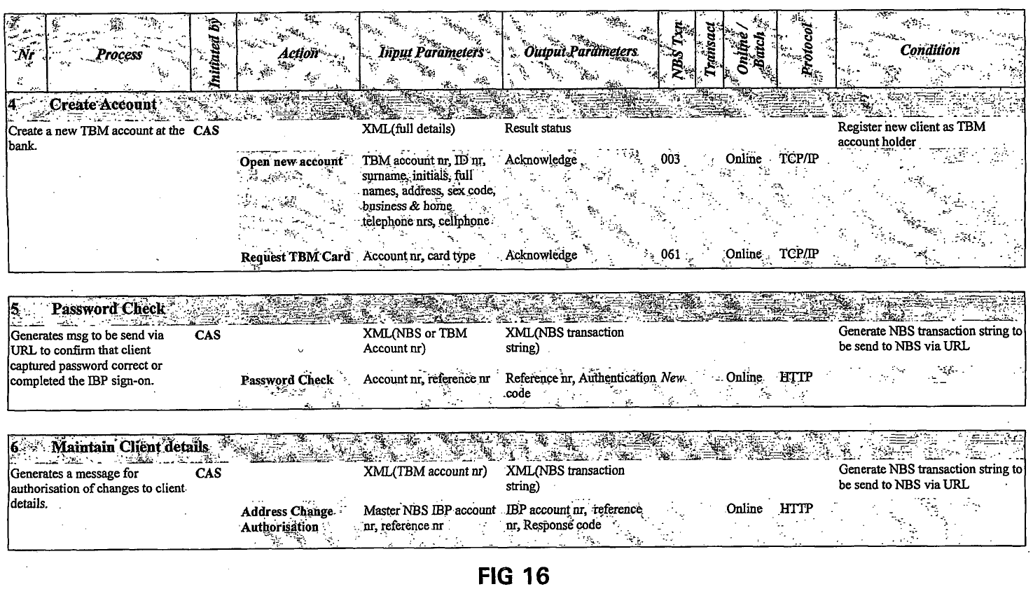

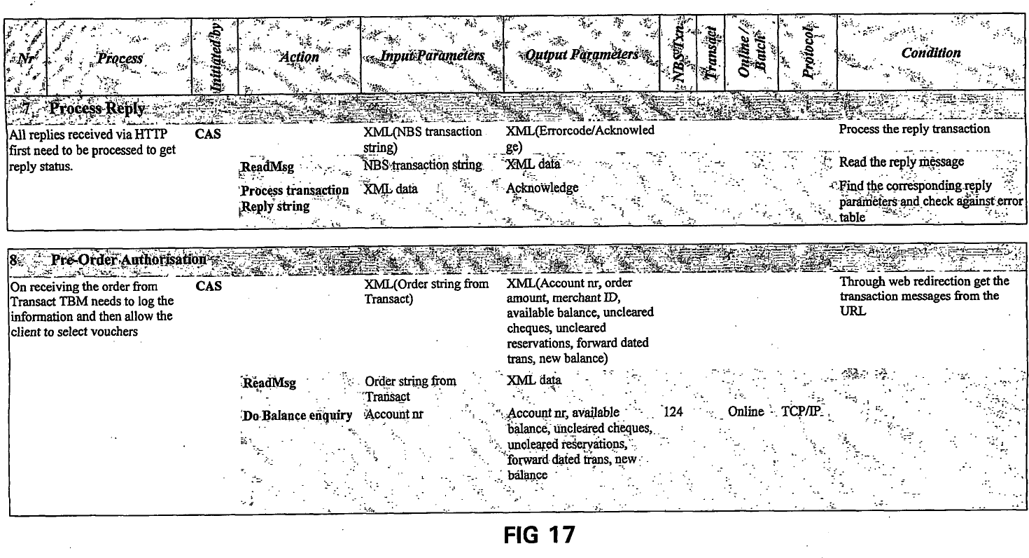

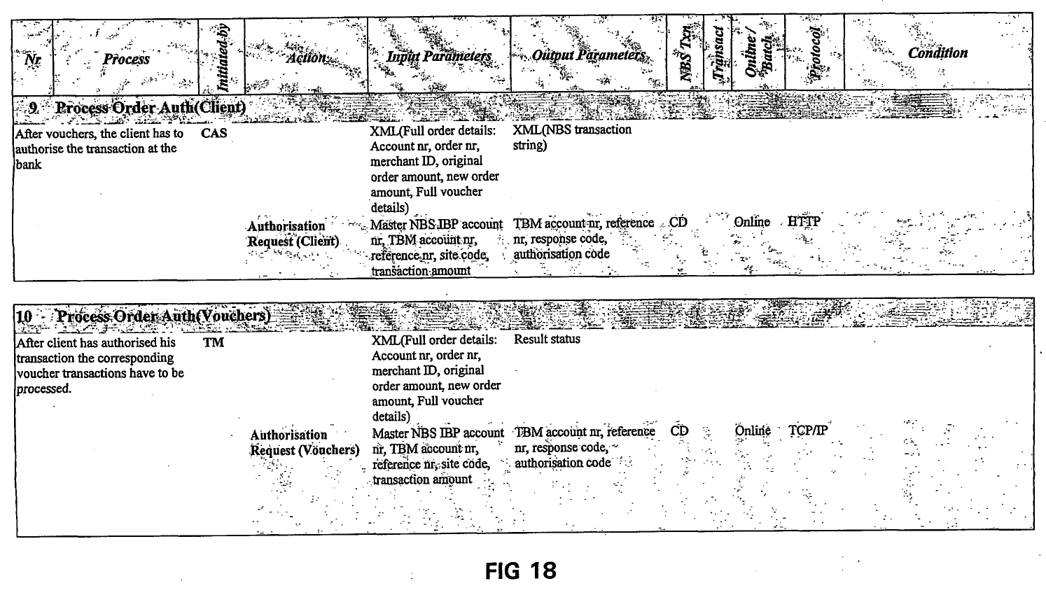

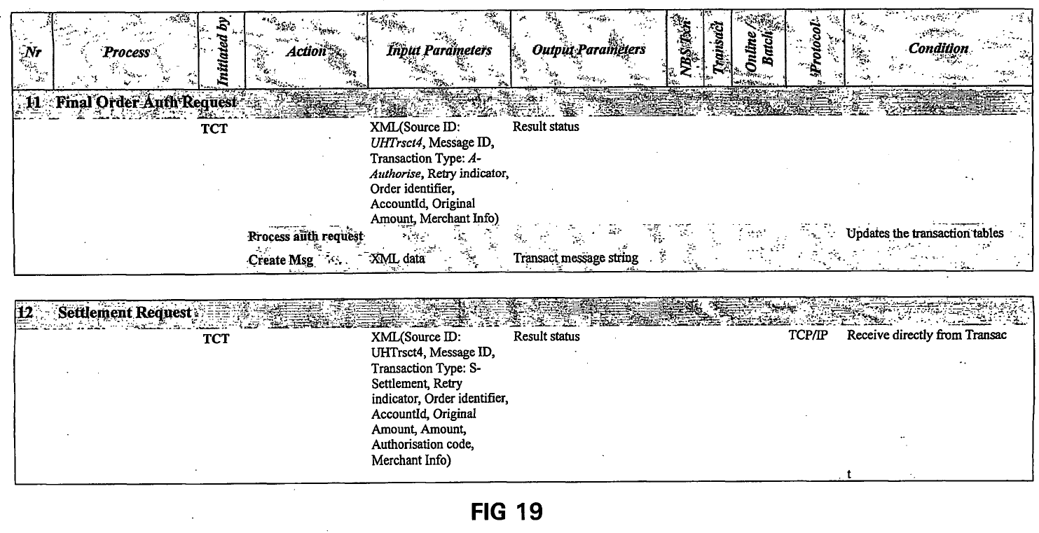

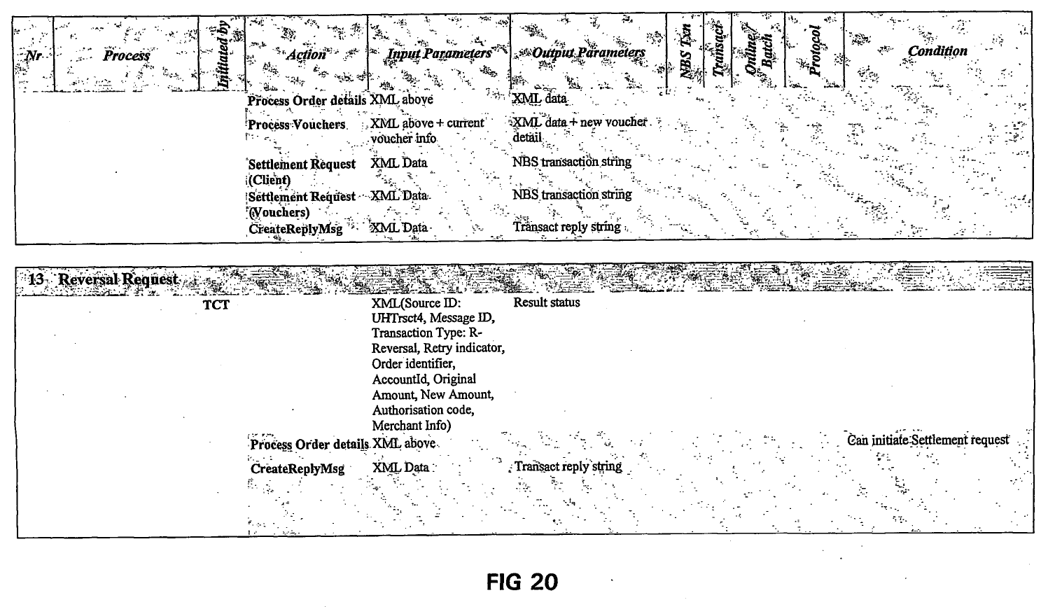

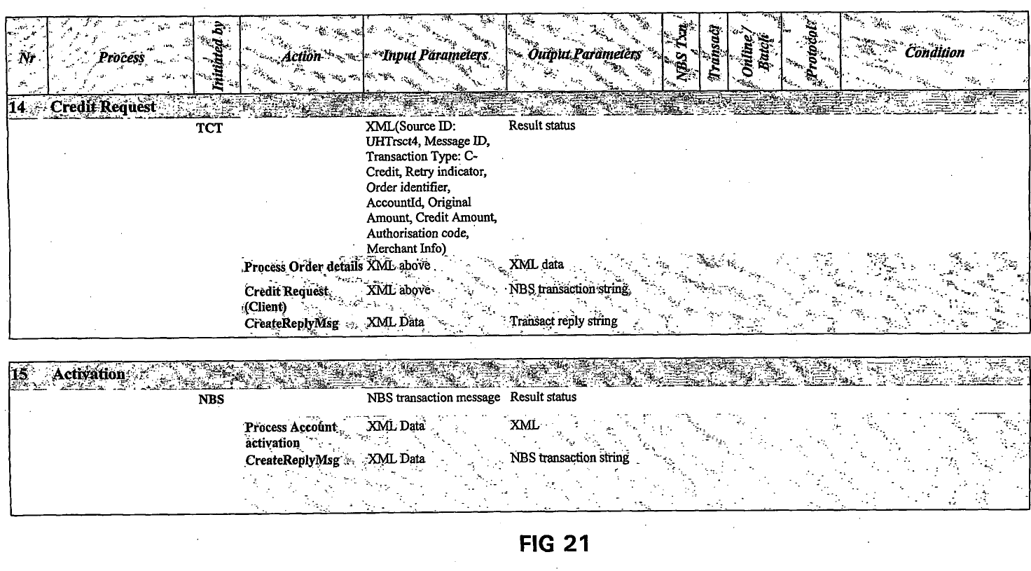

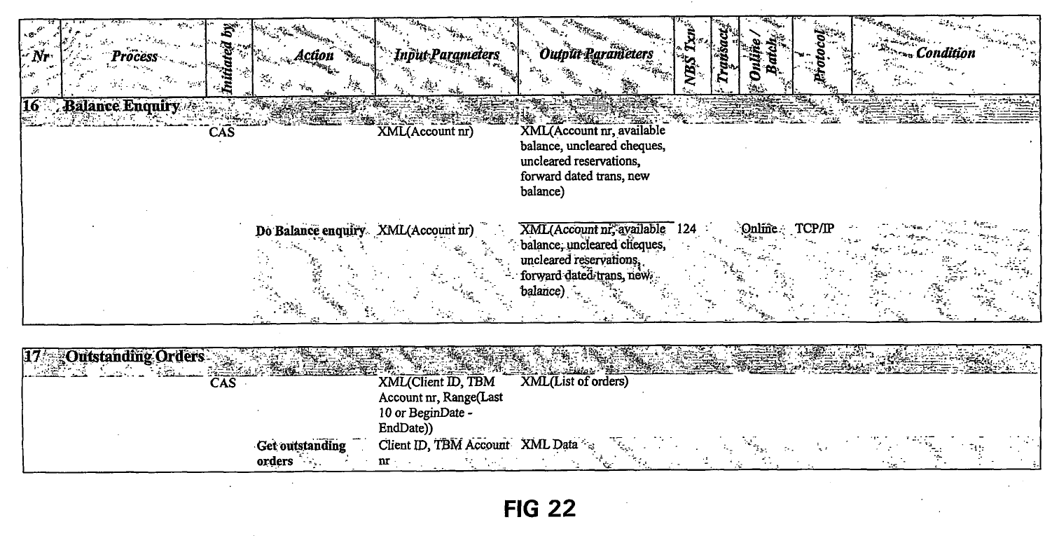

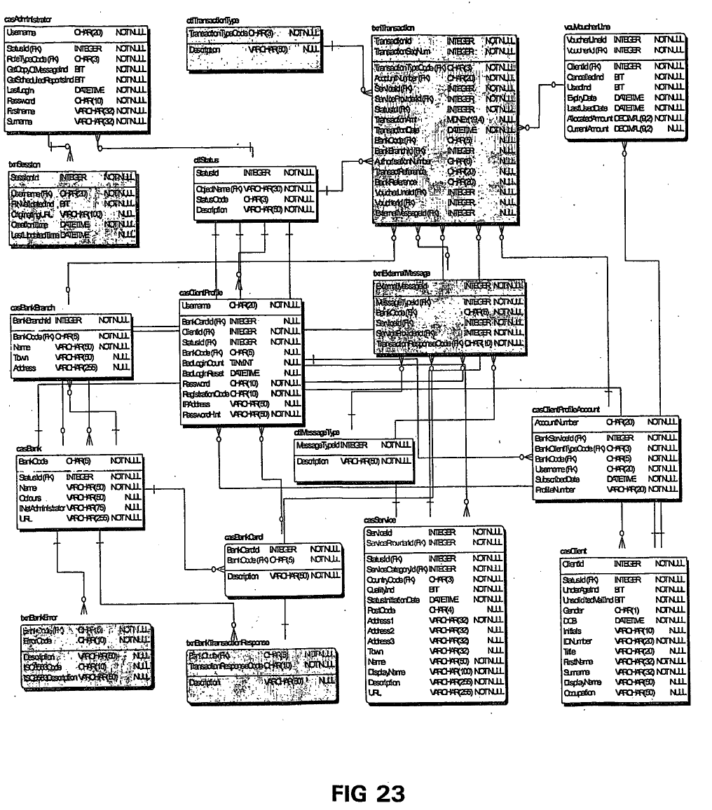

Referring in particular to FIG. 13 of the drawings, reference numeral 136 generally indicates a schematic block diagram of the transaction controller 38. The transaction controller 38 includes a transaction engine 138 and a payment engine 140, as mentioned above, to control transactions via the system 10. The transaction manager server 12 executes processes and actions, the processes being a logical grouping of various actions or steps that need to be executed to complete a transaction. The main logical processes within the system 10 are shown in FIG. 14. Various processes and their associated actions are described in FIGS. 15-22 of the drawings. FIG. 23 provides an entity relationship diagram of the transaction manager 12.

The functions and procedures of the transaction controller 38 are set out below. The fields shown below are the dynamic fields of the messages.

CreateAccount

Private Function CreateAccount (TransactionDate as Date, PostingDate as Date, blsIBP as Boolean, Sxml as String, Err as string) as string.

Purpose:

Controls the create account process.

Assigns a transaction number.

Precondition:

TransactionDate, PostingDate, blsIBP and sXML cannot be empty.

TransactionDate—used in Message to the banking institution 20, which in this case is NBS.

PostingDate—used in Message to NBS.

The Variable blsIBP is used to decide if AccountEnquiry must be called.

Post Condition:

Message XYZ will be handed back to the caller of this function ExecTxn.

The Account number is written to the database, and the message transaction table reflects a CreateAccount transaction against the client.

An account is then created for the client.

Message Information:

May be defined dependent on the circumstances.

Error Handling:

Serr is passed by reference and will contain an error message if an error occurred.

AccountEnquiry

Private Function AccountEnquiry (TransactionDate as Date, PostingDate as Date, AccountNumber as varchar, CASTransactionNum as long, byREF sErr as string) as Boolean.

Purpose:

Sends a message to NBS checking if the Client is a NBS client.

Precondition:

This Function is only called if blsIBP=true.

TransactionDate, PostingDate, Account number and CASTransactionNum cannot be empty.

Post Condition:

Sends message 087 to the NBS and returns a true or false.

True=Client is an existing IBP/phone bank users.

False=Client is not an existing IBP/phone bank user.

The Message Transaction table is updated.

Message Information:

R-Code/Mweb (server 92 in FIG. 7) Acc Enquiry Request 087 Transaction Date Posting Date Account Number CAS Transaction Number (Echo Data) R-Code/Mweb Acc Enquiry Reply 087 Surname Initials R-Codes Account Descriptor 1 Account Descriptor 2 Internet Account Number Phone Bank Account Number CAS Transaction Number (Echo Data) Error Handling:

Returns true if there were no errors and False if there were errors. Serr is passed by reference and will contain an error message if an error occurred.

Message Builder

Private Function Message Builder (CASTransactionNum as long, byref sErr as string) as string.

Purpose:

Creates a message, which will be sent via http to IBP logon screen.

Precondition:

Preconditions may be defined dependent upon the circumstances.

Post Condition:

Message XYZ is created and returned to the caller of this function.

Message Transaction Table is updated.

The message will contain the Account Number or IBP Number and e-mail address.

Message Information:

System dependent messages may be defined.

Message

IPB Number/Account Number E-mail Error Handling: Serr is passed by reference and will contain an error message if an error occurred.

Batch Processes A new client receives an e-mail with a registration code, the client needs to go to the TBM registration page and fill in this code. On filling in of the code the RegistrationDate field on the ClientProfile table is up dated. A stored procedure schedule under the administrative module or eBroom runs at night and finds all records in the ClientProfile table where the RegistrationDate is greater or equal to today and IBPConformationData is NULL. The results of the procedure must be sent to the message formatter 37 and a file will be created. This is sent to the NBS using the Transport services.

Fields to add to ClientProfile

IBPConformationDate

Database—First Pass Entity Transaction CASTransactionNum StatusCode DateTime TransactionType Message MessageNum Destination DateTinie MessageTransaction CASTransactionNum MessageNum Create Account When a new client registers with the TBM system 10, a bank account must be created for the client. The Client will go to the TBM web site and register on the system 10. Throughout the registration process the CAS system will rely on the transaction manager module to provide information and interface with the bank. The Create Account functional process consists of various transaction manager processes. The business rules for creating an account are as follows:

Business Rules

The parameters for opening a new account include the minimum
information, legally required, on the new Client such as name, address,
and telephone numbers.
The Banking System server 18 must confirm the receipt of the
Account Creation message. On confirmation of account creation, the
system must pass the TBM account number back to the Transaction
Engine 138. An account can be created as provisionally active. After
the Client's identity has been verified the account will be either
activated or rejected.
A client may carry on in the TBM system 10 even though the account
status is only provisionally active. The banking system server 18 will
reject a transaction if the account is not active.
Banking system server 18 will send a master account number back to
use as profile number.
A Client may have more than one bank account.

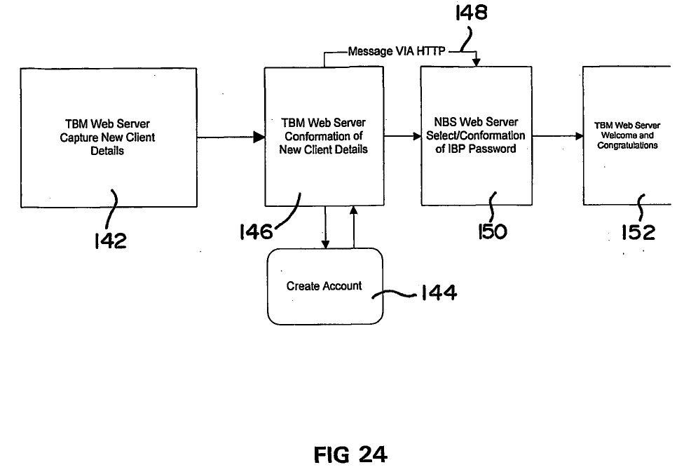

In order to create a new account at the banking institution 20 new client details are captured as shown at block 142 (see FIG. 24) which shows a high level design of the process) whereafter an account is created as shown at block 144 and the CAS server 14 then confirms the new client details as shown at block 146. In addition, a message is sent via http protocol from the CAS server 14 to a server of the banking institution 20 as shown by line 148. The banking system server 18 confirms the password as shown at block 150 and, thereafter, the CAS server 14 then despatches a “welcome and congratulations” message to the user as shown at block 152. Thus, a new client captures his/her details on the “icanonline” web site by pressing an “OK” button and, thereafter, the new client is redirected to a confirmation of new client details web page. When the client presses the confirm button, the create account process is initiated and an account is created for the client with the banking institution 20. Once the account has been created for the client, the client's web browser is directed directly to the financial institution's Internet banking screen via the Internet banking server 16 and a password is then selected or, in the case where the client is an existing client of the financial institution 20, the password may be confirmed. It is important to note that the client then communicates directly with the Internet banking facility of the financial institution 20 and not via any third party. Typically, the communication is via a pop-up screen which may then be closed once the procedure has been completed. Three different scenarios can be present when creating a new account. Firstly, the client may be a new client to both the system 10 and to the banking institution 20, secondly, the client may be a new client to the system 10 but an existing client of the banking institution 20 but not its Internet banking facility and, thirdly, the client may be a new client to the system 10 who is already a client of the financial institution's Internet banking facility.

Block Funds/Transaction Authorisation

When a client buys goods through an online, Internet store using his TBM account, the transactions must be authorised in the same manner as a standard credit card transaction. During this process the clients bank account is queried to verify that the client has sufficient funds. The client has to authorise the transaction at the bank's Internet banking site. On doing this, an amount equal to the transaction value is blocked in his account.

Business Rules

| | |
|---|---|
| 1. | The term “Block Funds” can be used synonymously with the |
| | terms “Reserve” or “Authorise Funds” for the purposes of this |
| | document. |
| 2. | Funds are blocked for a period according to default parameters |
| | per service. There is a batch run that extracts all blocks that |
| | have exceeded the expiry date a cancels the block with the |
| | Banking System. |
| 3. | The client's available balance will be less any Blocked amounts. |
| 4. | If there is a reservation and insufficient funds to satisfy (because |
| | of charges) allow the account to go overdrawn. TBM accounts |
| | are allowed to go overdrawn through batch charges being |
| | generated. |
| 5. | The Block message requests authorisation for a certain amount |
| | and then puts a hold on that value on the client's account until |
| | it is released via an Unblock message. |
| 6. | The Block message is a real time message that the client must |
| | get a response from immediately. |
| 7. | The Block message fields are: |
| | TBM Account Number |
| | Reservation Amount |
| | Reservation Date |
| | Float Type = 9 |
| | Service Provider Code |
| | Service Provider Transaction Number |
| | Period that Block is effective for (Terms) |
| | Identifying Transaction Number |
| 8. | This Blocked amount will not be able to be removed by any other |
| | system other than CAS. |
| 9. | Reservations for share trading - Partial completions. All |
| | Information to be held in CAS and a single settlement generated |
| | from CAS. |
| 10. | When a client makes a purchase, CAS notifies the Banking |
| | System of funds to be authorised (reserved). The client needs |
| | to login with their account Number and password to IBP or else |
| | they cannot perform the transaction. The account Number and |
| | password will be validated and the relevant funds put on hold if |
| | successful. |

Transaction Authorisation Process Th e following steps are followed in the Authorisation process:

The client shops on the Internet (shopping site that supports the TBM payment method, e.g. Shopzone);

As part of the checkout of pay process the client has to select a payment method, e.g. Visa, Mastercard or TBM;

On selecting TBM the client is requested to authorise the transaction. When the client clicks on the Authorise button a second instance of the web-browser is opened and the client is redirected to the TBM site. As part of this redirection process the basic client and transaction information is passed to TBM via HTTP;

The TBM site first reads the TBM cookie on the client's machine to verify that the client has logged onto the TBM web site prior to moving to the shopping site, by checking the date and time values in the cookie. If it is less than the predefined value (20 minutes), the client is considered logged on;

The Pre-Order Authorisation process is called which logs the transaction in the database and requests the client's account balances from NBS;

The client is then presented with his available vouchers where he can select the vouch rs to be used;

The client is then requested to authorise the transaction by providing his IBP password on the NBS Internet banking site. As part of the redirection to the IBP site, details regarding the client's portion of the transaction is send to the bank (via HTTP). For this the Process Order Auth(Client) process is used;

On arrival back at the TBM site the reply message is read and if authorised, the relevant details are stored in the database (Process Reply process);

In the background the rest of the transaction (TBM and/or Merchant Voucher transactions) is submitted to NBS for authorisation (Process OrderAuth(Vouchers);

The second instance of the browser is killed and the client is requested to complete the buying process by clicking on the Buy button on the original payment browser window;

On clicking Transact will generate a standard authorisation request which is send to TBM;

TBM receives the request and checks the TBM database for the authorisation of the corresponding transaction (Final Order Auth Request). If the transaction was successfully authorised, TBM sends the authorisation number as part of the confirmation back to Transact.

Settlements

The Merchant, on shipping the ordered goods to the client, initiates settlement or payment requests. The settlement transactions are captured on the Order Management system (Transact) and sent via TCP/IP to the TBM system 10.

Business Rules

| | |
|---|---|
| 1. | Settlements are initiated via the Unblock message that |
| | unblocks the hold on the account and processes a payment for |
| | the specified amount which may not exceed the Blocked |
| | amount. |
| 2. | Unblocking is a request that comes from the merchant to NBS. |
| | The request can be two fold: |
| | Request for cancellation of an order, in which case a previous |
| | order was submitted and funds were blocked and now need to |
| | be unblocked. |
| | Request for a settlement of a completed order, in which case |
| | the goods have been shipped from the merchant to the |
| | customer and the merchant now request his payment. |

High Level Design

The diagram below shows a high level design of the unblocking of funds and the different components involved. On receiving the settlement transaction from Transact, the TBM system

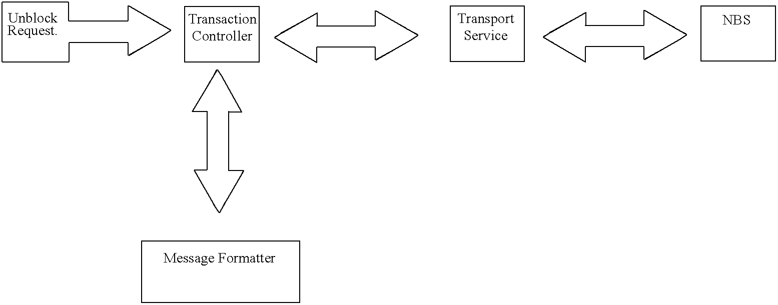

executes the following steps:

The TBM database is checked to confirm that the transaction is still outstanding (Settlement Request process);

If the request is for a partial transaction (the transaction is not final yet), TBM logs the request in the database and waits for the final settlement request. Only then will the full transaction be processed;

On receiving the final settlement request, the Transaction Manager evaluates the full transaction to determine if any partial cancellations were part of the transaction. If there were, the transaction controller 38 initiates the Voucher system to recalculate the transaction values;

It then generates the settlement/unblock transactions for the client and voucher transactions which are then sent to the banking institution 20. Unblock Request

A Request coming from one of the merchants. Transaction Controller

Handles transactions between NBS and the merchants.

Message Formatter

Format the messages sent into it from the source version to a message that can be interpreted by the destination.

Transport Servic

Transport message from Transaction Controller 38 to NBS 20 and back.

NBS

The banking side.

Detailed Design

Merchant

The merchant is an online entity that sells products or services. When a user logs on and buys from the merchant, funds are blocked on NBSs side. The UnblockFunds Function's purpose is to either cancel or pay out the funds that were blocked. A function named UnblockFunds in the transaction controller 38 is then called.

Transaction Controller

This function's layout is as follows:

Public Function UnblockFunds (sXMLDetail as String, Vdestination as Variable, TransactionType as UnblockTransactionTypes) as Boolean The purpose of this function is to request from NBS 20 that funds are either unblocked or paid out to the merchants account. The function is contained in the transaction controller 38. Components of Function

SXMLDetail: All the detail needed by NBS 20 is converted into XML by the WEB interface and is then sent via this function.

VDestination: This is the destination to which the message is sent which in this case will be NBS 20.

TransactionType: An ENum is created which must be called UnblockTransactionType. This ENum has two variables in it called Settlement and Cancellation. This indicates whether or not the amount in question must be paid out to the merchant or if the transaction must be cancelled. The very first step of this function is to validate the transaction. This is accomplished by checking the details of the Payment Request.

Checking if correct merchant requested the transaction and that it is the same merchant that originally made the transaction.

Checking that the amount is the same as the original amount.

Checking Transaction Numbers and entry that reside in the Database. Once it is accepted that the transaction is valid then the transaction is passed to the Message Formatter 37, which will convert the message to NBS specific format.

Message Formatter

The message formatter 37 consists of a completed function called WriteMessage. This function has the following parameters:

| | |
|---|---|
| MessageNum: | The number of the NBS messages to be built |
| | up. |
| SDestination: | The destination to which the message must go |
| | NBS. |
| SXML: | The XML data that is needed to be included in |
| | the message. |

The function then returns a string with the formatted message, which is returned to the Transaction Controller 38. Transaction Controller (Step 2) The transaction controller 38 unblocks funds function must now call the SendMessage function in the transport services control with the resulted formatted message. This function has the following parameters:

Transaction ID Formatted Message Destination This will be NBS or banking institution 20. This function resides in the transport services controller or module 64.

Transport Services

The transport services handles the rest by adding the transaction to the TMA Temporary Memory Area and sending it to the NBS. The NBS handles the transaction on their side and once finalized they send a response back to the transport services. This is where the Transaction Controller 38 yet again comes in to the picture. Transaction Controller (Step 3) The Transaction will now reside in memory in the Transport Services TMA. The transaction Controller now polls the memory area with the Transaction Services Poll function to see if a response was sent. As soon as a response is detected, it can be read from the memory and handled. The response must then be converted from a NBS specific string to a XML string. This can be done with the Read message function. This function consists of the following parameters:

| | |
|---|---|
| NBSString | This is the response from NBS. |
| SXMLResponse | The XML translated string. |

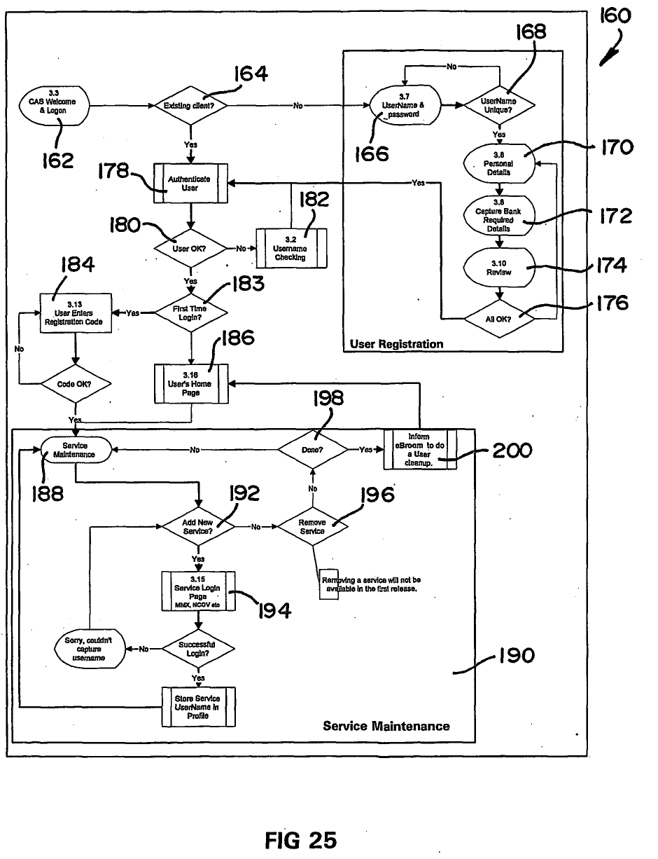

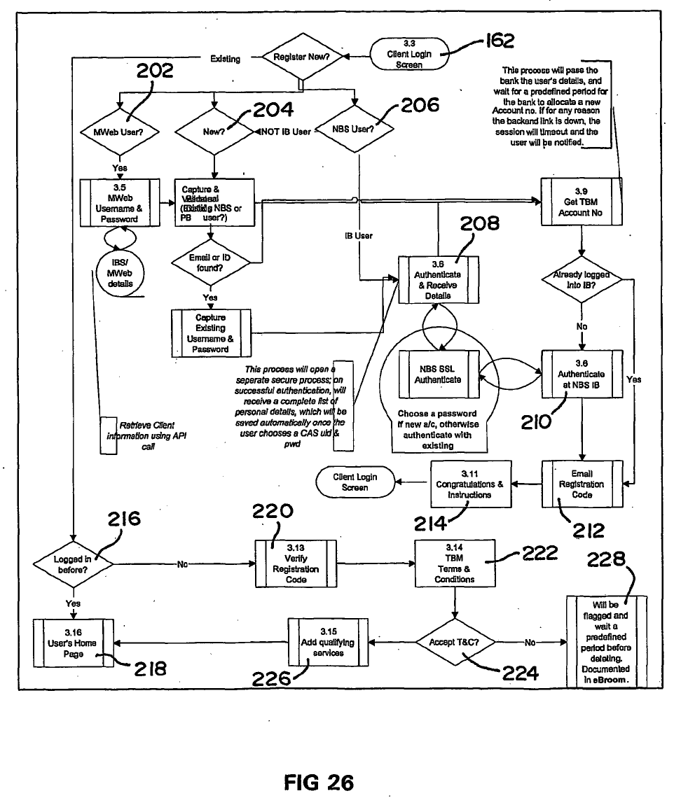

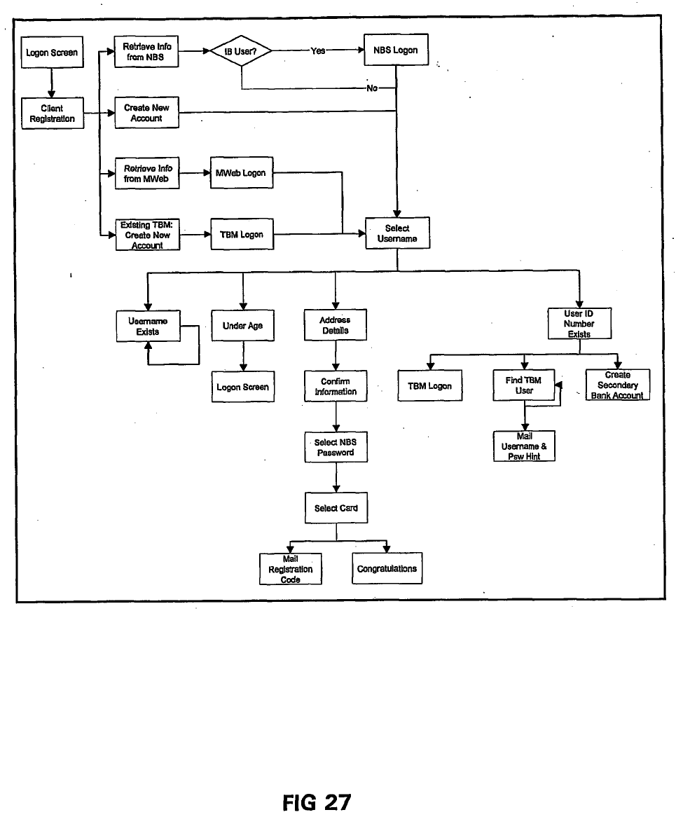

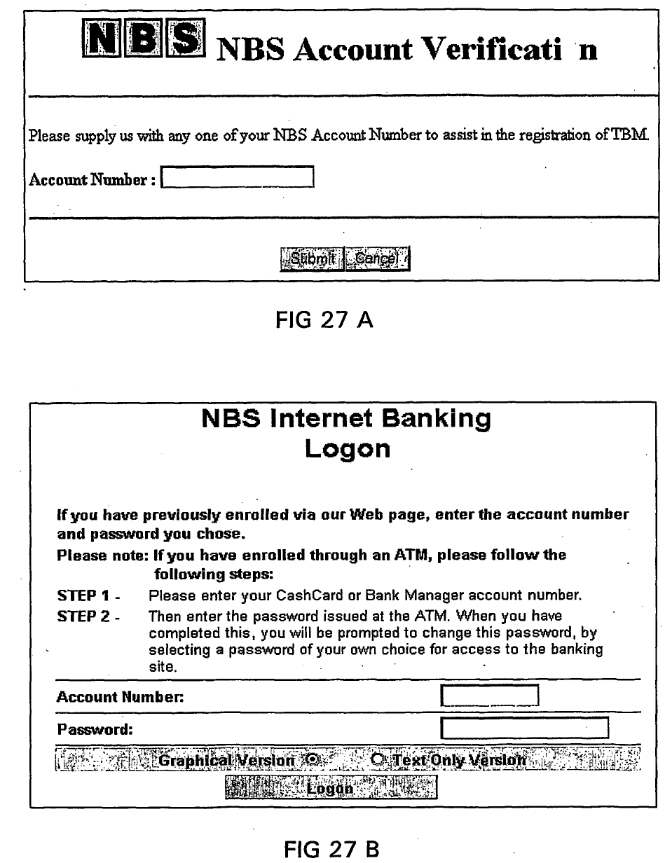

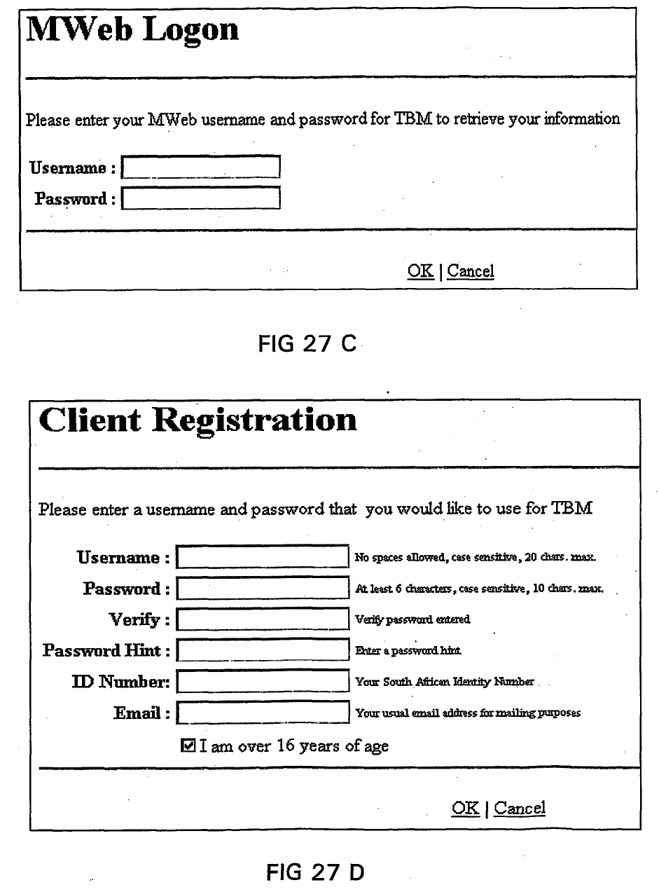

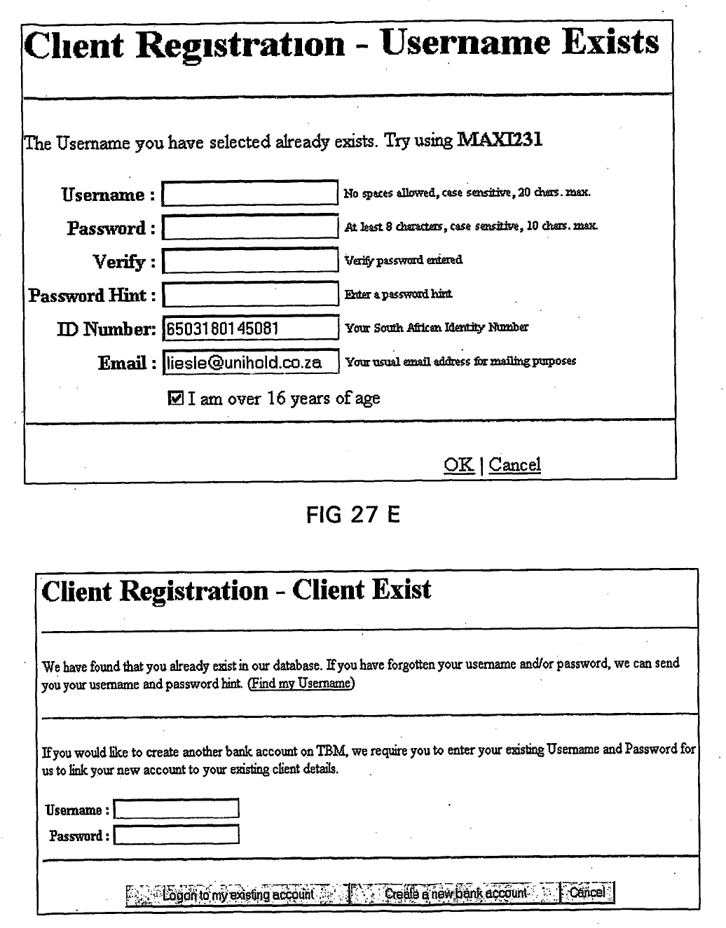

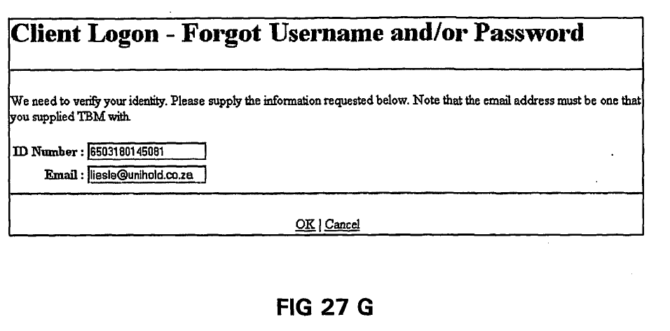

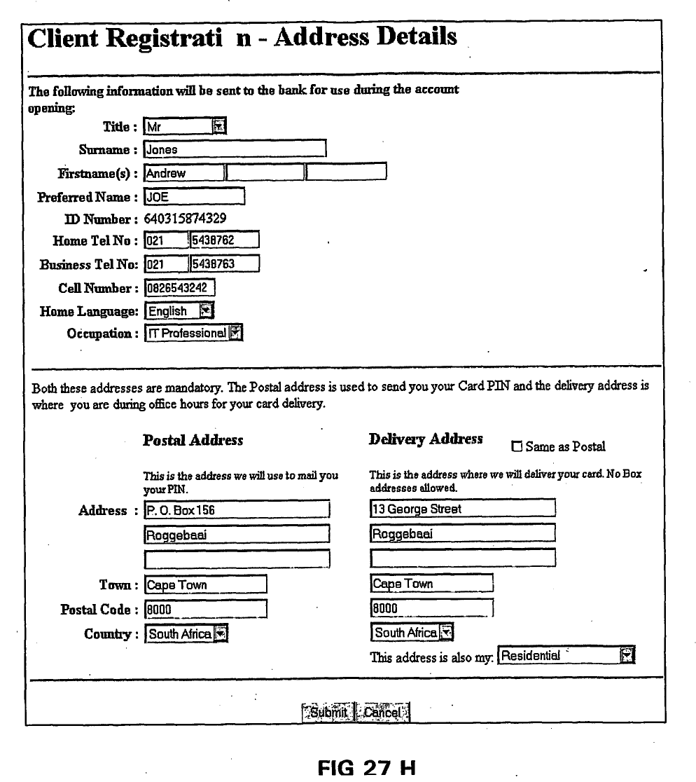

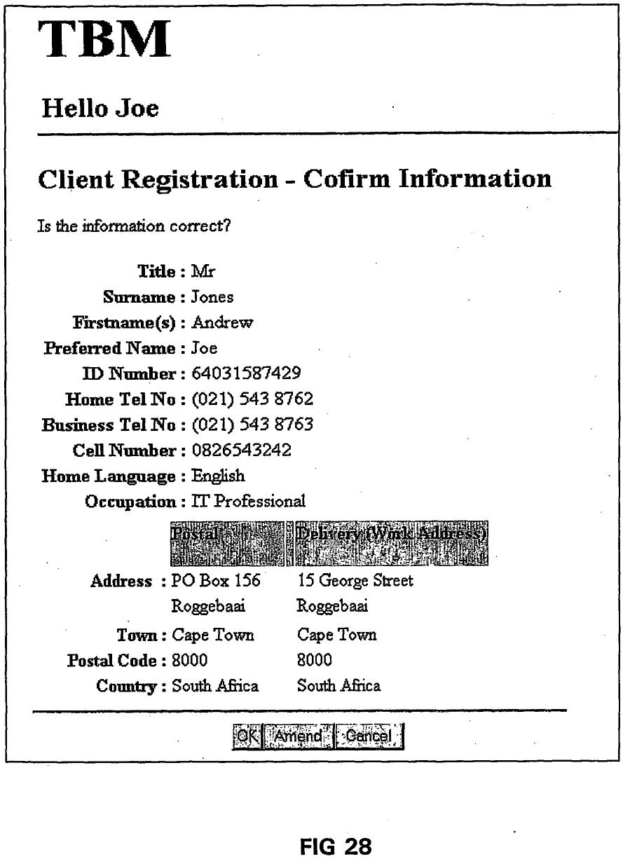

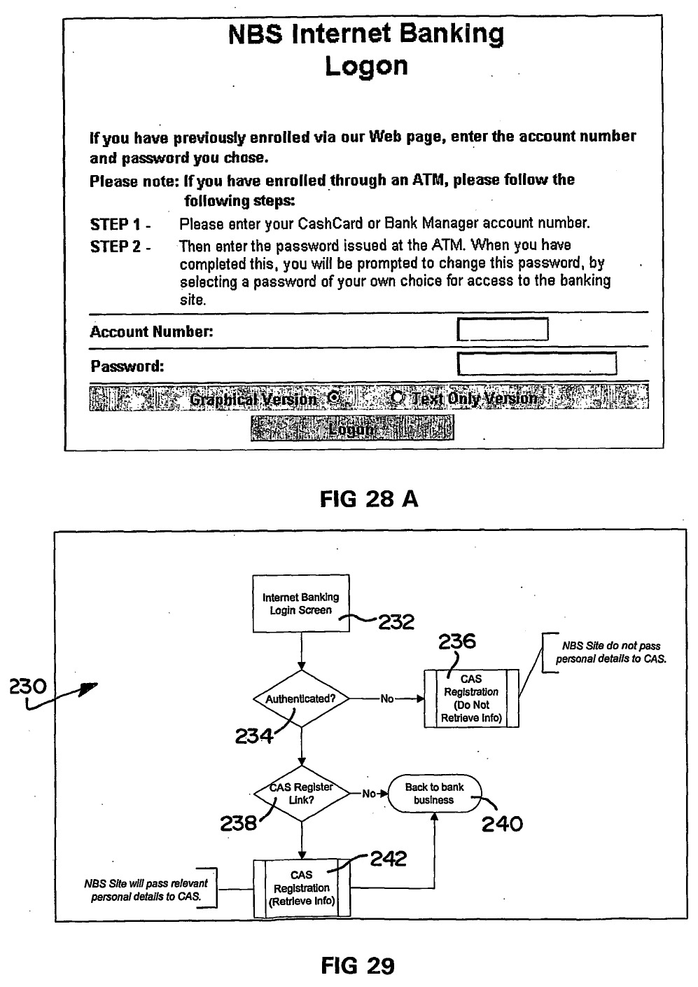

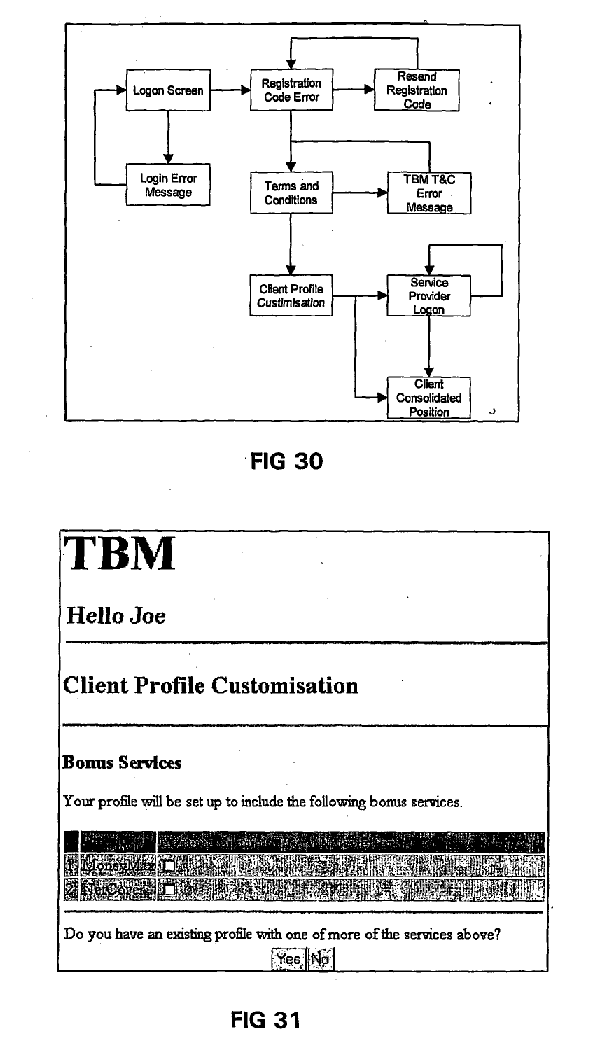

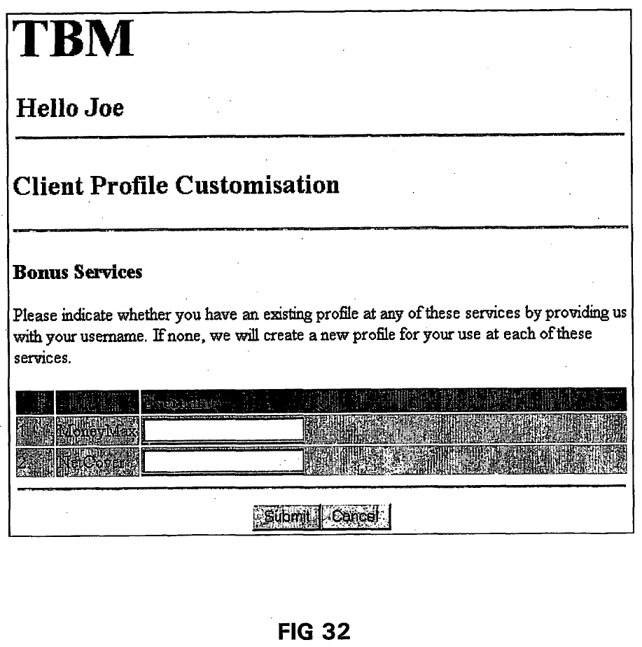

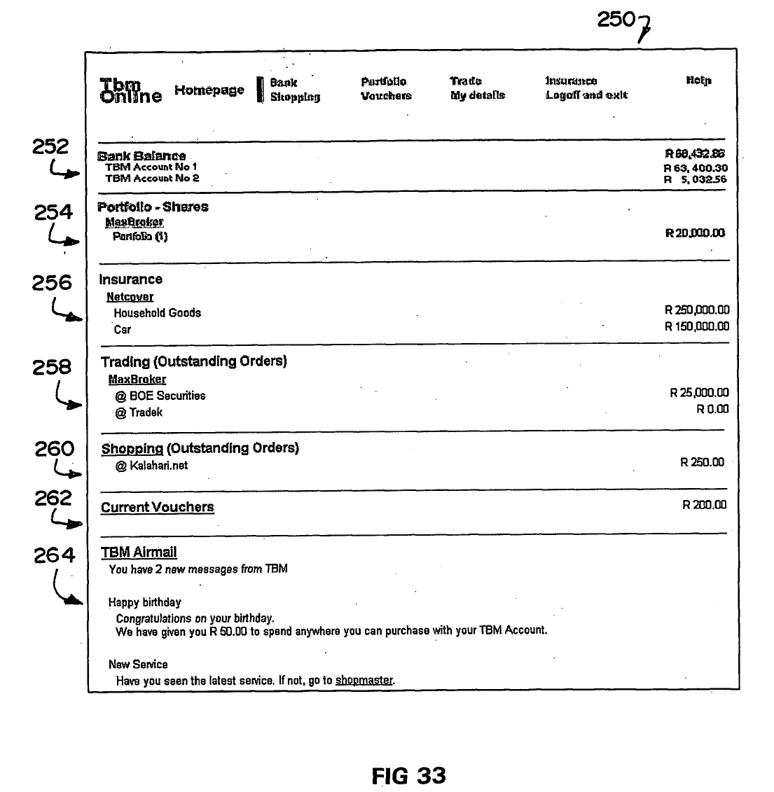

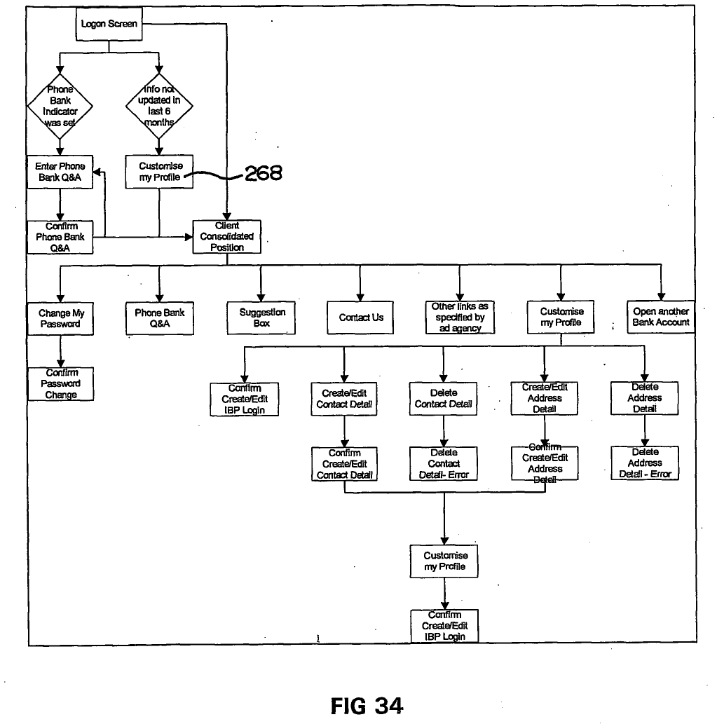

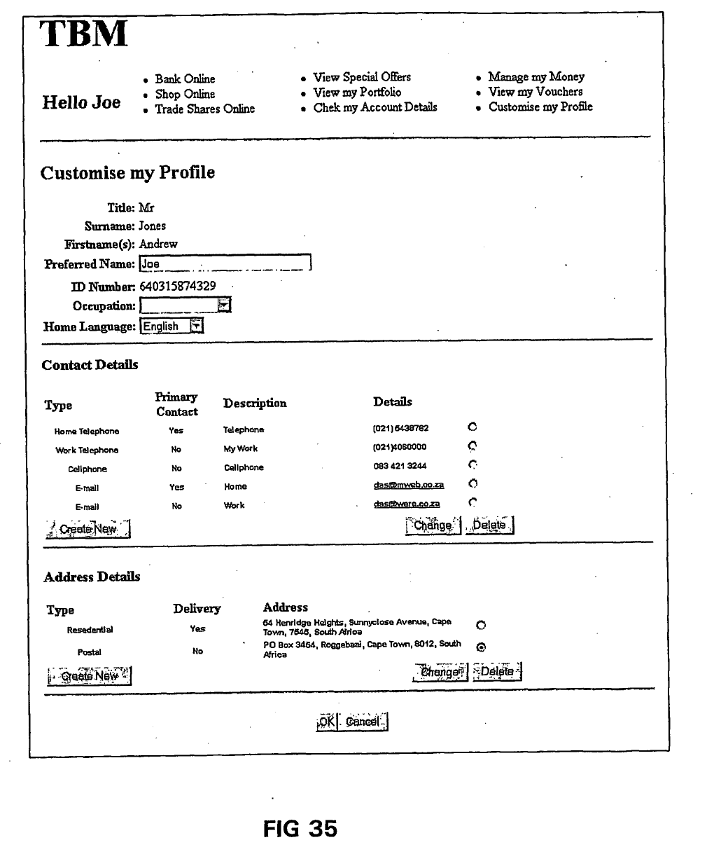

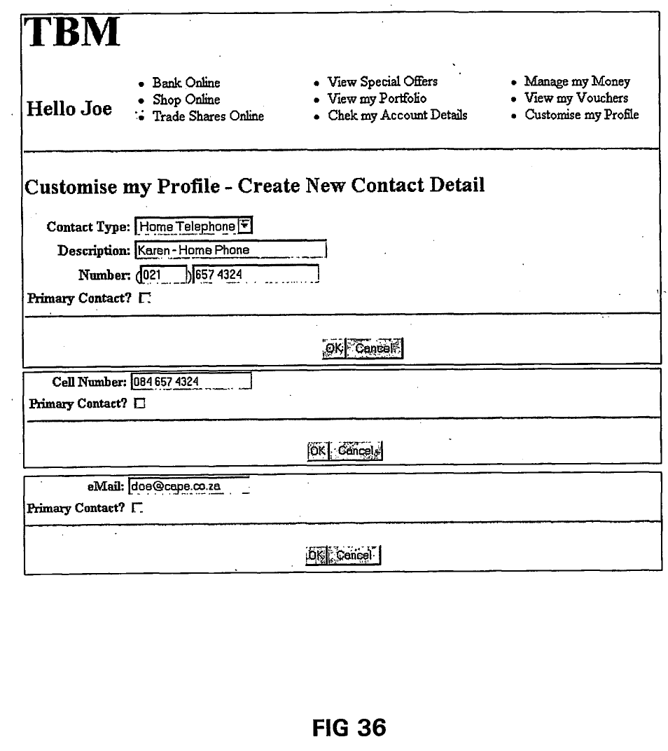

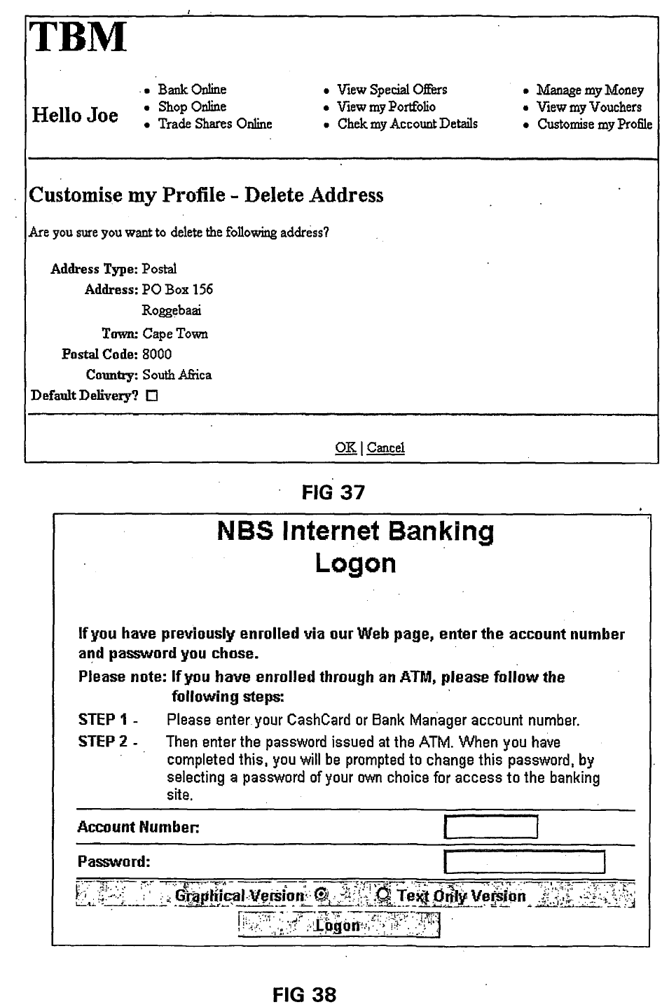

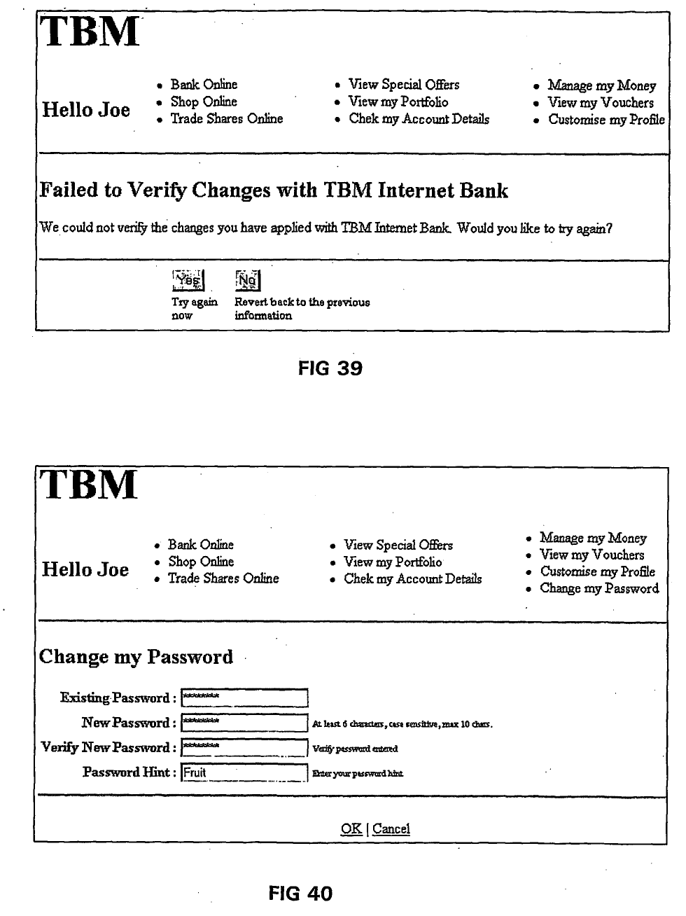

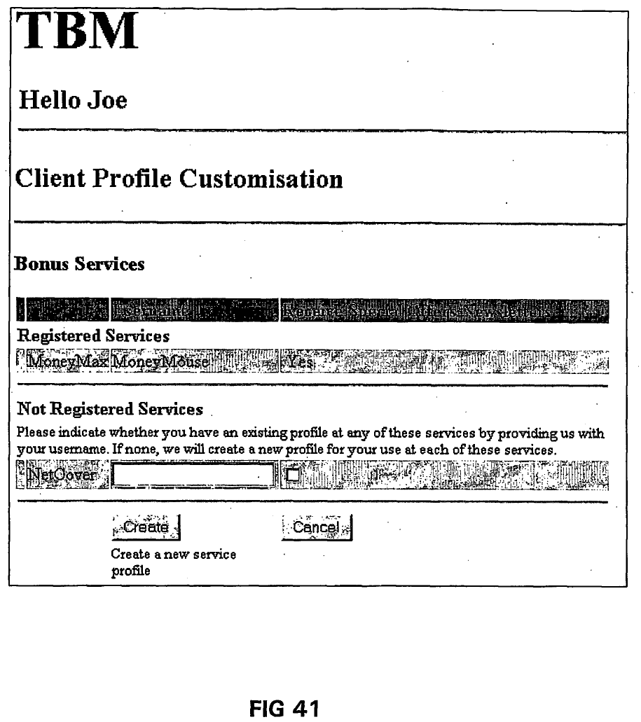

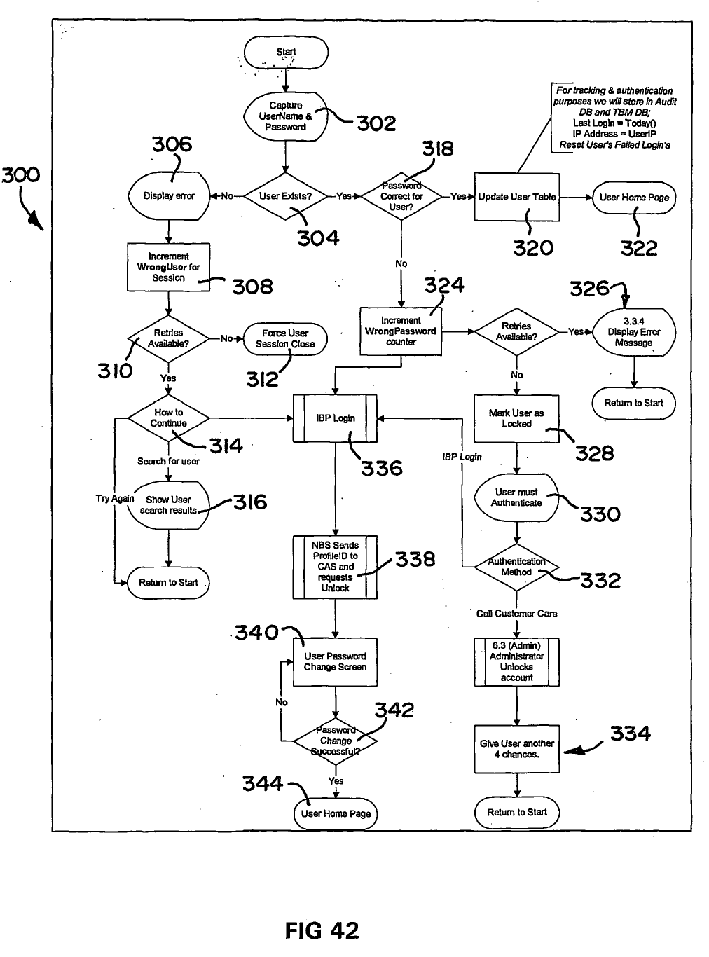

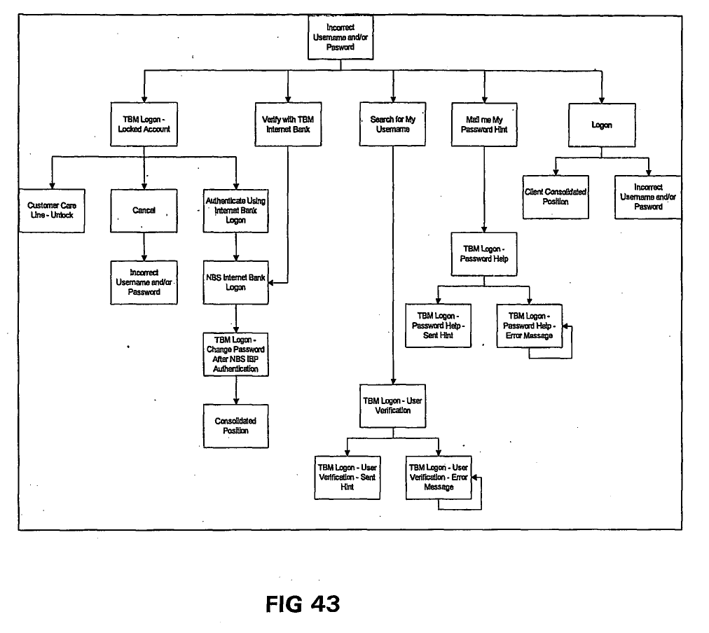

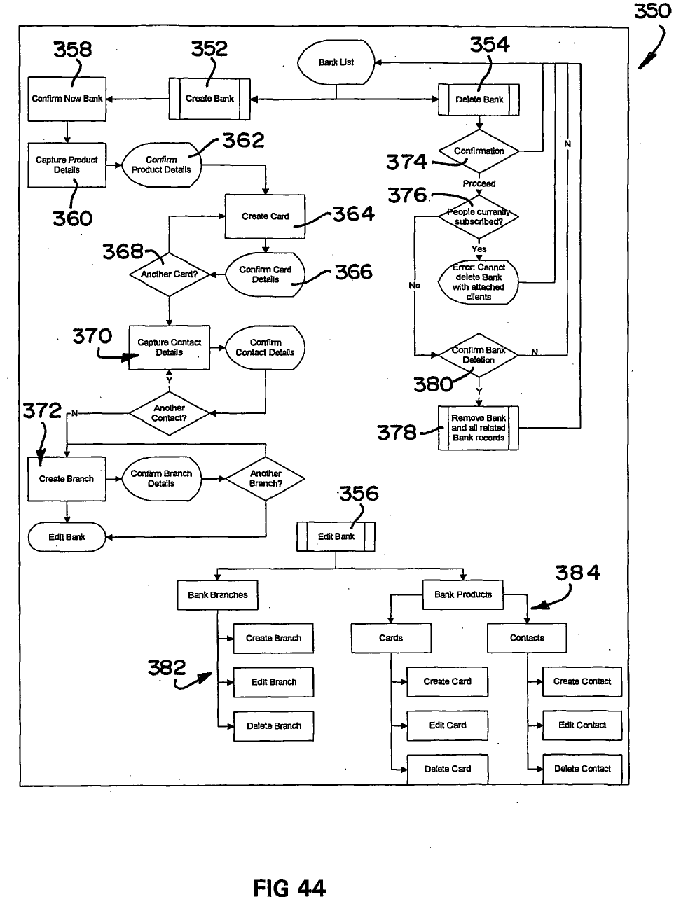

This string is now passed back to the Web interface, which then handles the transaction and response to the merchant. Referring in particular to FIG. 25 of the drawings, reference numeral 160 generally indicates a schematic flow chart of the client access, registration, and maintenance procedures of the TBM system 10. Initially, a CAS “welcome and logon” message is displayed (see block 162) and, at decision block 164, it is ascertained whether or not the user is a new or an existing client of the system 10. If the user is not an existing client, the user is requested to provide a user name and password (see block 166) whereafter the user name is verified to ensure that it is unique, as shown at block 168. If the user name is unique, personal details of the user are obtained as shown at block 170 and details specific to the banking institution 20 are then requested as shown at block 172 whereafter the data is reviewed as shown at block 174. If the reviewed details are in order, as shown at decision block 176, the user is authenticated as shown at block 178. If, however, the details are not in order, the process reverts to block 170 to obtain corrected or further personal details. If the user is an existing client, the process goes directly from block 164 to block 178 where the user is authenticated. Thereafter, as shown at decision block 180, if the user is not OK the user name is checked as shown at block 182. If, however, the user is OK the process proceeds to decision block 183 which determines whether or not the user is a first time user. If so, the process proceeds to block 184 where the user enters a particular registration code. If the user is not a first time user, the user then proceeds directly to the user's home page (see block 186) and, thereafter, to block 188 to a service maintenance facility 190. A check is then done to ascertain whether or not a new service is to be added as shown at block 192 and, if so, the appropriate login is effected as shown at block 194. If no new service is to be added the user then proceeds to decision block 196 to ascertain whether or not a service is to be removed. Thereafter, if no service is to be removed, the process proceeds to decision block 198 and, once completed, the administrative module or eBroom performs the relevant housekeeping. The CAS “welcome and logon” (see block 162 in FIGS. 25 and 26) is in the form of a logon scr en which provides the client with the option of logging on or registering with the system 10. Existing users of the system 10 are required to authenticate themselves before being allowed access to the TBM web site. At each login attempt, the user name and details are checked against the database and, if this is the first time the user logs in, he or she will have to enter the registration code which the CAS server 14 has mailed to him. When a client selects to enrol with the system 10, three options are provided, namely a new client option, an existing service provider client option, or an existing client of the banking institution 20 option as shown at decision blocks 202, 204, and 206 (see FIG. 26). The client access, registration and maintenance procedures of FIG. 25 are then carried out. If a client signs on to the banking institution 20 via decision block 206, a separate secure process is then opened wherein the client's details are authenticated and received as shown at block 208. At this point the client interacts directly with the banking institution 20. The new client may then choose a password and further authentication takes place as shown at block 210. Thereafter, a registration code is e-mailed to the client as shown at block 212 followed by “congratulations” and several instructions as shown at block 214 (see FIGS. 26 and 27). Examples of various logon screens are shown in FIGS. 27A to 27H. In the event of an existing client signing on, it is determined whether or not the client or user has logged in before as described above (see decision block 216) and, if the client has logged in before, the user's home page is then displayed as shown at block 218. If not, the registration code is verified as shown at block 220 and terms and conditions associated with the system 10 as shown at block 222, are displayed to the client. If the terms and conditions are accepted as shown at block 224, services are added as shown at block 226. However, if the terms and conditions are not accepted, the request is flagged and the data is deleted after a predetermined period as shown at block 228. The CAS server 14 sends the client three e-mail reminders if the client does not login during a given period and then deletes the client record and advises the banking institution 20 to do likewise. When the client logs onto the CAS server 14, enters a registration code, and accepts the terms and conditions, a first time marketing e-mail is then despatched to the client. The client is also mailed with a brochure and a card file is couriered to the customer. The courier envelope is then handed across to the client upon presentation of an identity document of which the courier takes a copy. If the user is an existing client of the banking institution 20, the CAS server 14 passes the account number to the Internet banking server 16 which is used to ascertain the Internet banking status of the client. The user is then requested to verify himself with his password before the process can continue. The system 10 caters for situations where a selected user name already exists, when a user has forgotten his/her password and/or user name, or client registration details. Once the process has been completed, the system 10 generates a screen layout confirming the details provided by the client (see FIG. 28). Referring in particular to FIG. 29 of the drawings, reference numeral 230 generally indicates the flow process during registration of a user at the banking institution 20. Initially, an Internet banking login screen is provided as shown at block 232 whereafter authentication takes place as shown at block 234. If the client is not authenticated by the banking institution 20, registration in the system 10 takes place a shown at block 236 but details from the banking institution 20 are not passed on to the client administration server 14. If the user is authenticated, a check is done to ascertain whether or not there is a CAS register link as shown at block 238 and, if not, the process reverts back to the bank as shown at block 240. If, however, there is a registration link then CAS registration is effected as shown at block 242 and relevant data from the banking institution 20 is passed on to the CAS server 14. FIG. 30 shows a schematic block diagram of the client registration process at first time logon. Once registration of the system 10 has taken place, a registration code is sent to the user via e-mail which is then required to be entered for the system 10 to verify the user's identity. Provision is made in the system 10 for registration error code messages e.g. if the client has entered an incorrect e-mail address. Further, client profile customization facilities are provided to allow the client to include bonus services (see FIGS. 31 and 32). As shown in FIG. 33, the system 10 is arranged to provide a consolidated position 250 of the various facilities or services which a client or user of the system 10 uses. In particular, details of a bank balance 252 at the banking institution 20 are shown, details of share or stock portfolios 254 are shown, details of insurance taken through the comparative insurance web site 28 are shown as generally indicated by arrow 256, transaction statuses of the stockbrokerage web site 26 are shown at 258, d tails of transactions conducted via the online shopping facility 22 are shown at 260, and vouchers which have been earned are shown at 262. Various messages may also be generated as shown at 264. The consolidated position 250 includes data sourced from the CAS database 88 as well as data which the system 10 may poll from other servers e.g. the banking system server 18. Once the user has logged into the system 10, various options are available. Firstly, the customer may customize his/her profile. In particular, once the client has successfully logged on, he/she can change personal address details by selecting the “customize my profile” option (see block 268 in FIG. 34). If the client has not effected any changes to his/her profile within six months of the last change, it is required that the client confirms the client information by way of an additional message such as “please confirm that the information held on our database is still correct by selecting the OK button”. If any of the bank held information is changed a password is required. FIGS. 35, 36 and 41 show examples of screen layouts to accommodate this facility. As mentioned above, a password is required in order to modify or update bank held records. FIG. 37 shows a screen layout to delete a bank held address. In order to effect the changes, a further screen layout (see FIG. 38) is provided. The screen layout provided in FIG. 38 is only communicated to the client once all address and contact details relating to the bank have been effected. If the Internet bank verification has failed, a further screen layout is forwarded to the client as shown in FIG. 39. As shown in FIG. 40, the client may elect to open another bank account in response to which a further card is sent to the client via courier. When any bank related functions are executed by the user or client, a separate browser window is opened which directs the user to the Internet banking server 16. Referring to FIG. 42 of the drawings, reference numeral 300 generally indicates the user name validation and tracking process of the system 10. Once the user name and password is captured as shown at block 302, the system 10 ascertains whether or not the user exists (see block 304). If the user does not exist, an error is displayed as shown at block 306 whereafter a wrong user counter is incremented for the session as shown at block 308. Only a selected number of retries are permissible (see decision block 310) whereafter the user is forced to close the session (see block 312). If, however, the user successfully enters his/her password within the predetermined number of tries, a search is conducted for a user and the search results are shown (see blocks 314 and 316). If the user exists, a check is conducted to see if the password for the user is correct as shown at decision block 318 whereafter, if the password is correct, the user table is updated (see block 320) and the user home page is displayed (see block 322). If, however, the password is incorrect, the wrong password counter is incremented as shown at block 324 and, in a similar fashion to the wrong user counter, only a predetermined number of retries are possible as shown generally by arrow 326. User authentication is also provided at blocks 328, 330, and 332. If authentication fails, the user can call a customer care center via a telephonic communication link where an operator can unblock the user's account as generally indicated by arrow 334. Upon login to the Internet banking server 16, the banking institution 20 sends a profile identification code to the CAS server 14 as shown at block 338 which then provides a user password change screen (see block 340) and a check facility (as shown at block 342) to change the password. If the change in the password is successful, the user is directed to the user home page as shown at block 344. FIG. 43 shows the process of how the system 10 then deals with an incorrect user name and/or password. Referring in particular to FIG. 44 of the drawings, reference numeral 350 generally indicates the CAS administration process for bank maintenance by a system administrator. All processes in which information is added, changed or deleted in the CAS database 88 are confirmed with the user before any changes are effected. The CAS administration process of the system 10 allows a user to create a bank as shown at block 352, to delete a bank as shown at block 354, and to edit banking details as shown at block 356. If the user selects the option to create a new bank, confirmation of the instruction is sent to the user at block 358 whereafter product details are captured as shown at block 360. The product details are then confirmed (see block 362) whereafter a card is created as shown at block 364. Card details are subsequently confirmed as shown at block 366 and a request for further cards is then processed as shown at decision block 368. Contact details are confirmed and captured (see arrow 370) and branch details are confirmed as shown at arrow 372. When deleting a banking institution, confirmation is requested as shown at decision block 374, whereafter confirmation as to whether or not the user is indeed a subscriber is ascertained as shown at decision block 376. Prior to removal of the bank details and all related bank records as shown at block 378, the user is required to confirm the deletion process (s e block 380). When editing bank details, as shown at block 356, a user may select either to edit bank branch details (as shown by arrow 382) or edit bank products as shown by arrow 384. All processes where information is added, changed or deleted in the database will be confirmed with the user before the changes are effected.

Bank List

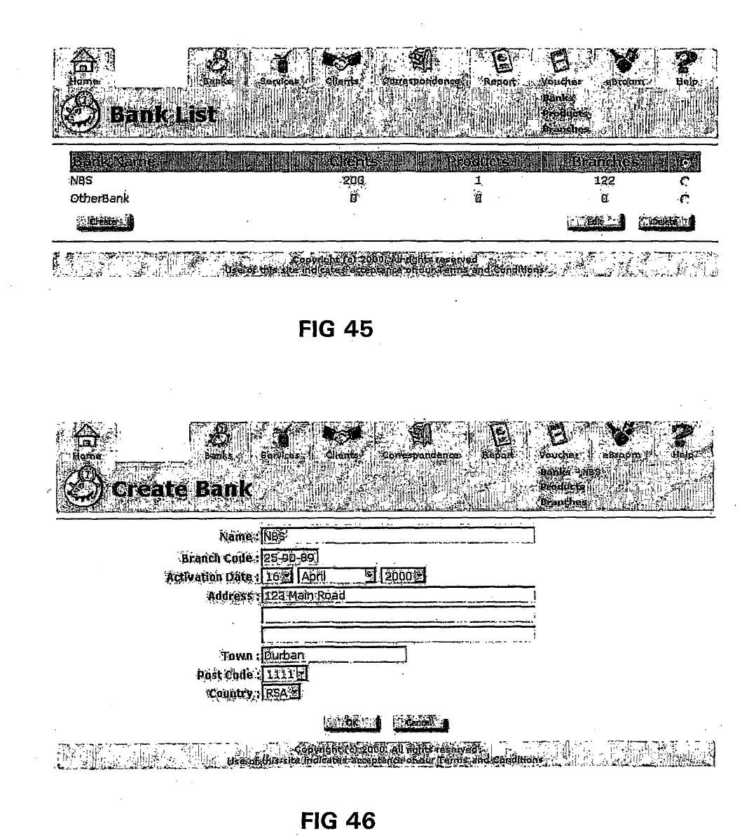

All banking institution or bank related operations are accessed by the Administrator via the Banks tab on the Icanonline web site. Once clicked, the screen will refresh to show the list of active banks (see FIG. 45). The operations accessible from the above screen are:

Creating a New Bank;

Editing, deleting a current Bank;

Editing a Bank's Products, Cards, Contacts and Branches. Each Listing screen operates in the same fashion. If the desired operation is Delete or Edit, the user must first select one of the radio buttons listed to the right of the list. Once selected, the desired operation can be performed. If only one list of items exists on the page, the Create operation can be selected without selecting an existing item; if more than one list of items exists on the page, the user must first select one of the radio buttons to the right of the list item heading.

Fields:

| Field Name | Caption | Required | Rules |
|---|---|---|---|
| Bank.Name | BankName | N/A | |
| count(Client.BankCode) | Clients | N/A | 1 |
| count(BankService.BankCode) | Products | N/A | 2 |
| count(BankBranch.BankCode) | Branches | N/A | 3 |
| N/A | Create | N/A | 4 |
| N/A | Edit / View | N/A | 6 |
| N/A | Delete | N/A | 5 |

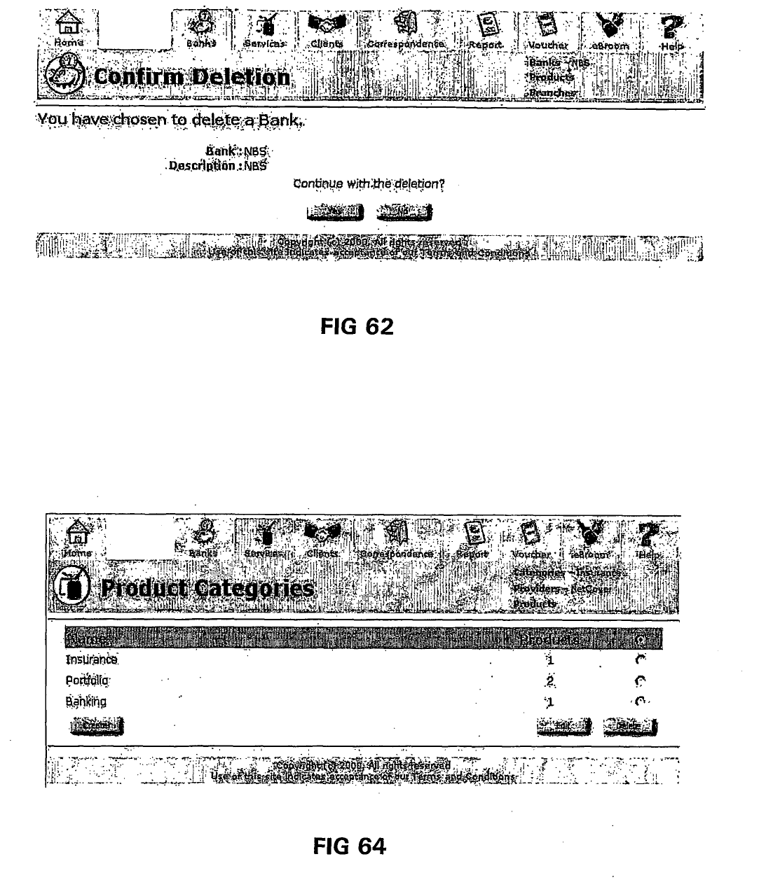

Rules:

| No. | Rules |
|---|---|
| 1 | Count of Client Profiles linked to current Bank |
| 2 | Count of Products linked to current Bank |
| 3 | Count of Branches linked to Current Bank |
| 4 | Display Create a New Bank (see FIG. 46) |
| 5 | User must select an available bank from the select column. |
| | The system will then display Confirm Remove for deleting |
| | the bank selected (see FIG. 62). |
| 6 | User must select an available bank from the select column. |
| | The system will then display the Edit a Bank for the Bank |
| | selected (see FIG. 54). |

Create a New Bank by an Administrator (see FIG. 46) The Address Details are for internal use only and are not displayed to users. The Bank Branches section is shown to users when they have to visit a branch to verify their details.

Fields:

| Field Name | Caption | Required | Rules |
|---|---|---|---|
| Bank.BankID | Not Shown | Yes | 1 |
| Bank.Name | Name | Yes | 2 |
| Bank.BranchCode | Branch Code | Yes | 3 |
| Bank.Status | Activation | N/A | 4 |
| | Date | | |
| Bank.Address1 | Address | Yes | |
| Bank.Address2 | | Yes | |
| Bank.Address3 | | No | |
| Bank.Town | Town | Yes | |
| Bank.PostCode | Post Code | Yes | 5 |
| Bank.CountryCode | Country | Yes | 6 |
| N/A | OK | N/A | 7 |
| N/A | Cancel | N/A | 8 |

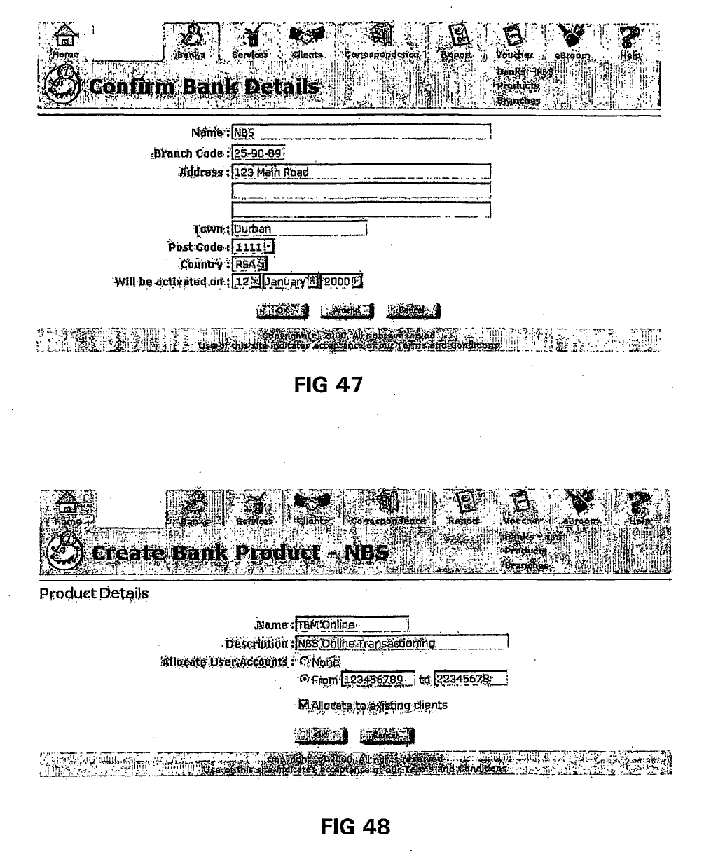

Rules:

| No. | Rules |
|---|---|
| 1 | Internal Code automatically allocated on record creation. |
| 2 | The descriptive Name of Bank. Must be unique. |
| 3 | 6 Digit number for the “physical” branch where the account |
| | is held. For NBS accounts, will be 72-00-26, all other banks, |
| | will be the Branch Sort Code. |
| 4 | Date to Activated the Bank. Must be a valid date, not in |
| | the past. Will set the Status to Pending until the |
| | Administrator confirms the action at the end of the |
| | creation process. |
| 5 | Use PostCode table to populate combo list. |
| 6 | Use Country table to populate combo list. Default to “RSA” |
| 7 | Validate and save current details, display. |
| | Confirm the New Bank (see FIG. 47) |
| 8 | Cancel current Process, return to Bank List (see FIG. 45) |

Confirm the New Bank

After a new bank is created, the administrator must confirm the bank details (see FIG. 47). The fields and rules required ar set out below:

Fields:

| Field Name | Caption | Required | Rules |
|---|---|---|---|
| Bank.BankID | Not shown | N/A | |
| Bank.Name | Name | N/A | |
| Bank.BranchCode | Branch Code | N/A | |
| Bank.Address1, Bank.Address2, | Address | N/A | |
| Bank.Address3, Bank.Town, | | | |
| Bank.PostCode, Country.Name | | | |
| N/A | Bank will be | N/A | |
| | activated on | | |
| N/A | OK | N/A | 1, 2 |
| N/A | Amend | N/A | 3 |
| N/A | Cancel | N/A | 4 |

Rules:

| No. | Rules |
|---|---|
| 1 | Bank.StatusCode to “PND” |
| | Insert a task for eBroom to activate on the specified date. |
| 2 | Save changes. Continue with the wizard of creating a Bank. |
| | Create all Bank Products, then create all card data is for |
| | the products created for the Bank, then all the contact |
| | details for these products. |
| 3 | Show |
| | Edit a Bank (see FIG. 54). |
| 4 | Remove the record, display Bank List (see FIG. 45). |

*Create Bank Product An example of a create bank product screen is shown in FIG. 48 and the required fields and rules are set out below:

Fields:

| Field Name | Caption | Required | Rules |
|---|---|---|---|
| BankSevice.Name | Name | Yes | 1 |
| BankService.Description | Description | Yes | 2 |
| BankService.AccountRangeFrom | Allocate User | No | 3, 4 |
| BankService.AccountRangeTo | Accounts: | | |
| | None or From | | |
| | Range | | |
| N/A | Allocate | No | 4 |
| | to existing | | |
| | clients | | |
| N/A | OK | N/A | 6 |
| N/A | Cancel | N/A | 5 |

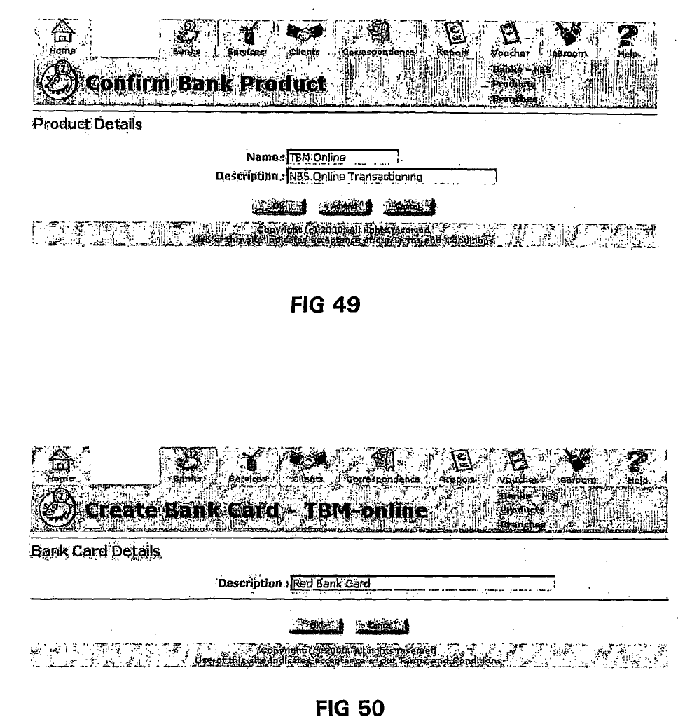

Rules:

| No. | Rules |
|---|---|
| 1 | The Product Name. It must be unique. |
| 2 | A description for the Product. |
| 3 | An account range is entered if the bank product would like |
| | the TBM system 10 to allocate account numbers automatically. |
| | CAS will then send the client information to the bank, as |
| | per the Service Interaction Specification. |
| | If None is selected, the two account number fields, and the |
| | Allocate to existing check box are disabled. If the user |
| | selects the From option, the account numbers and the |
| | checkbox are enabled. |
| 4 | The TBM system 10 can allocated account numbers to all |
| | ClientProfile records. This function can be called at any |
| | point in time. A task will be scheduled in eBroom to |
| | allocate these accounts. |
| | A check is done on the account number range: The number of |
| | available account numbers must be more than the number of |
| | ClientProfile records plus a specified buffer. This buffer |
| | is stored in the system variables table. |
| 5 | Validate and save current details, display Confirm the New |
| | Bank Product (see FIG. 49). |
| 6 | The first Product, display message New Bank Product Error |
| | Message. |
| | If one Product exists, continue with the wizard creation |
| | of the Bank. |

Confirm the New Bank Product After a new bank product has been created, a confirmation screen is displayed (see FIG. 49). The following fields and rules are defined:

Fields:

| Field Name | Caption | Required | Rules |
|---|---|---|---|
| BankSevice.Name | Name | N/A | |
| BankService.Description | Description | N/A | |
| N/A | OK | N/A | 1 |
| N/A | Amend | N/A | 2 |
| N/A | Cancel | N/A | 3 |

Rules:

| No. | Rules |
|---|---|
| 1 | Save changes. Continue with the wizard of creating a Bank. |
| 2 | Show Edit Bank Product (see FIG. 56). |
| 3 | Do not save, display Create Bank Product (see FIG. 48). |

Create Bank Product Card Once a new bank product has been successfully created, a bank product card is then produced (see FIG. 50). If more than one Product was created, all the Product's card details can be captured in one process.

Fields:

| Field Name | Caption | Required | Rules |
|---|---|---|---|
| BankServiceCard.Description | Description | Yes | 1 |
| N/A | OK | N/A | 2 |
| N/A | Cancel | N/A | 3 |

Rules:

| No. | Rules |
|---|---|
| 1 | A description for the Product Card. This must be unique per Bank. |
| 2 | Validate and save current details, display Confirm the New Bank |
| | Product Card |
| 3 | It is not required that Products have Cards. Continue with the |
| | wizard creation of the Bank. |

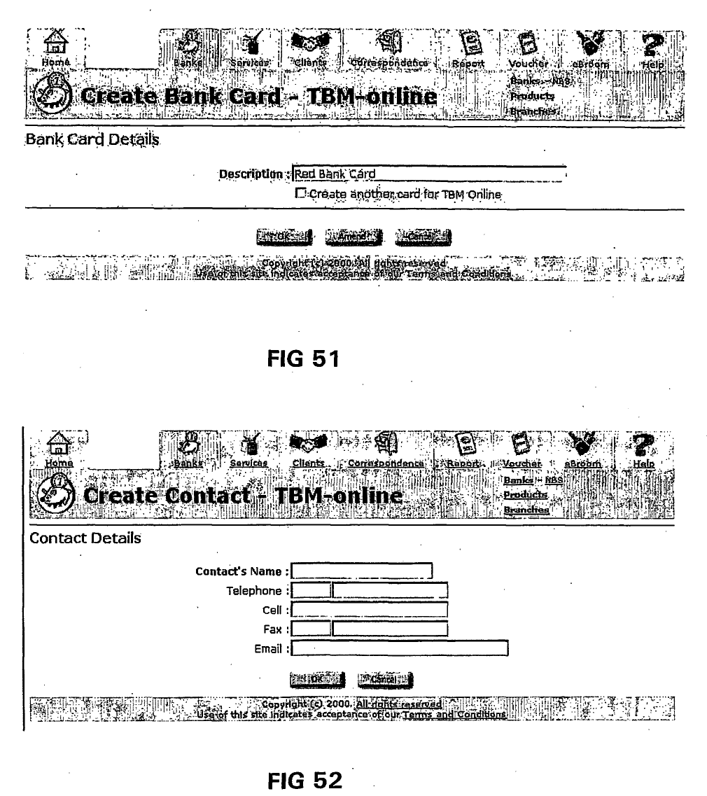

Confirm the New Bank Product. Card New bank product cards are confirmed upon finalization thereof (see FIG. 51).

Fields:

| Field Name | Caption | Required | Rules |
|---|---|---|---|
| BankServiceCard.Description | Description | N/A | |
| N/A | Create Another Card? | N/A | 1 |
| N/A | OK | N/A | 2 |
| N/A | Amend | N/A | 3 |
| N/A | Cancel | N/A | 4 |

Rules:

| No. | Rules |
|---|---|
| 1 | If this option is selected, Create Bank Product Card (see FIG. 50) |
| | will be displayed for the creation of another bankcard. If there |
| | is more than one product, the user will have the option to add |
| | another bankcard for all the products. If this option is not |
| | selected, continue with the wizard of creating a Bank. |
| 2 | Save changes. Continue with the wizard of creating a Bank. |
| 3 | Show Create Bank Product Card (see FIG. 50), pre-populated with |
| | captured information. |
| 4 | Do not save, display Create Bank Product Card (see FIG. 50). |

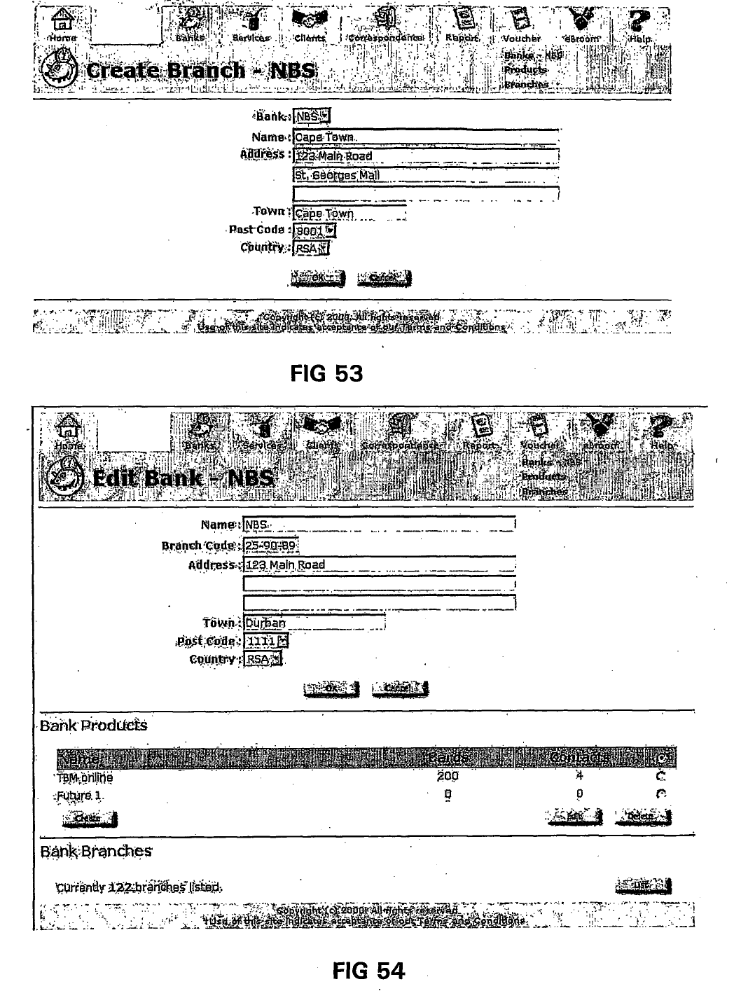

Create a Bank Branch A bank branch can be created via the screen display shown in FIG. 53. The BankBranch table will be pre-populated with NBS branch information before the go-live date of the system 10.

Fields:

| Field Name | Caption | Required | Rules |
|---|---|---|---|
| BankBranch.Name | Name | Yes | 1 |
| BankBranch.Address1 | Address | Yes | 2 |
| BankBranch.Address2 | | No | 2 |
| BankBranch.Address3 | | No | 2 |
| BankBranch.Town | Town | Yes | 3 |
| BankBranch.PostCode | Post Code | Yes | 4 |
| BankBranch.Country | Country | Yes | 5 |
| N/A | OK | N/A | 6 |
| N/A | Cancel | N/A | 7 |

Rules:

| No. | Rules |
|---|---|
| 1 | Name of the Branch, must be unique. |
| 2 | Must be the physical address. |
| 3 | Town must be valid, used for grouping purposes. |
| 4 | Use PostCode table to populate combo list. |
| 5 | Use Country table to populate combo list. Will default |
| | to “RSA”. |
| 6 | Display Confirm the New Bank Branch (see below). |
| 7 | The first Branch, display message New Bank Branch Error |
| | Message. |
| | If one Branch exists for the bank, display Bank List |
| | (see FIG. 45) if in the process of creating a bank, or |
| | Edit a Bank (see FIG. 54) when editing a bank or Branch |
| | List (see FIG. 45), depending on the origin of the |
| | creation request. |

Confirm the New Bank Branch This page displays a confirmation message for the creation of the New Bank Branch. The page has the same information as the Create Branch page (see FIG. 53), but the information is read only.

Fields:

| Field Name | Caption | Required | Rules |
|---|---|---|---|
| BankBranch.Name | Name | N/A | |
| BankBranch.Address1, | | | |
| BankBranch.Address2, | | | |
| BankBranch.Address3, | | | |
| BankBranch.Town, | | | |
| BankBranch.PostCode, | | | |
| Country.Name | | | |
| N/A | Create another | N/A | 1 |
| | Branch? | | |
| N/A | OK | N/A | 2 |
| N/A | Amend | N/A | 3 |
| N/A | Cancel | N/A | 4 |

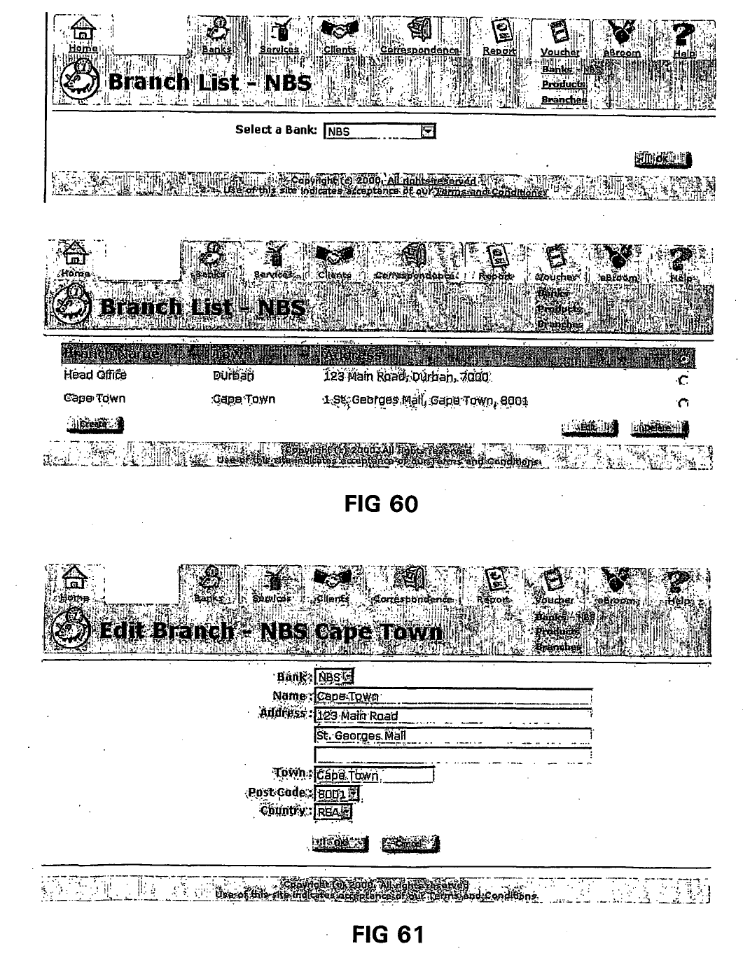

Rules:

| No. | Rules |
|---|---|
| 1 | If this option is selected, Create a Bank Branch (see FIG. 53) |
| | is displayed for the creation of another bank. |
| 2 | Save changes. Display Bank List (see FIG. 45) if in the process |
| | of creating a bank, or |
| | Edit a Bank (see FIG. 54) when editing a bank or Branch List |
| | (see FIG. 60), depending on this origin of the creation request. |
| 3 | Show Edit a Bank Branch (see FIG. 61), pre-populated with |
| | captured information. |
| 4 | Do not save, display Create a Bank Branch (see FIG. 53). |

Edit a Bank A bank may be edited using the screen display of FIG. 54.

Fields:

| Field Name | Caption | Required | Rules |
|---|---|---|---|
| Bank.BankID | Not shown | Yes | 1 |
| Bank.Name | Name | Yes | 2 |
| Bank.BranchCode | Branch Code | Yes | |
| BankService.Address1 | Address | Yes | |
| BankService.Address2 | | No | |
| BankService.Address3 | | No | |
| BankService.Town | Town | Yes | |
| BankService.PostCode | Post Code | No | 3 |
| BankService.CountyCode | Country | Yes | 4 |

Bank Products

Fields:

| Field Name | Caption | Required | Rules |
|---|---|---|---|
| BankProduct.Name | Name | N/A | 5 |
| BankProduct.Description | Descrip- | N/A | 5 |
| | tion | | |
| Count(BankCard) | Cards | N/A | 5 |
| Count(ClientProfileBankAccount) | Clients | N/A | 5 |
| N/A | Create | N/A | 5 |
| N/A | Delete | N/A | 5 |
| N/A | Edit | N/A | 5 |

Bank Branches

Fields:

| Field Name | Caption | Required | Rules |
|---|---|---|---|
| Count(BankBranch) | Bank | N/A | 6 |
| | Branches | | |
| N/A | List | N/A | 6 |
| N/A | OK | N/A | 7 |
| N/A | Cancel | N/A | 8 |

Rules:

| No. | Rules |
|---|---|
| 1 | Unique ID allocated on record creation. |
| 2 | Descriptive Name of Bank, must be unique. |
| 3 | Use PostCode to populate combo list. |
| 4 | Use Country to populate combo list, defaults to RSA. |
| 5 | List Name, Description for each record in BankProduct for |
| | BankId, sort by Name. Count number of Clients & Cards for |
| | each Product. Create will display Create Bank Product |
| | (see FIG. 48). User must select a listed item before |
| | clicking Edit, Delete. Edit will display Edit Bank |
| | Product (see FIG. 56). Delete will display Confirm |
| | Remove Bank Product (see below). |
| 6 | Count the number of active branches for this Bank. List |
| | button will show Branch List (see FIG. 60). |
| 7 | Display Confirmation Message. See Confirm the Bank (FIG. 47). |
| 8 | Cancel changes Display Bank List (see FIG. 45). |

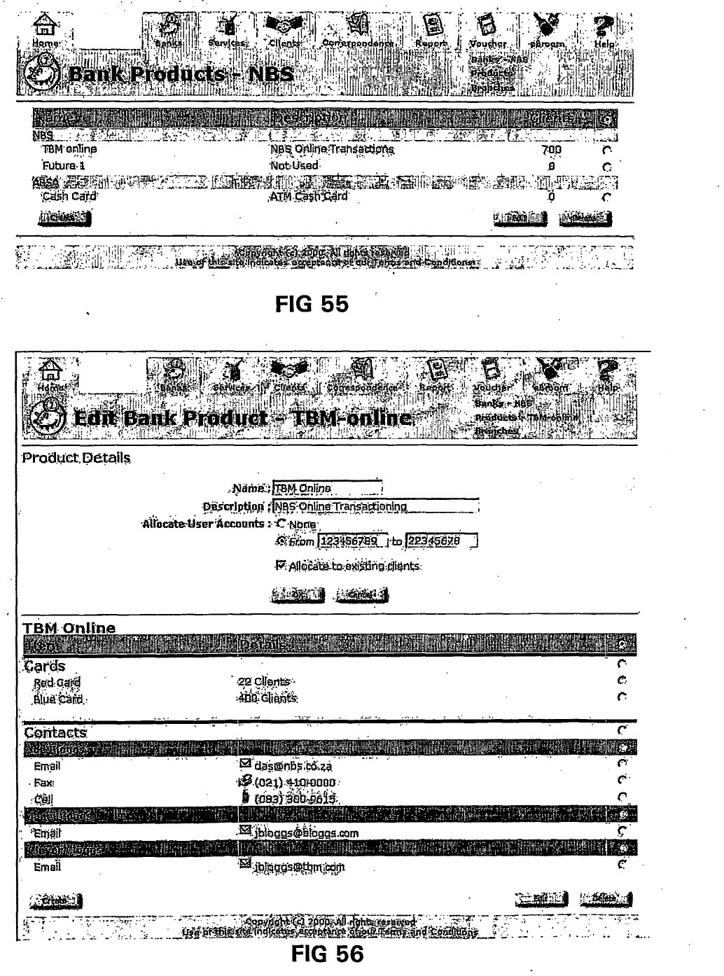

Bank Product List An example of a screen layout for a bank product list is shown in FIG. 55. The fields and rules are as follows:

Fields:

| Field Name | Caption | Required | Rules |
|---|---|---|---|
| Bank.Name / | Name | N/A | |
| BankService.Name | | | |
| BankService.Description | Description | N/A | |
| count(Client.BankServiceCode) | Clients | N/A | 1 |
| N/A | Create | N/A | 2 |
| N/A | Edit | N/A | 4 |
| N/A | Delete | N/A | 3 |

Rules:

| No. | Rules |
|---|---|
| 1 | Count of Client Profiles linked to current Bank. |
| 2 | Display Create Bank Product (see FIG. 48). Continue with |
| | wizard, as with the Bank Creation. |
| 3 | User must select an available branch from the select column. |
| | The system will then display Confirm: Remove Bank Product |
| | for deleting the bank selected. |
| 4 | User mus select an available bank product from the select |
| | column. The system will then display the Edit Bank Product |
| | (see FIG. 56) for the product selected. |

Edit Bank Product Bank products may be edited as shown in FIG. 56.

Fields:

| Field Name | Caption | Required | Rules |
|---|---|---|---|
| BankSevice.Name | Name | Yes | 1 |
| BankService.Description | Description | Yes | 2 |
| BankService.AccountRangeFrom, | Allocate | No | 3, 4 |
| | User | | |
| BankService.AccountRangeTo | Accounts: | | |
| | None or | | |
| | From Range | | |
| N/A | Allocate to | No | 4 |
| | existing | | |
| | clients | | |

Cards
Fields:

| Field Name | Caption | Required | Rules |
|---|---|---|---|
| BankCard.Description | Description | N/A | 5 |
| Count(Client.BankCardCde) | Clients | N/A | 5 |
| N/A | Create | N/A | 5 |
| N/A | Delete | N/A | 5 |
| N/A | Edit | N/A | 5 |

Confirm the Bank Product Changes See confirm the New Bank Product (see also FIG. 49).

Edit a Bank Card

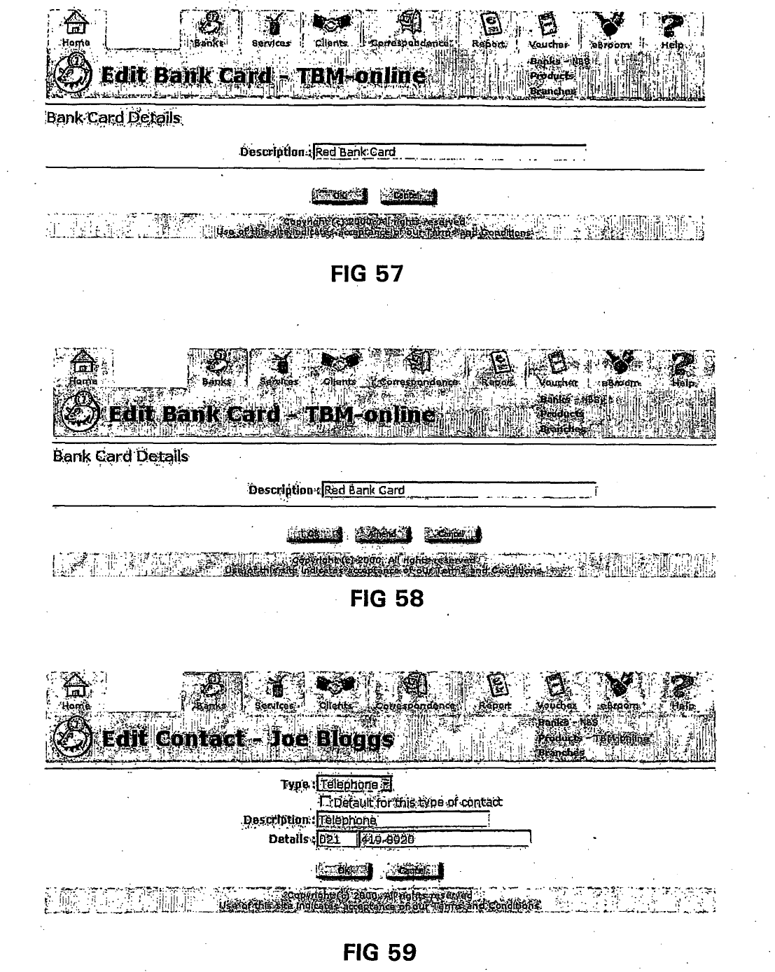

The system 10 makes provision for the editing of a bank card (see FIG. 57). The fields and rules are as follows:

Fields:

| Field Name | Caption | Required | Rules |
|---|---|---|---|
| BankCard.BankCode | | No | 1 |
| BankCard.Description | Description | Yes | 2 |
| N/A | OK | N/A | 3 |
| N/A | Cancel | N/A | 4 |

Rules:

| No. | Rules |
|---|---|
| 1 | Not shown, Used for Page Title. |
| 2 | Descriptive Name of Card. |
| 3 | Display Confirmation Message. See Confirm the Bank |
| | Card Change (see FIG. 58). |
| 4 | Cancel changes and display Edit Bank Product (see FIG. 56). |

Confirm the Bank Card Change The screen layout to confirm a bank card change is shown in FIG. 58.

The fields and rules are as follows:

Fields:

| Field Name | Caption | Required | Rules |
|---|---|---|---|
| BankServiceCard.Description | Description | N/A | |
| N/A | OK | N/A | 1 |
| N/A | Amend | N/A | 2 |
| N/A | Cancel | N/A | 3 |

Rules:

| No. | Rules |
|---|---|
| 1 | Save changes. Continue with the wizard of creating a Bank. |
| 2 | Show Edit a Bank Card (see FIG. 57), pre-populated with |
| | captured information. |
| 3 | Do not save. Display Edit Bank Product (see FIG. 56). |

Edit Bank Product Contact Person Details The screen layout to edit bank product contact details is shown in FIG. 59 and the fields and rules are set out below:

Fields:

| Field Name | Caption | Required | Rules |
|---|---|---|---|
| BankServiceContactPerson.Name | Contact | Yes | 1 |
| | Person | | |
| BankServiceContactPersonDetail.Con- | Type | Yes | 1, 2 |
| tactType | | | |
| BankServiceContactPersonDetail.De- | Descrip- | Yes | 1 |
| scription | tion | | |
| BankServiceContactPersonDetail.De- | Details | Yes | 1, 3 |
| tails | | | |
| N/A | Create | N/A | 1, 4 |
| N/A | Delete | N/A | 1, 5 |
| N/A | Cancel | N/A | 6 |

Rules:

| No. | Rules |
|---|---|
| 1 | List all the existing contact details for the person as |
| | is in the database. The user can then elect to change any |
| | of this information, or to create or delete |
| | a record by selecting the appropriate buttons. |
| 2 | Populate drop down from ContactType table. |
| 3 | Read the area code at the end of the number with, numbers |
| | separated by a “\|\|”. “5438762 \|\| 021”. Use the “\|\|” delimiter |
| | to pick up the area code in future. |
| 4 | At least one contact number must exist. Display Create Bank |
| | Product Contact (see FIG. 52). |
| 5 | Display Confirm: Remove Bank Contact Person Detail (see below). |
| 6 | Display Edit Bank Product (see FIG. 56). |

Confirm the Bank Product Contact Person Changes This page displays a confirmation message for the addition of the Bank. Person Contact Details. The page has the same information as the Edit page, but the information is read only.

Fields:

| Field Name | Caption | Required | Rules |
|---|---|---|---|
| BankServiceContactPerson.Name | Contact | N/A | |
| | Person | | |
| BankServiceContactPersonDetail.Con- | Type | N/A | |
| tactType | | | |
| BankServiceContactPersonDetail.De- | Descrip- | N/A | |
| scription | tion | | |
| BankServiceContactPersonDetail.Details | Details | N/A | |
| N/A | OK | N/A | 1 |
| N/A | Amend | N/A | 2 |
| N/A | Cancel | N/A | 3 |

Rules:

| No. | Rules |
|---|---|
| 1 | Save changes. Display Edit Bank Product (see FIG. 56). |
| 2 | Show Edit Bank Product Contact Person Details (see FIG. 59), |
| | pre-populated with captured information. |
| 3 | Do not save. Display Edit Bank Product (see FIG. 56). |

Branch List Screen layouts of branch lists are shown in FIG. 60. The fields and rules are as follows:

Fields:

| Field Name | Caption | Required | Rules |
|---|---|---|---|
| Bank.Name | Bank | No | 1 |
| BankBranch.Name | Branch Name | No | 2 |
| BankBranch.Town | Town | No | 2 |
| BankBranch.Address1, | Address | No | 2 |
| BankBranch.Address2, | | | |
| BankBranchAddress3, | | | |
| BankBranch.Town, | | | |
| BankBranch.PostCode. | | | |
| N/A | Create | N/A | 3 |
| N/A | Delete | N/A | 4 |
| N/A | Edit | N/A | 5 |

Rules:

| No. | Rules |
|---|---|
| 1 | Use Bank table to populate all banks. Only display |
| | branches for the bank selected in the combo box. If this |
| | screen was reached without selecting a Bank, display a |
| | drop-down list of all Banks and display this screen when |
| | the user selects one of the available banks. |
| 2 | List all records from BankBranch where BankCode is the |
| | selected bank. |
| 3 | Display Create a Bank Branch (see FIG. 53). |
| 4 | Display Confirm: Remove Bank Branch. |
| 5 | Display Edit a Bank Branch (see FIG. 61). |

*Edit a Bank Branch The screen layout for editing a bank branch is shown in FIG. 61. The fields and rules are as follows:

Fields:

| Field Name | Caption | Required | Rules |
|---|---|---|---|
| BankBranch.BankCode | Bank | No | 1 |
| BankBranch.Name | Name | No | 2 |
| BankBranch.Address1 | Address | Yes | 3 |
| BankBranch.Address2 | | No | 3 |
| BankBranch.Address3 | | No | 3 |
| BankBranch.Town | Town | Yes | 4 |
| BankBranch.PostCode | Post Code | Yes | 5 |
| BankBranch.Country | Country | Yes | 6 |
| N/A | OK | N/A | 7 |
| N/A | Cancel | N/A | 8 |

Rules:

| No. | Rules |
|---|---|
| 1 | Not editable. |
| 2 | Not Editable. |
| 3 | Physical Address, first line must be completed. |
| 4 | Must be valid, used for Grouping purposes. |
| 5 | Use PostCode table to populate. |
| 6 | Use Country table to populate combo list. |
| | Will default to “RSA”. |
| 7 | Display Confirmation Page. See Confirm the New |
| | Bank Branch (see FIG. 53). |
| 8 | Discard changes and display |
| | Edit a Bank (see FIG. 54). |

Confirm: Remove Bank The screen layout to confirm removal of a bank is shown in FIG. 62 and the fields and rules are set out below:

Fields:

| Field Name | Caption | Required | Rules |
|---|---|---|---|
| Bank.BankCode | Code | N/A | |
| Bank.Name | Name | N/A | |
| Bank.BranchCode | Branch Code | N/A | |
| Bank.Address1, | Address | N/A | |
| Bank.Address2, | | | |
| Bank.Address3, | | | |
| Bank.Town, | | | |
| Bank.PostCode, | | | |
| Country.Name | | | |
| Count(ClientProfile.BankCode) | Subscribed | N/A | 1 |
| | Users | | |
| N/A | OK | N/A | 2, 3 |
| N/A | Cancel | N/A | 3 |

Rules:

| No. | Rules |
|---|---|
| 1 | Count the number of ClientProfile where BankCode is |
| | the one selected for deletion. |
| 2 | For the deletion of a bank, there must be no related |
| | records in the following tables linking to this bank |
| | (Display error message, Remove Bank Error |
| | Message: Records Exist in Related Tables): |
| | ClientBank; |
| | ClientProfile; |
| | ClientProfileAccount. |
| | On deletion of the bank, the records in the following |
| | tables are also deleted: |
| | BankBranch; |
| | BankCard; |
| | BankService; |
| | BankServiceContactPerson; |
| | BankServiceContactPersonDetail. |
| 3 | Show Bank List (see FIG. 45). |

Remove Bank Error Message: Records Exist in Related Tables. If records exist in related tables, display an error message:

“There are related records in ClientProfile, the Bank cannot be deleted”.

Confirm: Remove Bank Product

The same information is displayed as for the edit pages.

Fields:

| Field Name | Caption | Required | Rules |
|---|---|---|---|
| BankSevice.Name | Name | N/A | |
| BankService.Description | Descrip- | N/A | |
| | tion | | |
| Count(ClientProfile.BankCode) | Sub- | N/A | 1 |
| | scribed | | |
| | Users | | |
| N/A | OK | N/A | 2, 3 |
| N/A | Cancel | N/A | 3 |

Rules:

| No. | Rules |
|---|---|
| 1 | Count the number of ClientProfileAccount where BankCode |
| | and BankServiceID is the one selected for deletion. |
| 2 | For the deletion of a bank product, there must be no |
| | related records in the following tables linking to this |
| | bank product (Display error message (see below), Remove |
| | Bank Product Error Message: Records Exist in Related Tables). |
| | ClientProfileAccount. |
| | On deletion of the bank product, the records in the |
| | following tables are also deleted: |
| | BankCard; |
| | BankServiceContactPerson; |
| | BankServiceContactPersonDetail. |
| | If this is the only Bank Product for the Bank, display error |
| | message (see below): Remove Bank Product Error Message: At |
| | least one Bank Product must exist. |
| 3 | Show Bank Product List (see FIG. 55) or Edit a Bank |
| | (see FIG. 54) depending on the origin or the request. |

Remove Bank Product Error Message: Records Exist in Related Tables. If records exist in related tables, display an error message: “There are related records in ClientProfileAccount, the BankProduct cannot be deleted”. Remove Bank Product Error Message: At least one Bank Product must exist. If this is the only Bank Product for the Bank, display an error message: “At least one Bank Product must exist for a Bank, the BankProduct cannot be deleted”. Confirm: Remove Bank Product Contact Person The same information is displayed as for the edit pages.

Fields:

| | | Re- | |
|---|---|---|---|
| Field Name | Caption | quired | Rules |
| BankServiceContactPerson.Name | Contact | N/A | 1 |
| | Person | | |
| BankServiceContactPersonDetail.Con- | Type | N/A | 1 |
| tactType | | | |
| BankServiceContactPersonDetail.De- | Descrip- | N/A | 1 |
| scription | tion | | |
| BankServiceContactPersonDetail.De- | Details | N/A | 1, 2 |
| tails | | | |
| N/A | OK | N/A | 3, 4 |
| N/A | Cancel | N/A | 4 |

Rules:

| No. | Rules |
|---|---|
| 1 | List all the existing contact details for the person |
| | as is in the database. |
| 2 | Read the area code at the end of the number with numbers |
| | separated by a “\|\|”. “5438762 \|\| 021”. Use the “\|\|” |
| | delimiter to pick up the area code in future. |
| 3 | Delete all related records in: |
| | BankServiceContactPersonDetail. |
| | If this is the only Contact Person for the Bank Product, |
| | display error message: |
| | Remove Contact Person Error Message: At least one Contact |
| | Person must exist (see below). |
| 4 | Show Edit Bank Product (see FIG. 56). |

Remove Contact Person Error Message: At least one Contact Person must exist. If this is the only Contact Person for the Bank Product, display an error message:

At least one Contact Person must exist for a Bank Product, the Contact Person cannot be deleted”. Confirm: Remove Bank Contact Person Detail This page displays a confirmation message for the deletion of the Bank Contact. The page has the same information as the Create Contact page, but the information is read only.

Fields:

Fields:

| | | Re- | |
|---|---|---|---|
| Field Name | Caption | quired | Rules |
| BankServiceContact.ContactTypeCode | Contact Type | N/A | |
| BankServiceContact.PrimaryContact- | Default for | N/A | |
| TypeInd | this type of | | |
| | contact | | |
| BankServiceContact.Description | Description | N/A | |
| BankServiceContact.Details | Details | N/A | |
| N/A | OK | N/A | 1 |
| N/A | Cancel | N/A | 2 |

Rules:

| No. | Rules |
|---|---|
| 1 | Delete the Bank Contact. |
| | Return to Edit Bank Product (see FIG. 56). |
| 2 | Do not delete the record. |
| | Return to Edit Bank Product (see FIG. 56). |

Confirm: Remove Bank Card This page displays a confirmation message for the deletion of the Bank Card. The page has the same information as the Create Card page, but the information is read only.

Fields:

| Field Name | Caption | Required | Rules |
|---|---|---|---|
| BankCard.BankCode | Bank | N/A | |
| BankCard.Description | Description | N/A | |
| N/A | OK | N/A | 1 |
| N/A | Cancel | N/A | 2 |

Rules:

| No. | Rules |
|---|---|
| 1 | A Bank card cannot be deleted if a Client has selected |
| | to use this bank card. |
| | The only time this record can be deleted is when there |
| | are no related records in ClientProfile. To permanently |
| | remove a bank card, these ClientProfile records must be |
| | altered: |
| | Delete the Bank Card. |
| | Return to Edit Bank Product (see FIG. 56). |
| 2 | Do not delete the record. |
| | Return to Edit Bank Product (see FIG. 56). |

*Confirm: Remove Bank Branch This page displays a confirmation message for the deletion of the New Bank Branch. The page has the same information as the Create Branch page, but the information is read only.

Fields:

| Field Name | Caption | Required | Rules |
|---|---|---|---|
| BankBranch.BankCode | Bank | N/A | |
| BankBranch.Name | Name | N/A | |
| BankBranch.Address1, | | | |
| BankBranch.Address2, | | | |
| BankBranch.Address3, | | | |
| BankBranch.Town, | | | |
| BankBranch.PostCode, | | | |
| Country.Name | | | |
| N/A | OK | N/A | 1 |
| N/A | Cancel | N/A | 2 |

Rules:

| No. | Rules |
|---|---|
| 1 | Delete the Bank Branch. |
| | Depending on the origin of the process, return to either |
| | Edit a Bank (see FIG. 54) or Branch List (see FIG. 60). |
| | If this is the only Branch for the Bank, display error |
| | message: Remove Bank Branch Error Message: At least one |
| | Branch must exist (see below). |
| 2 | Do not delete the record. |
| | Depending on the origin of the process, return to either |
| | Edit a Bank (see FIG. 54) or Branch List (see FIG. 60). |

Remove Bank Branch Error Message: At least one Branch must exist. If this is the only Branch for the Bank, display an error message:

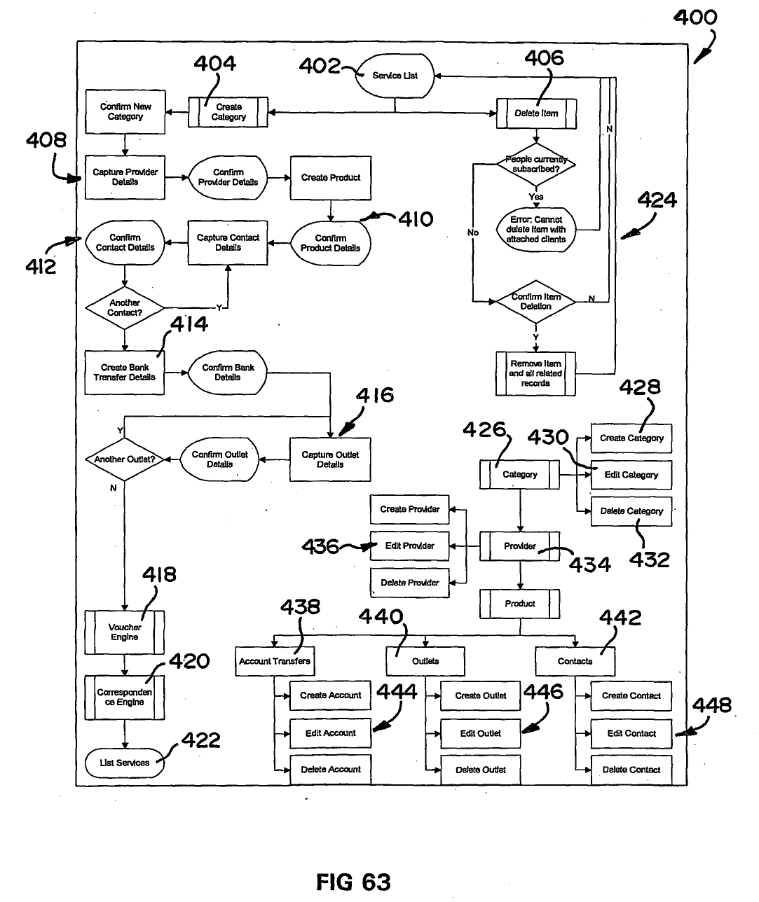

“At least one Branch must exist for a Bank, the Branch cannot be deleted”. Reference numeral 400 generally indicates the CAS administration process for product maintenance (see FIG. 63). A service list is provided (see block 402) which provides the option of creating a product category (see block 404) or deleting a product item as shown at block 406. When a product category is created, the new category is confirmed and provider or merchant details are captured and confirmed as generally indicated by reference numeral 408. Thereafter, the product is created and confirmed (see arrow 410) followed by the capturing and confirmation of product details as shown at 412. As shown at block 414, bank transfer details are created and thereafter confirmed and captured as generally indicated by arrow 416. The voucher engine and correspondence engine 418, 420 respectively are then activated and the goods and/or services are thereaft r listed as shown at 422. In order to delete a product item as shown at block 406, confirmation of subscription is first ascertained whereafter all related items and records are deleted as generally indicated by arrow 424. Categories of items (see block 426) can be created, edited or deleted (see blocks 428, 430 and 432). Likewise, a provider (see block 434) may either be created, edited or deleted (as shown by arrow 436). Account transfers (block 438), outlets 440, and contacts 442 may be created, edited and deleted as generally indicated by arrows 444, 446, and 448.

Product Category List An example of a screen display for this feature is shown in FIG. 64. The fields and rules are set out below.

Fields:

| Field Name | Caption | Required | Rules |
|---|---|---|---|
| ServiceCategory.Name | Name | N/A | |
| Count(Service.ServiceProvidedId) | Services | N/A | 1 |
| N/A | Create | N/A | 2 |
| N/A | Edit | N/A | 3 |
| N/A | Delete | N/A | 4 |

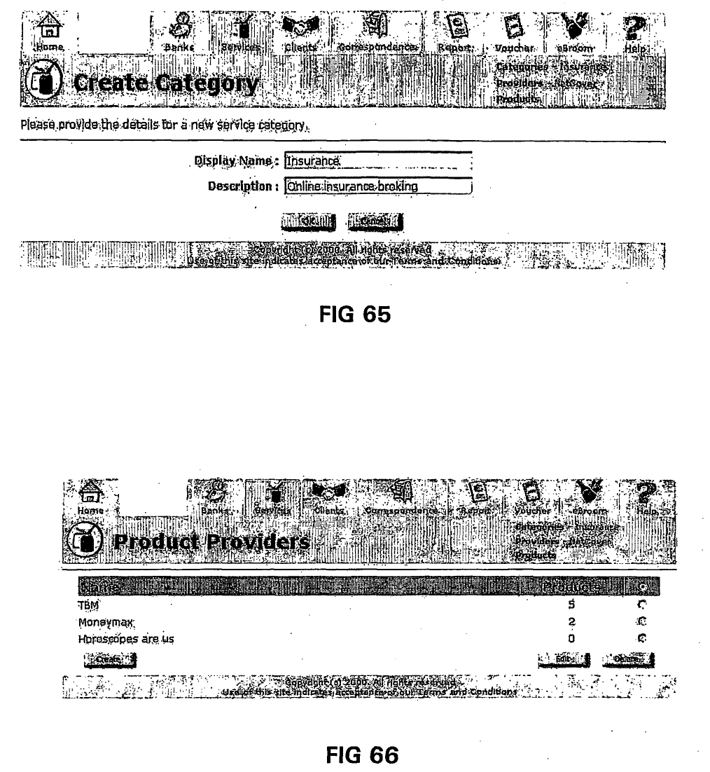

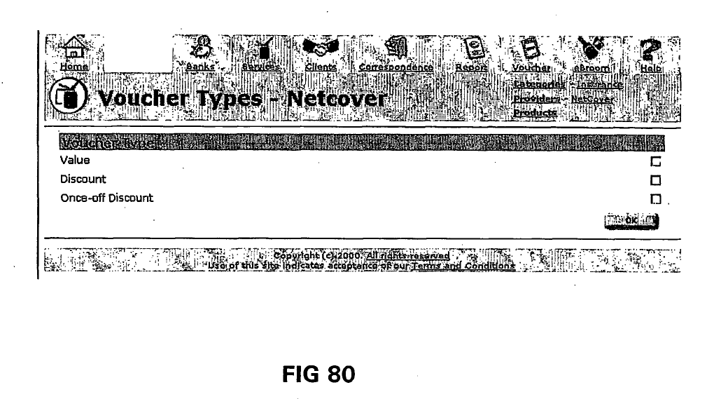

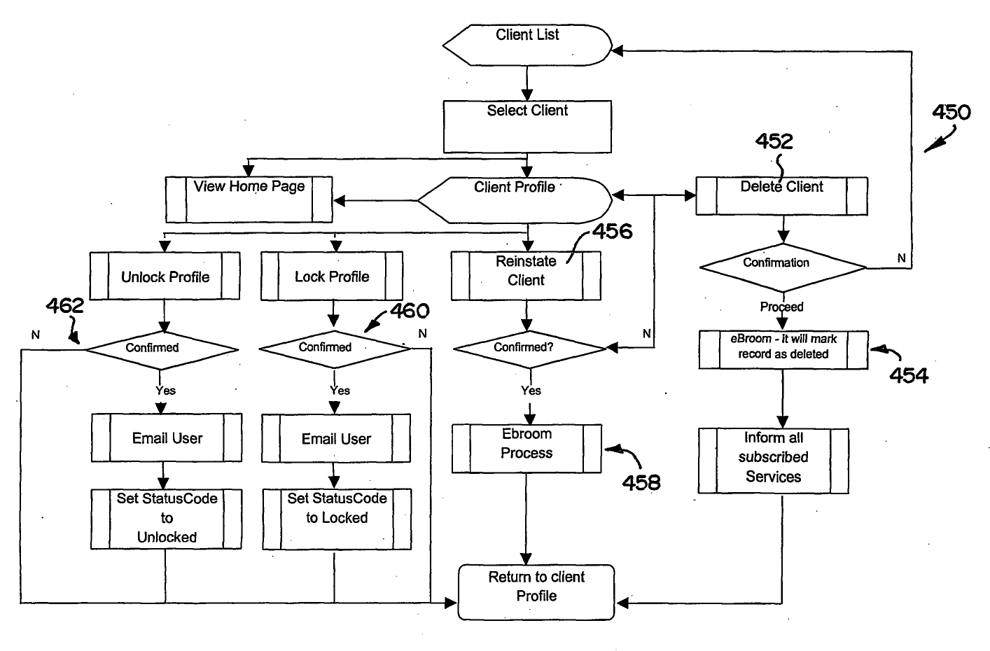

Rules:

| No. | Rules |
|---|---|
| 1 | Count of Active Products linked to the Product Category. |
| 2 | Display Create a New Product Category (see FIG. 65). |
| 3 | User must select an available Product category from the |
| | select column. The system will then display the Edit a |
| | Category for the Product category selected (see FIG. 73A). |
| 4 | User must select an available Product category from the |
| | select column. The system will then display Product Voucher |
| | Types (see FIG. 80) for dealing the Product category selected. |

* Create a New Product Category See FIG. 65 for an example of a screen display.

Fields:

| Field Name | Caption | Required | Rules |
|---|---|---|---|
| ServiceCategory.DisplayName | Display Name | Yes | 1 |
| ServiceCategory.Description | Description | Yes | 2 |
| N/A | OK | N/A | 3 |
| N/A | Cancel | N/A | 4 |

Rules:

| No. | Rules |
|---|---|
| 1 | The name to display to the Client (In the menu of |
| | the www.icanonline.co.za) |
| 2 | A short description for the Product Category. |
| 3 | Display confirmation message. |
| 4 | Cancel the creation of a Product Category, return |
| | to Product Category List (see FIG. 64). |

Confirm the New Product Category This page displays a confirmation message for the creation of the New Product Category. The page has the same information as the Create Product Category page, but the information is read only.

Fields:

Fields:

| Field Name | Caption | Required | Rules |
|---|---|---|---|
| ServiceCategory.DisplayName | Display Name | N/A | |
| ServiceCategory.Description | Description | N/A | |
| N/A | OK | N/A | 1 |
| N/A | Amend | N/A | 2 |
| N/A | Cancel | N/A | 3 |

Rules:

| No. | Rules |
|---|---|
| 1 | Save changes. |
| | Return to Product Category List (see FIG. 64). |
| 2 | Show Edit a Category (see FIG. 73A). |
| 3 | Do not save the record. |
| | Return to Product Category List. |

Product Provider List (see FIG. 66)

Fields:

| Field Name | Caption | Required | Rules |
|---|---|---|---|
| ServiceProvider.Name | Name | N/A | |
| Count(Service.ServiceProviderId) | Products | N/A | 1 |
| N/A | Create | N/A | 2 |
| N/A | Edit | N/A | 3 |
| N/A | Delete | N/A | 4 |

Rules:

| No. | Rules |
|---|---|
| 1 | Count of Active Products linked to the Product Provider. |
| 2 | Display Create a New Product Provider. |
| 3 | User must select an available Product provider from the select |
| | column. The system will then display the Edit Product Provider |
| | for the Product provider selected. |
| 4 | User must select an available Product provider from the select |
| | column. The system will then display Confirm Remove Product |
| | Provider for deleting the Product provider selected. |

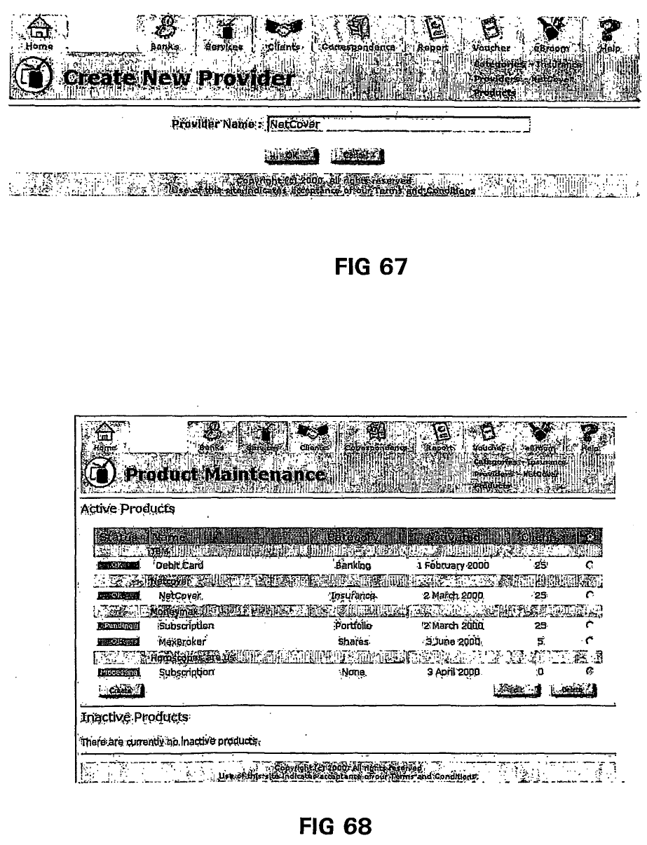

Create a New Product Provider (see FIG. 67)

Fields:

| | | Re- | |
|---|---|---|---|
| Field Name | Caption | quired | Rules |
| ServiceProvider.Name | Name | Yes | |
| ServiceProvicer.InternalServiceProviderInd | <not | No | 1 |
| | shown> | | |
| N/A | OK | N/A | 2 |
| N/A | Cancel | N/A | 3 |

Rules:

| No. | Rules |
|---|---|
| 1 | To manage the creation of TBM vouchers, a TBM Product |
| | Provider and TBM Product needs to be set-up. These |
| | Products are then seen as TBM Products and only TBM |
| | vouchers can be created for these Products. |
| | Default to False. |
| 2 | Show Confirmation message. |
| 3 | Cancel the creation of a Product Provider return to |
| | Product Provider List (see FIG. 66). |

Confirm the New Product Provider This page displays a confirmation message for the creation of the New Product Provider. The page has the same information as the Create Product Provider page, but the information is read only.

Fields:

| Field Name | Caption | Required | Rules |
|---|---|---|---|
| ServiceProvider.Name | Name | N/A | |
| N/A | OK | N/A | 1 |
| N/A | Amend | N/A | 2 |
| N/A | Cancel | N/A | 3 |

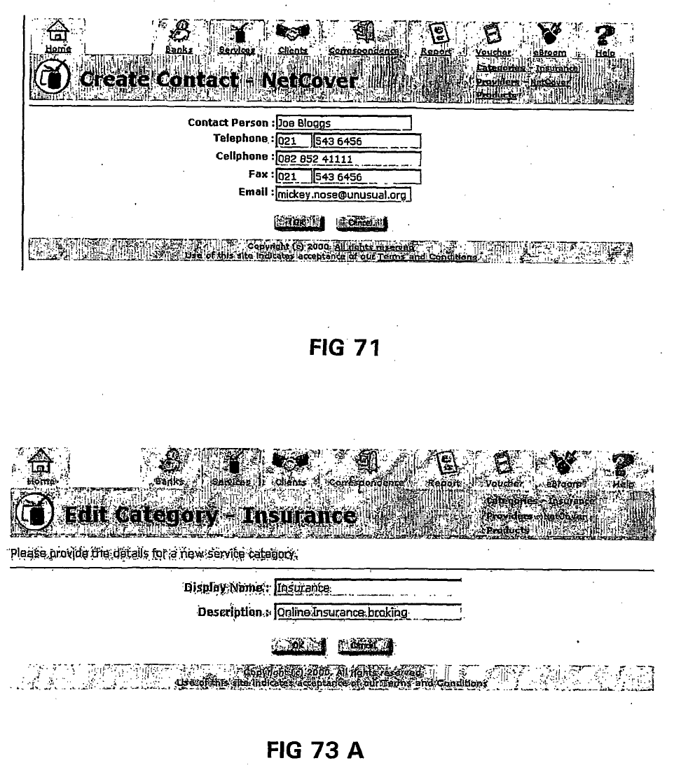

Rules:

| No. | Rules |
|---|---|
| 1 | Save changes. Continue to create at least on Product. |
| | Display Create New Product (see FIG. 71). |
| 2 | Show Edit Product Provider (see FIG. 73A). |
| 3 | Do not save the record. |
| | Return to Product Provider List (see FIG. 66). |

Product List

All Product related operations are accessed via the Products tab (see FIG. 68). Once clicked, the screen refreshes to show the list of active Products. Each Listing screen operates in the same fashion. If the desired operation is a Delete or Edift, the user must first select one of the radio buttons listed to the right of the list. Once selected, the desired operation can be performed. The Create operation can be selected without selecting an existing item. Fields:

Fields:

| Field Name | Caption | Required | Rules |
|---|---|---|---|
| Service.StatusCode | Status | N/A | |
| Service.Name | Name | N/A | |
| ServiceCategory.DisplayName | Category | N/A | |
| Service.StatusInitiationData | Activated | N/A | |
| Count(ClientProfileService) | Client | N/A | 1 |
| N/A | Create | N/A | 2 |
| N/A | Edit | N/A | 3 |
| N/A | Delete | N/A | 4 |

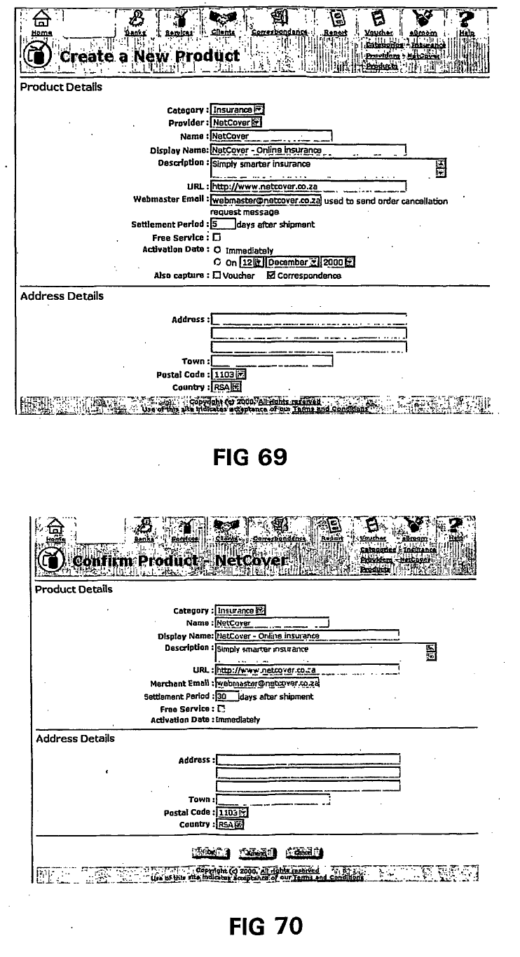

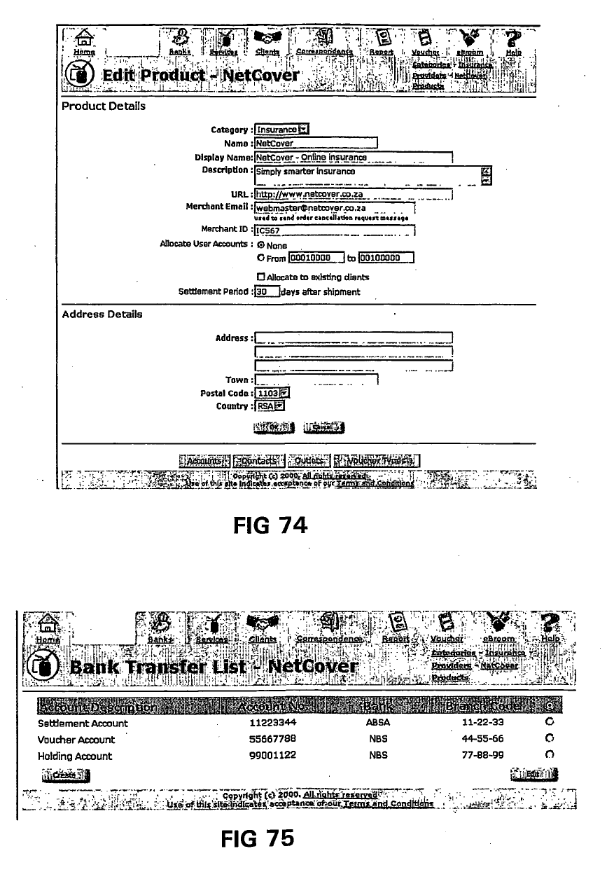

Rules:

| No. | Rules |
|---|---|
| 1 | Count of Client Profiles linked to current Product. |
| 2 | Display Create New Product (see FIG. 69). |
| 3 | User must select an available Product from the select |
| | column. The system will then display Edit a Product |
| | for the Product selected (see FIG. 74). |
| 4 | User must select an available Product from the select column. |
| | If this is the only Product for the Provider, display error |
| | message: At least one Product must exist for the Provider, |
| | else display Confirm: Remove Product fordeleting the |
| | Product selected. |

Create New Product (see FIG. 69)

Fields:

| Field Name | Caption | Required | Rules |
|---|---|---|---|
| Service.ServiceCategoryID | Category | N/A | 1 |
| Service.ServiceProviderID | Provider | N/A | 2 |
| Service.Name | Name | N/A | |
| Service.DisplayName | Display | N/A | |
| | Name | | |
| Service.Description | Description | N/A | |
| Service.URL | URL | N/A | 3 |
| Service.MerchantE-mail | Webmaster | N/A | 4 |
| | E-mail | | |
| Service.MerchantID | Not Shown | N/A | 5 |
| Service.SettlementPeriod | Settlement | N/A | |
| | Period | | |
| N/A | Free | N/A | 6 |
| | Service | | |
| Service.Address1, | Address | N/A | |
| Service.Address2, | | | |
| Service.Address3, | | | |
| Service.Town, | | | |
| Service.PostCode, | | | |
| Country.Name. | | | |
| Service.StatusInitiationDate | Activation | N/A | 7 |
| | Date | | |
| N/a | OK | N/A | 8 |
| N/A | Cancel | N/A | 9 |

Rules:

| No. | Rules |
|---|---|
| 1 | Use the ProductCategory table to populate. If the user |
| | reached this screen from a wizard, default this combo |
| | to the Category created at the beginning of the |
| | wizard, and mark it read-only. |
| 2 | Use the ProductProvider table to populate. If the user |
| | reached this screen from a wizard, default the value |
| | to the Provider created and mark it read-only. |
| 3 | This URL is used to go to the Product's site. Ensure |
| | that it is a valid web address. |
| 4 | The E-mail address is used for the Transaction Co-ordinator |
| | to rollback a transaction. Ensure that it is a valid e-mail |
| | address for someone at the Product who will know how to |
| | perform the operation. |
| 5 | The MerchantID is used by the Transaction Coordinator. |
| | It will default to “IC” + the Product ID when the |
| | record is created. |
| 6 | A free product does not need bank transfer details. |
| | Vouchers cannot be created for a free product. |
| 7 | If this is set to immediately, the record will be marked |
| | ACT (Active) immediately on completion of the wizard, or |
| | clicking on OK. If the user enters a date, the date must be |
| | a valid date in the future. A task will be created for |
| | eBroom to activate the Product on this date. |
| 8 | Save and validate changes. Continue to create at least |
| | one Product Contact. |
| 9 | At least one Product must exist for a Provider: If this |
| | was created from the wizard, display an error message |
| | informing the user. If the user confirms the cancellation, |
| | rollback all records created during the wizard process, |
| | else continue to create at least one Product Contact. |
| | If this is not the first Product for a Provider, cancel |
| | the creation process and return to6 Product List. |
| | (see FIG. 68). |

*Confirm New Product (see FIG. 70) Fields: See Create New Product Fields (see FIG. 69). All fields are be marked read-only.

| Field Name | Caption | Required | Rules |
|---|---|---|---|
| N/A | OK | N/A | 1 |
| N/A | Amend | N/A | 2 |
| N/A | Cancel | N/A | 3 |

Rules:

| No. | Rules |
|---|---|
| 1 | Save changes, move to next Wizard Item depending on |
| | selection in Create New Product (see FIG. 69). |
| 2 | Show Edit a Product (see FIG. 74). |
| 3 | At least one Product must exist for a Provider: If |
| | this was created from the wizard, display an error |
| | message informing the user. If the user confirms |
| | the cancellation, rollback all records created during |
| | the wizard process, else continue to create at least |
| | one Product Contact. |
| | If this is not the first Product for a Provider, cancel |
| | the creation process and return to Product List |
| | (see FIG. 68). |

Create Product Contact The page shown in FIG. 71 is used to create a new contact record for the selected Product.

Fields:

| Field Name | Caption | Required | Rules |
|---|---|---|---|
| ServiceContactPerson.ContactPerson | Contact | Yes | 1 |
| | Person | | |
| ServiceContactPersonDetail.Details | Telephone | Yes/No | 2, 3, 7 |
| ServiceContactPersonDetail.Details | Cell | Yes/No | 2, 4 |
| | Phone | | |
| ServiceContactPersonDetail.Details | Fax | Yes/No | 2, 5, 7 |
| ServiceContactPersonDetail.Details | E-mail | Yes/No | 2, 6, 7 |
| N/A | OK | N/A | 8 |
| N/A | Cancel | N/A | 9 |

Rules:

| No. | Rules |
|---|---|
| 1 | Contact Person. Must be unique. |
| 2 | Either the Telephone or Cell must be completed. |
| | E-mail must be completed. |
| 3 | ServiceContactPersonDetail.PrimaryContractTypeInd = True |
| | ServiceContactPersonDetail.Description = “Business Tel No” |
| | ServiceContactPersonDetail.ContactTypeCode = “WPH” |
| 4 | ServiceContactPersonDetail.PrimaryContractTypeInd = True |
| | ServiceContactPersonDetail.Description = “Cell Number” |
| | ServiceContactPersonDetail.ContactTypeCode = “CPH” |
| 5 | ServiceContactPersonDetail.PrimaryContractTypeInd = True |
| | ServiceContactPersonDetail.Description = “Fax Number” |
| | ServiceContactPersonDetail.ContactTypeCode = “WFX” |
| 6 | ServiceContactPersonDetail.PrimaryContractTypeInd = True |
| | ServiceContactPersonDetail.Description = “E-mail Address” |
| | ServiceContactPersonDetail.ContactTypeCode = “EML” |
| 7 | Save with the area code at the end of the number with a |
| | “\|\|” separating the numbers. “5438762 \|\| 021”. Use the |
| | “\|\|” delimiter to pick up the area code in future. |
| 8 | Validate and Save current details, display Confirm the |
| | Product Contact. |
| 9 | At least one Contact must exist for a Product. If this was |
| | created from the wizard, display an error message informing |
| | the user. If the user confirms the cancellation, rollback |
| | all records created during the wizard process, else continue |
| | to create Bank Transfer Details. |
| | If this is not the first Contact for a Product, cancel the |
| | creation process and return to Product List (see FIG. 68). |

Confirm the Product Contact

This page displays a confirmation message for the creation/edition of the Product Contact. The page has the same information as the Create/Edit Contact page, but the information is read only.

Fields:

| | | Re- | |
|---|---|---|---|
| Field Name | Caption | quired | Rules |
| ServiceContact.ContactTypeCode | Contact | N/A | |
| | Type | | |
| ServiceContact.PrimaryContactTypeInd | Default | N/A | |
| | for | | |
| | this | | |
| | type of | | |
| | contact | | |
| ServiceContact.Description | Descrip- | N/A | |
| | tion | | |
| ServiceContact.Details | Details | N/A | |
| N/A | Capture | N/A | 1 |
| | another | | |
| | contact | | |
| | for | | |
| | NetCover | | |
| N/A | OK | N/A | 2 |
| N/A | Amend | N/A | 3 |
| N/A | Cancel | N/A | 4 |

Rules:

| No. | Rules |
|---|---|
| 1 | Checkbox. Use the Product.Description field to change |
| | the Caption. Default to True. |
| 2 | Save changes. |
| | If this was created from the wizard, continue to create |
| | Bank Transfer Details, else return to either Create New |
| | Product (see FIG. 69) or Edit a Product (see FIG. 74). |
| 3 | Show Create Product Contact (see FIG. 71). |
| 4 | At least one Contact must exist for a Product: If this was |
| | created from the wizard, display an error message |
| | informing the user. If the user confirms the cancellation, |
| | rollback all records created during the wizard process, |
| | else continue to create Bank Transfer Details. |
| | If this is not the first Contact for a Product, cancel |
| | the creation process and return to Product List |
| | (see FIG. 68). |

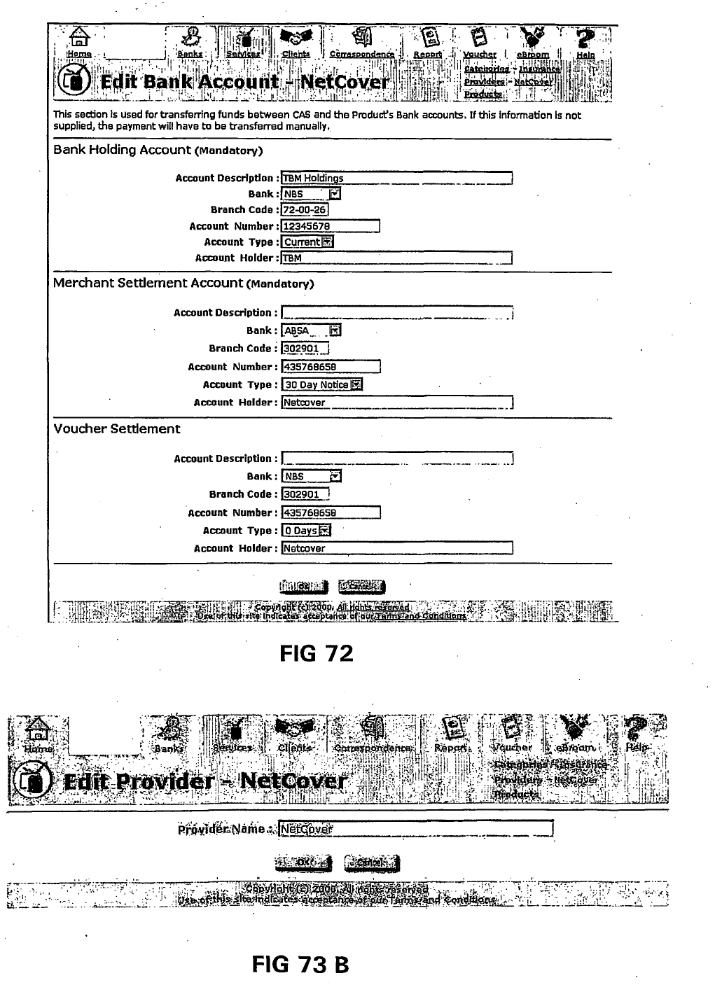

Create/EditProduct Bank (Bank Transfer Information An example of a screen display of this feature is shown in FIG. 72.

Fields:

| | | Re- | |
|---|---|---|---|
| Field Name | Caption | quired | Rules |
| ServiceBankAccount.Description | Account | Yes | 1, |
| | Descrip- | | 5 |
| | tion | | |
| ServiceBankAccount.BankID | Bank | Yes | 1, |
| | | | 4, |
| | | | 5 |
| ServiceBankAccount.BranchCode | Branch | Yes | 1, |
| | Code | | 5 |
| ServiceBankAccount.AccountNumber | Account | Yes | 1, |
| | Number | | 5 |
| ServiceBankAccount.AccountTypeID | Account | Yes | 1, |
| | Type | | 2, |
| | | | 5 |
| ServiceBankAccount.AccountHolder | Account | Yes | 1, |
| | Holder | | 5 |
| ServiceBankAccount.BankTypeCde | <not | N/A | 1, |
| | shown> | | 3, |
| | | | 5 |
| N/A | OK | N/A | 6 |
| N/A | Cancel | N/A | 7 |

Rules:

| No. | Rules |
|---|---|
| 1 | At least the “Bank Holding” and “Merchant Settlement” |
| | accounts must be completed. See Rule 3 for BankTypeCode. |
| | The Voucher option is not necessary in this embodiment. |
| | It is included in other embodiments |
| 2 | Use ctlAccountType table to populate. |
| 3 | Use ctlBankType table to generate screen. HLD (Holding) |
| | and STL (Settlement) accounts must be completed. |
| 4 | Use ctlBank to populate the list for Bank Holding |
| | Account and Voucher Settlement Account. |
| | Use ctlSABank to populate the list for Merchant |
| | Settlement Account. |
| | Note: This information will be set up for TBM. |
| 5 | Defaulted from ctlSystem for Bank Holding Account |
| | and Voucher Settlement Account. |
| 6 | Validate and save details. Confirm the information. |
| | See Confirm the Bank Transfer Information. |
| 7 | If there are no valid Bank accounts for the product, |
| | display error that the bank accounts must be created |
| | for a product. If the user continues with the cancel, |
| | the product will be deleted along with any records |
| | that were created during the process. |
| | If there are valid Bank accounts for the product, |
| | cancel the process. |

*Confirm the Bank Transfer Information This page display a confirmation message for the creation/editing of the Bank Transfer Information. The page has the same information as the Create/Edit page, but the information is read only.

Fields:

| Field Name | Caption | Required | Rules |
|---|---|---|---|
| See Create/Edit | N/a | N/A | |
| Product Bank | | | |
| (Bank Transfer | | | |
| Information) | | | |
| N/A | OK | N/A | 1 |
| N/A | Amend | N/A | 2 |
| N/A | Cancel | N/A | 3 |

Rules:

| No. | Rules |
|---|---|
| 1 | Save changes. |
| | Return to either Create New Product (see FIG. 69) |
| | or Edit a Product (see FIG. 74). |
| 2 | Show Create/Edit Product Bank (Bank Transfer |
| | Information) (see FIG. 72). |
| 3 | Do not save the record. |
| | Return to either Create New Product (see FIG. 69) |
| | or Edit a Product (see FIG. 74). |

*Edit a Category The same rules apply as in Create a New Product Category (see FIG. 73A).

Confirm Edit Product Category

The same rules apply as in Confirm the New Product Category.

Edit Product Provider

The same rules apply as in Create a New Product Provider (see FIG. 73B).

Confirm Edit Product Provider

The same rules apply as in Confirm the New Product Provider.

Edit a Product (see FIG. 74)

Fields:

See Create New Product (see FIG. 69) for Fields and Rules for Product Details and Address.

| Fields | Caption | Required | Rules |
|---|---|---|---|
| N/A | Allocate user | N/A | 1 |
| | Accounts | | |
| N/A | Allocate to | N/A | 2 |
| | existing | | |
| | clients | | |
| N/A | OK | N/A | 3 |
| N/A | Cancel | N/A | 4 |
| N/A | Accounts | N/A | 5 |
| N/A | Contacts | N/A | 6 |
| N/A | Outlets | N/A | 7 |
| N/A | Voucher | N/A | 8 |
| | Types | | |

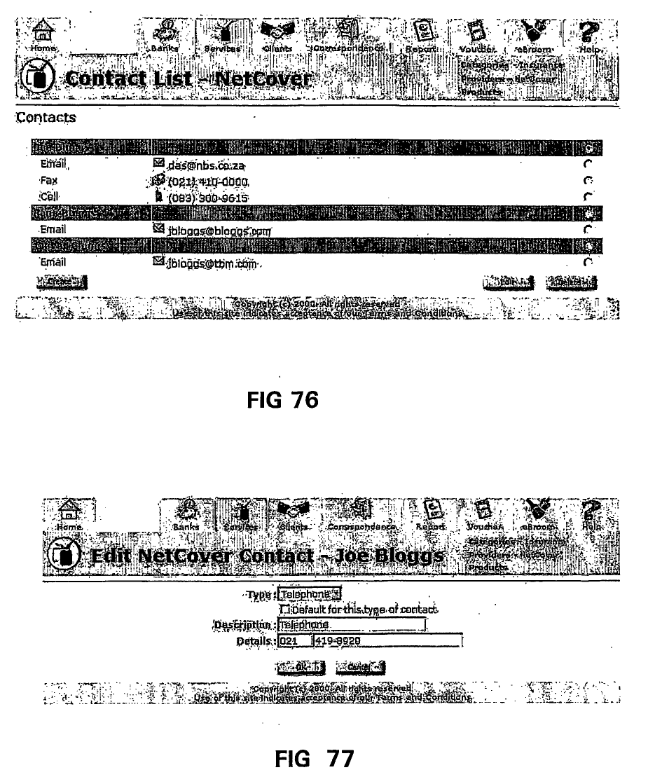

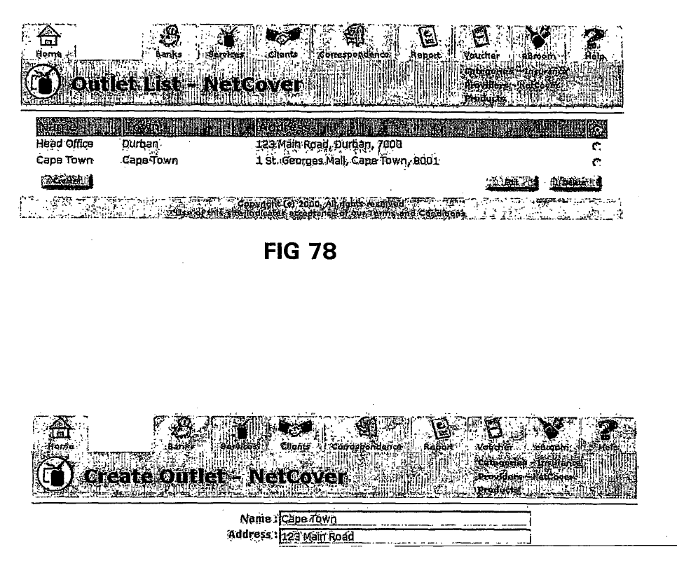

Rules:

| No. | Rules |
|---|---|
| 1 | An account range is entered if the product would like |
| | the TBM system 10 to allocate account numbers automatically. |
| | The CAS will then sent the client information to the |
| | product, as per the Service Interaction Specification. |
| | If None is selected, the 2 account number fields, and the |
| | Allocate to existing checkbox is disabled. If the user |
| | selects the From option, enabled the account numbers and |
| | the checkbox. |
| 2 | The TBM system 10 can allocate account numbers to all |
| | ClientProfile records. This function can be called at any |
| | point in time. A task will be scheduled in eBroom to |
| | allocate these accounts. |
| | A check is done on the account number range: The number |
| | of available account numbers must be more than the number |
| | of ClientProfile records plus a specified buffer. This |
| | buffer is stored in the system variables table. |
| 3 | Display confirmation page. |
| 4 | Cancel the creation edition of the Product. See Product |
| | List (FIG. 68). |
| 5 | Display Bank Account_1st (see FIG. 75). |
| 6 | Display Contact List (see FIG. 76). |
| 7 | Display List Outlets (see FIG. 78). |
| 8 | Display Product Voucher Types (see FIG. 80). |

Confirm Edit Product Provider

The same rules apply as in Confirm New Product (see FIG. 70).

Bank Account List

An example of a screen layout of this feature Is shown in FIG. 75.

Fields:

| Field Name | Caption | Required | Rules |
|---|---|---|---|
| ServiceBank.Description | Description | N/a | 1 |
| ServiceBank.AccountNumber | Account No. | N/a | 1 |
| ServiceBank.Bank | Bank | N/a | 1 |
| ServiceBank.BranchCode | Branch | N/a | 1 |
| | Code | | |
| N/a | Create | N/a | 2 |
| N/a | Edit | N/a | 2 |

Rules:

| No. | Rules |
|---|---|
| 1 | Display details for all records in ServiceBank where |
| | ServiceID = Current Service |
| 2 | Display Create/Edit Product Bank (Bank Transfer Information) |
| | (see FIG. 72) |

Create/Edit Contact (see FIG. 76)

Fields:

| Field Name | Caption | Required | Rules |
|---|---|---|---|
| ServiceContact.Name/ | Name | N/a | 1 |
| ServiceContactDetail.Description | | | |
| ServiceContactDetail.Detail | Details | N/a | 1 |
| N/a | Create | N/a | 2 |
| N/a | Edit | N/a | 3 |
| N/a | Delete | N/a | 4 |

Rules:

| No. | Rules |
|---|---|
| 1 | Display details for all records in ServiceContact where |
| | ServiceID = Current Service. |
| 2 | Display Create Product Contact (see FIG. 71). |
| 3 | Display Create/Edit Contact (see FIG. 77). |
| 4 | If this is the only Contact for the Product display error |
| | message: At least one Contact must exist for the Product, |
| | else display Confirm: Remove Product Contact. |

Create/Edit Contact (see FIG. 77)

Fields:

Fields:

| | | Re- | |
|---|---|---|---|
| Field Name | Caption | quired | Rules |
| ServiceContactPerson.Name | Contact | No | 1 |
| | Person | | |
| ServiceContactPersonDetail.ContactType | Type | Yes | 2 |
| ServiceContactPersonDetail.Description | Descrip- | Yes | |
| | tion | | |
| ServiceContactPersonDetail.Details | Details | Yes | 3 |
| N/A | OK | N/A | 4 |
| N/A | Cancel | N/A | 5 |

Rules:

| No. | Rules |
|---|---|
| 1 | Use for Descriptive Page title. |
| 2 | Populate drop down from ContactType table. |
| 3 | Read the area code at the end of the number with, numbers |
| | separated by a “\|\|” “5438762 \|\| 021”. Use the “\|\|” delimiter |
| | to pick up the area code in future. |
| | For E-mail and Cell details, show only one text box. Use the |
| | relevant validation for the type of contact selected. |
| 4 | Display confirmation screen. |
| 5 | Cancel changes and return to Contact List (see FIG. 76). |

Confirm: Remove Product Contact This page displays a confirmation message for the deletion of the Product Contact. The page has the same information as the Create Product Contact page, but the information is read only.

Fields:

| Field Name | Caption | Required | Rules |
|---|---|---|---|
| N/A | OK | N/A | 1 |
| N/A | Cancel | N/A | 2 |

Rules:

| No. | Rules |
|---|---|
| 1 | Delete the Product Contact. |
| | Return to Create New Product (see FIG. 69) or |
| | Edit a Product (see FIG. 74). |
| 2 | Do not delete the record. |
| | Return to Create New Product (see FIG. 69) or |
| | Edit a Product (see FIG. 74). |

List Outlets (see FIG. 78)

Fields:

| Field Name | Caption | Required | Rules |
|---|---|---|---|
| ServiceOutlet.Name | Name | N/a | 1 |
| ServiceOutlet.Town | Town | N/a | 1 |
| ServiceOutlet.(Address1 + | Address | N/a | 1 |
| Address2 + Address3 + Town + | | | |
| PostCode) | | | |
| N/a | Create | N/a | 2 |
| N/a | Edit | N/a | 3 |
| N/a | Delete | N/a | 4 |

Rules:

| No. | Rules |
|---|---|
| 1 | Display details for all records in ServiceOutlet |
| | where SericeID = Current Service. |
| 2 | Display Create/Edit Outlet (see FIG. 79). |
| 3 | Display Create/Edit Outlet (see FIG. 79). |
| 4 | Display Confirm: Remove Product Outlet. |

Create/Edit Outlet (see FIG. 79)

Fields:

| Field Name | Caption | Required | Rules |
|---|---|---|---|
| ServiceOutlet.Name | Name | Yes | 1 |
| ServiceOutlet.Address1 | Address | Yes | 2 |
| ServiceOutlet.Address2 | | No | 2 |
| ServiceOutlet.Address3 | | No | 2 |
| ServiceOutlet.Town | Town | Yes | 3 |
| ServiceOutlet.PostCode | Post | Yes | 4 |
| | Code | | |
| ServiceOutlet.Country | Country | Yes | 5 |
| N/A | OK | N/A | 6 |
| N/A | Cancel | N/A | 7 |

Rules:

| No. | Rules |
|---|---|
| 1 | Name of the Outlet, must be unique. |
| 2 | Must be the physical address. |
| 3 | Town must be valid, used for grouping purposed. |
| 4 | Use PostCode table to populate combo list. |
| 5 | Use Country table to populate combo list. Will |
| | default to “RSA”. |
| 6 | Display Confirm screen. |
| 7 | If first Outlet for a Product, Display error |
| | message that at least one Outlet must exist for |
| | a product. |
| | Discard changes. |

Confirm: Remove Product Outlet This page displays a confirmation message for the deletion of the Product Outlet. The page has the same information as the Create Product Outlet page, but the information is read only. The Product Outlet cannot be deleted if there are any related records in Product. All these Product records need to be amended before the Product Outlet can be deleted

Fields:

| Field Name | Caption | Required | Rules |
|---|---|---|---|
| N/A | OK | N/A | 1 |
| N/A | Cancel | N/A | 2 |

Rules:

| No. | Rules |
|---|---|
| 1 | Delete the Product Outlet. |
| | Return to Edit a Product (see FIG. 74). |
| 2 | Do not delete the record. |
| | Return to Edit a Product (see FIG. 74). |

Product Voucher Types (see FIG. 80) When a new Product is created, a record is inserted into casServiceVoucherList for all the available voucher types: When the user access this page for the first time, all the voucher types are selected.

Fields:

| Field Name | Caption | Required | Rules |
|---|---|---|---|
| ctlVoucherType.Description | Voucher | N/a | 1 |
| | Type | | |
| N/a | (Checkbox) | N/a | 23 |
| N/a | Delete | N/a | 4 |

Rules:

| No. | Rules |
|---|---|
| 1 | Available Voucher types in ctlVoucherType is displayed. |
| 2 | This is defaulted to be checked when a record exists in |
| | casServiceVoucherList for this Product and Voucher Type. |
| 3 | A record is saved in casServiceVoucherList for this |
| | Product and Voucher Type if this is checked. |
| 4 | Display Confirm: Product Voucher Types. |

Confirm: Product Voucher Types This page displays a confirmation message for the Product Voucher Types.

The page has the same information as the Select Product Voucher Types page, but the information is read only.

Fields:

| Field Name | Caption | Required | Rules |
|---|---|---|---|
| N/A | OK | N/A | 1 |
| N/A | Cancel | N/A | 2 |

Rules:

| No. | Rules |
|---|---|
| 1 | Save casServiceVoucherList for the Product and |
| | selected Voucher Types. |
| | Return to Edit a Product (see FIG. 74). |
| 2 | Return to Product Voucher Types (see FIG. 80). |

Confirm: Remove Product Category This page displays a confirmation message for the deletion of the Product Category. The page has the same information as the Create Product Category page, but the information is read only. The Product Category cannot be deleted if there are any related records in Product. All these Product records need to be amended before the Product Category can be deleted.

Fields:

| Field Name | Caption | Required | Rules |
|---|---|---|---|
| N/A | OK | N/A | 1 |
| N/A | Cancel | N/A | 2 |

Rules:

| No. | Rules |
|---|---|
| 1 | Delete the Product Category. |
| | Return to Product Category List (see FIG. 64). |
| 2 | Do not delete the record. |
| | Return to Product Category List (see FIG. 64). |

Confirm: Remove Product Provider This page displays a confirmation message for the deletion of the Product Provider. The page has the same information as the Create Product Provider page, but the information is read only. The Product Provider cannot be deleted if there are any related records in Product. All these Product records need to be amended before the Product Provider can be deleted.

Fields:

| Field Name | Caption | Required | Rules |
|---|---|---|---|
| N/A | OK | N/A | 1 |
| N/A | Cancel | N/A | 2 |

Rules:

| No. | Rules |
|---|---|
| 1 | Delete the Product Provider. |
| | Return to Product Provider List (see FIG. 66). |
| 2 | Do not delete the record. |
| | Return to Product Provider List (see FIG. 66). |

Confirm: Remove Product This page displays a confirmation message for the deletion of the Product.

The Product cannot be deleted if there are any related records in ClientProfileService, ProductBankAccount and Voucher. All these records need to be amended before the Product can be deleted.

Fields:

| N/A | OK | N/A | 1 |
|---|---|---|---|
| N/A | Cancel | N/A | 2 |
| No. | Rules | | |

Rules:

| | |
|---|---|
| 1 | Delete the Product. |
| | Return to Product List (see FIG. 68). |
| 2 | Do not delete the record. |
| | Return to Product List (see FIG. 68). |

See Confirm New Product for Field List (see FIG. 70).

Reference numeral 450 generally indicates the CAS administration process for client maintenance. Clients may be deleted as shown at block 452 and associated blocks 454, clients may be reinstated as shown at block 456 and associated blocks 458, and profiles may be locked or unlocked as generally indicated by blocks 460 and 462 respectively.

Client Search

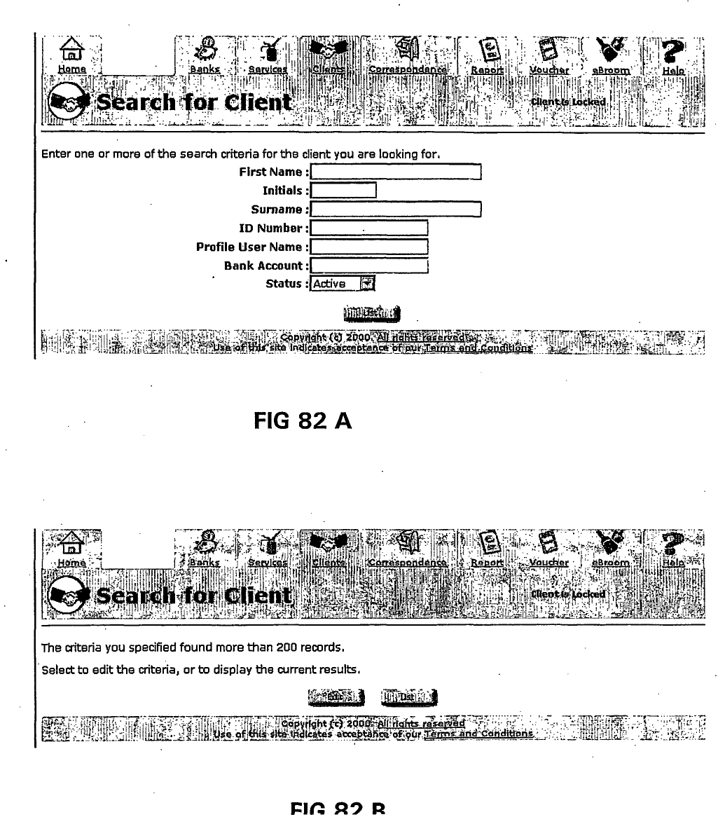

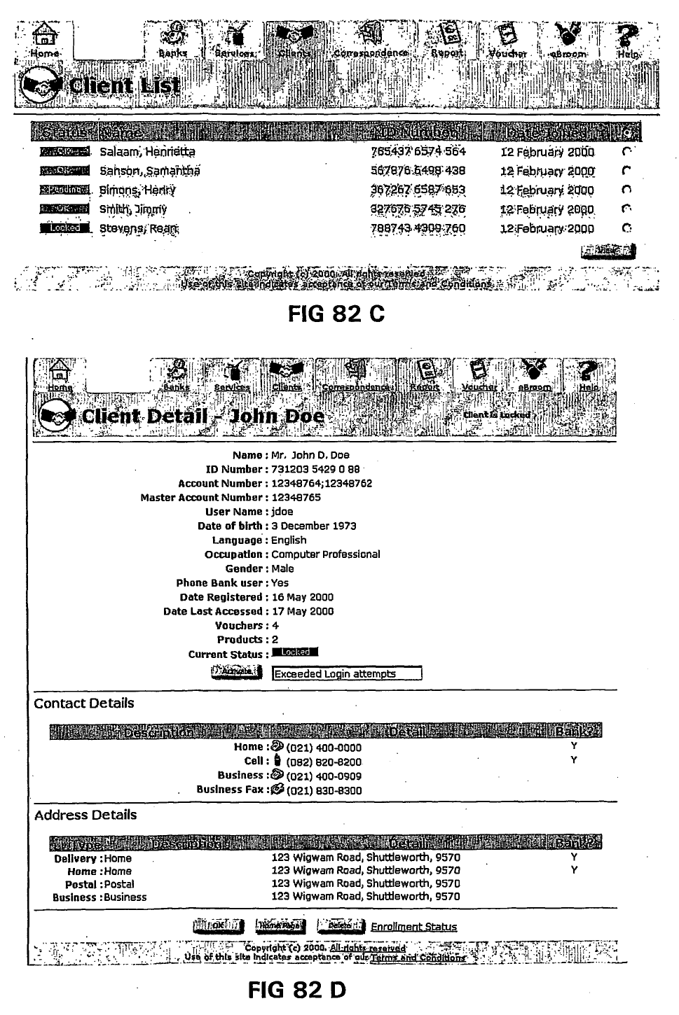

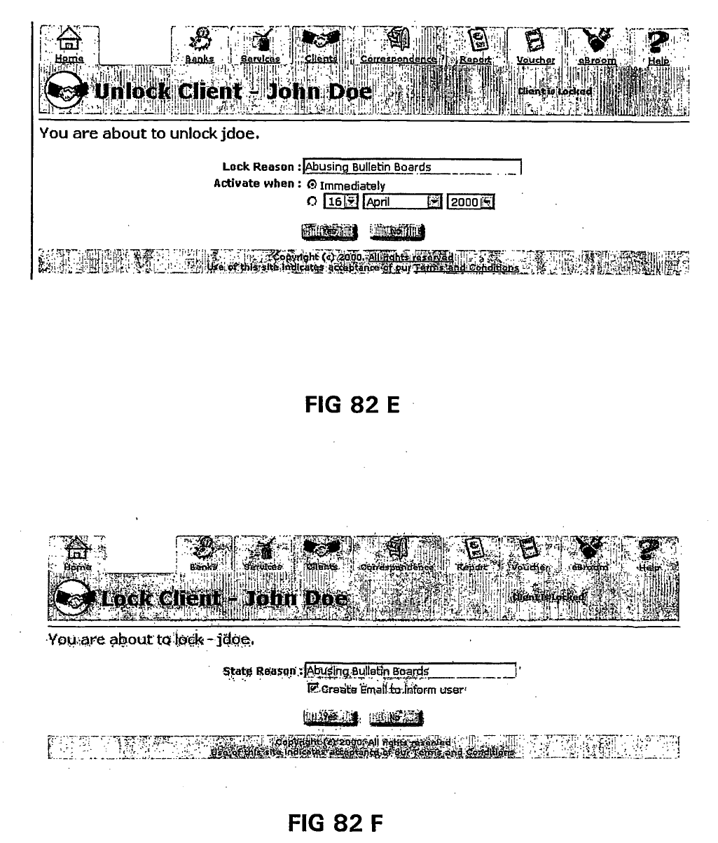

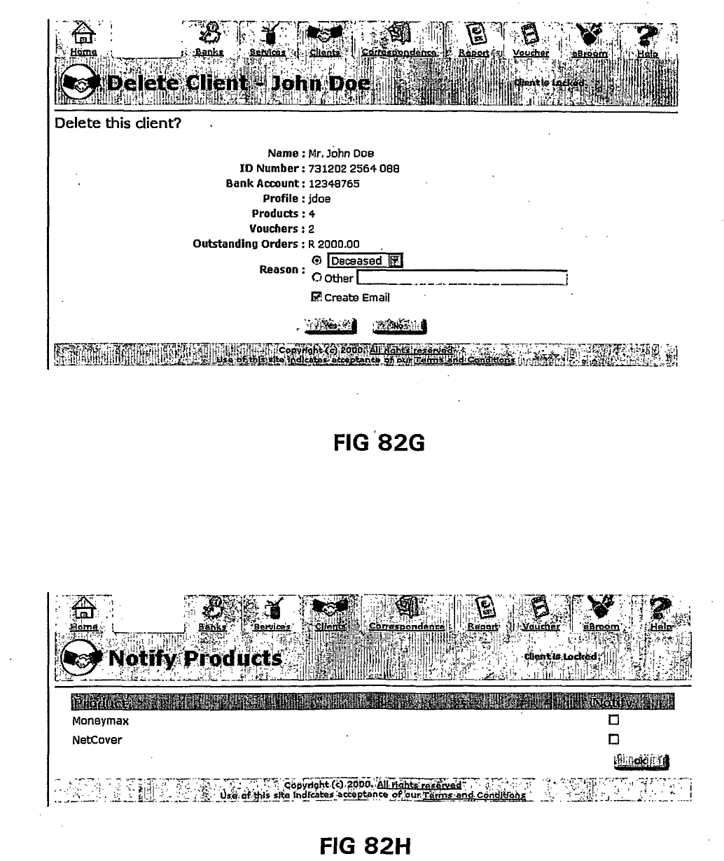

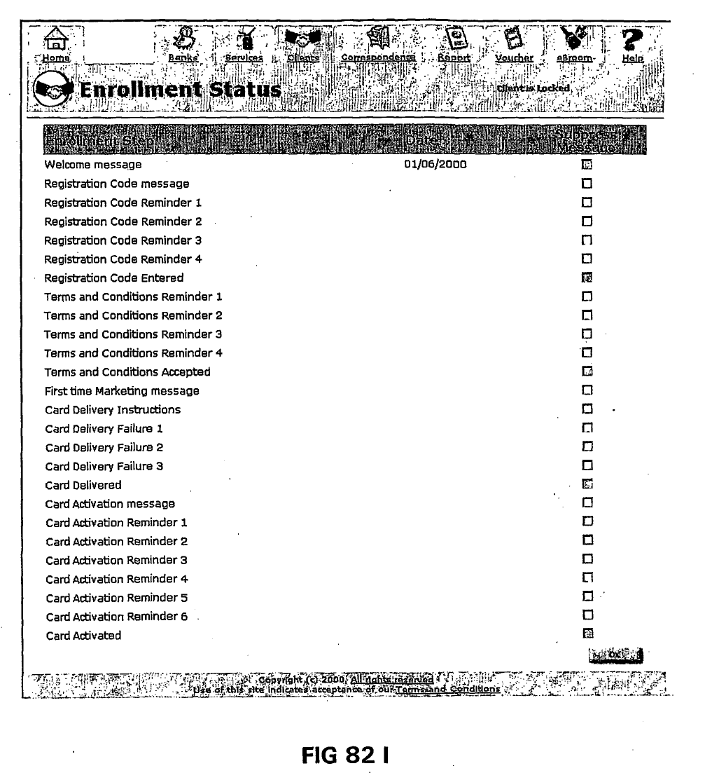

Due to the large number of records that will exist in the client database, clicking on the Clients tab will not show a list in the embodiment d epicted in the drawings. Instead, the administrator is shown a selection screen, which allows the administrator to shorten the list by entering some details for the client he or she seeks (see FIG. 82A).

Fields:

| Field Name | Caption | Required | Rules |
|---|---|---|---|
| N/A | First Name | N/A | 1 |
| N/A | Initials | N/A | 1 |
| N/A | Surname | N/A | 1 |
| N/A | ID Number | N/A | 1 |
| N/A | User Name | N/A | 1 |
| N/A | Bank Account | N/A | 1 |
| N/A | Status | N/A | 1, 2 |
| N/A | List | N/A | 3 |

Rules:

| No. | Rules |
|---|---|
| 1 | The Administrator must enter something into at least of one |
| | the search fields. Generate a query based on this information. |
| | The system 10 automatically appends wildcard characters to |
| | the fields so that partial matches will be found. Sort records |
| | by Client.Surname, Client.FirstName. |
| 2 | The search is limited to display records only in the Status |
| | Selected. CtlStatus is used to populate this drop-down. |
| 3 | Execute the built query. |
| | If no records are found, a note is added to the screen |
| | informing the user that no records match. |
| | If the Search criteria supplied finds more than 200 records, |
| | display Client Search Confirm (see FIG. 82B), otherwise |
| | display Client List (see FIG. 82C). |

Client Search Confirm If the Search criteria supplied finds more than 200 records, the user may select to edit the criteria, or to display the current results (see FIG. 82B).

Fields:

| Field Name | Caption | Required | Rules |
|---|---|---|---|
| N/A | Edit | N/A | 1 |
| N/A | List | N/A | 2 |

Rules:

| No. | Rules |
|---|---|
| 1 | Display Client Search (see FIG. 82A). |
| 2 | Execute the built query. If no records are found, add a |
| | note to the screen informing the user that no records |
| | match, otherwise display Client List (see FIG. 82C). |

Client List (see FIG. 82C)

Fields:

| | | Re- | |
|---|---|---|---|
| Field Name | Caption | quired | Rules |
| ClientProfile.StatusCode | Status | N/A | 1 |
| Client.Surname + Client.FirstName | Name | N/A | |
| Client.IDNumber | ID | N/A | |
| | Number | | |
| ClientProfile.RegistrationCodeEnteredOn | Date | N/A | 2 |
| | Joined | | |
| N/A | View | N/A | 3 |

Rules:

| No. | Rules |
|---|---|
| 1 | Retrieve all ClientProfiles for the ClientId, if any are |
| | locked then show the Status as Locked. |
| 2 | Select First(ClientProfile.RegistrationEnteredOn) for ClientID. |
| 3 | Display Client Profile (see FIG. 82D). |

Client Profile The client profile screen allows the administrator to view all the TBM services the client has selected to use, as well as their personal details. All of this information is read-only, the only change the administrator is allowed to make is to lock, unlock, delete and re-instate users (see FIG. 82D).

| | | | |
|---|---|---|---|
| Field Name | Caption | Required | Rules |

Fields:

| | | | |
|---|---|---|---|
| Client.Title + | Name | N/A | |
| Client.FirstName + | | | |
| Client.Initials + | | | |
| Client.Surname | | | |
| Client.IDNumber | ID Number | N/A | |
| ClientProfileAccount. | Account | N/A | |
| AccountNumber | Number | | |
| ClientBank. | Master | N/A | |
| ProfileNumber | Account | | |
| | Number | | |
| ClientProfile. | User Name | N/A | |
| UserName | | | |
| ClientProfile. | Language | N/A | |
| LanguageID | | | |
| ClientOccupation | Occupation | N/A | |
| Client.Gender | Gender | N/A | |
| | Phone Bank | N/A | |
| | User | | |
| ClientProfile. | Date | N/A | |
| RegistrationCodeEnteredOn | Registered | | |
| ClientProfile. | Date Last | N/A | |
| LastLoggedOn | Accessed | | |
| Count(VoucherLine. | Vouchers | N/A | 1 |
| ClientID) | | | |
| Count | Products | N/A | 2 |
| (ClientProfileAccount. | | | |
| UserName) + | | | |
| Count | | | |
| (ClientProfileService. | | | |
| UserName) | | | |
| ClientProfile. | Status | N/A | 3, 6 |
| StatusCde | | | |
| N/A | Lock / | N/A | 6 |
| | Activate | | |
| N/A | OK | N/A | 7 |
| N/A | Home Page | N/A | 8 |
| N/A | Delete / | N/A | 9 |
| | Re-Instate | | |
| N/A | Enrollment | N/A | 10 |
| | Status | | |

Contact Details:

| | | | |
|---|---|---|---|
| ClientContact. | Description | N/A | 4 |
| Description | | | |
| ClientContact. | Detail | N/A | 4 |
| Detail | | | |
| ClientContact. | Bank? | N/A | 4 |
| UpdateBankInd | | | |

Address Details:

| | | | |
|---|---|---|---|
| ClientAddress. | Description | N/A | 5 |
| Description | | | |
| ClientAddress. | Type | N/A | 5 |
| AdressTypeCode | | | |
| ClientAddress. | Detail | N/A | 5 |
| (Address1 + | | | |
| Address.2 + | | | |
| Address3 + Town + | | | |
| PostCode + | | | |
| Country) | | | |
| ClientAddress. | Bank? | N/A | 5 |
| UpdateBankInd | | | |

| | |
|---|---|
| No | Description |

Rules:

| | |
|---|---|
| 1 | Count Vouchers for the Current ClientID. |
| 2 | Count Services for current ClientID. |
| 4 | Display details for each ClientContact record |
| | for current ClientID. |
| 5 | Display details for each ClientAddress record |
| | for current ClientID. |
| 6 | If StatusCde is LCK (Locked); Show Activate button. |
| | Display Client Status - Unlock (see FIG. 82E). |
| | If StatusCde is ACT (Active), Show Lock button. |
| | Display Client Status - Lock (see FIG. 82F). |
| | If StatusCde is PND (Pending), User is undergoing |
| | registration and Administrator cannot change the |
| | status. |
| 7 | Display Client List (see FIG. 82C). |
| 8 | Retrieve the User's Home Page based on the ClientID. |
| | This page is strictly read-only. |
| 9 | If StatusCde is PND; do not display either button. |
| | If StatusCde is ACT; display the Delete button. If |
| | Clicked, display Client - Remove (see FIG. 82G). |
| | If StatusCde is DEL, display the Reinstate Button. |
| | If Clicked, display a System Generated confirmation |
| | page to confirm that the Administrator wishes to |
| | reinstate the user. Display Notify Products |
| | (see FIG. 82H). |
| 10 | Display Enrollment Status (see FIG. 82I). |

Clent Status—Unlock (see FIG. 82E)

| | | | |
|---|---|---|---|
| Field Name | Caption | Required | Rules |

Fields:

| | | | |
|---|---|---|---|
| N/A | <System Message> | N/A | 1 |
| CasClientProfile. | Lock Reason | N/A | |
| StatusChangeReason | | | |
| N/A | Activate when | N/A | 2 |
| N/A | Yes | N/A | 345 |
| N/A | No | N/A | 4 |

| | |
|---|---|
| No | Description |

Rules:

| | |
|---|---|
| 1 | Use ClientProfile.StatusCde and ClientProfile. |
| | StatusChangeReason to create an |
| | informative title and message. |
| 2 | If this is set to immediately, set the StatusCde |
| | to Active immediately on Yes. |
| | Clear the ClientProfile.StatusChangeReason to null. |
| | If the activation date is set, instert a task for |
| | eBroom to activate the client on this |
| | date. The StatusCde will not change until eBroom |
| | reaches that date. |
| 3 | Perform the operations defined in 2. |
| 4 | Return to Client Profile (see FIG. 82D). |
| 5 | Add an eBroom task to Sent a ClientUnlocked E-mail |
| | message to user. |

Client Status Lock (see FIG. 82F)

| | | | |
|---|---|---|---|
| Field Name | Caption | Required | Rules |

Fields:

| | | | |
|---|---|---|---|
| N/A | <System Message> | N/A | 1 |
| ClientProfile. | State Reason | Yes | |
| StatusChangeReason | | | |
| N/A | Create E-mail | N/A | |
| N/A | Yes | N/A | 23 |
| N/A | No | N/A | 3 |

| | |
|---|---|
| No | Description |

Rules:

| | |
|---|---|
| 1 | Use ClientProfile.StatusCde and ClientProfile. |
| | StatusChangeReason to create an |
| | Informative title and message. |
| 2 | Update the ClientProfile.StatusCde & ClientProfile. |
| | StatusChangeReason fields. Show Correspondence Manger |
| | to explain reason for Lock. |
| 3 | Return to Client Profile (see FIG. 82D). |

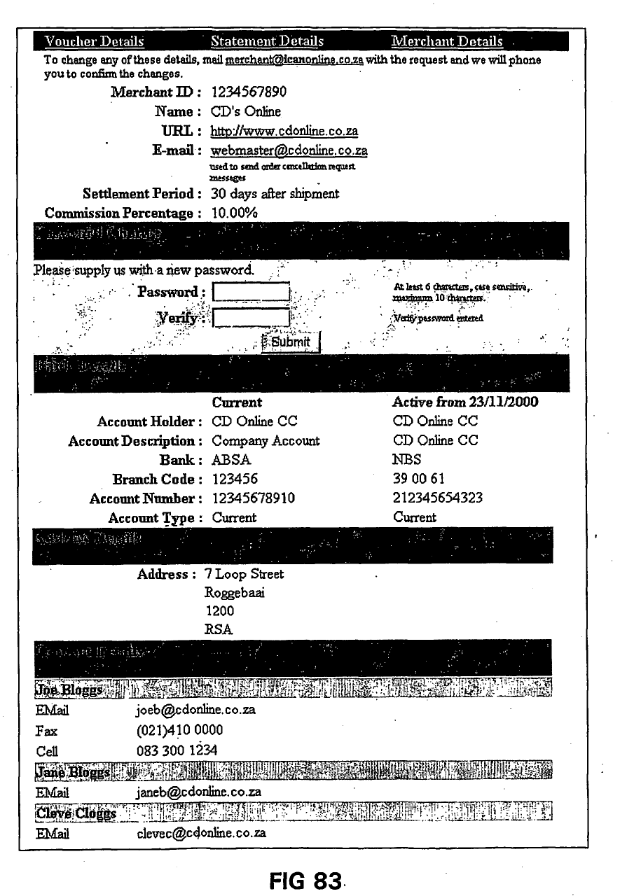

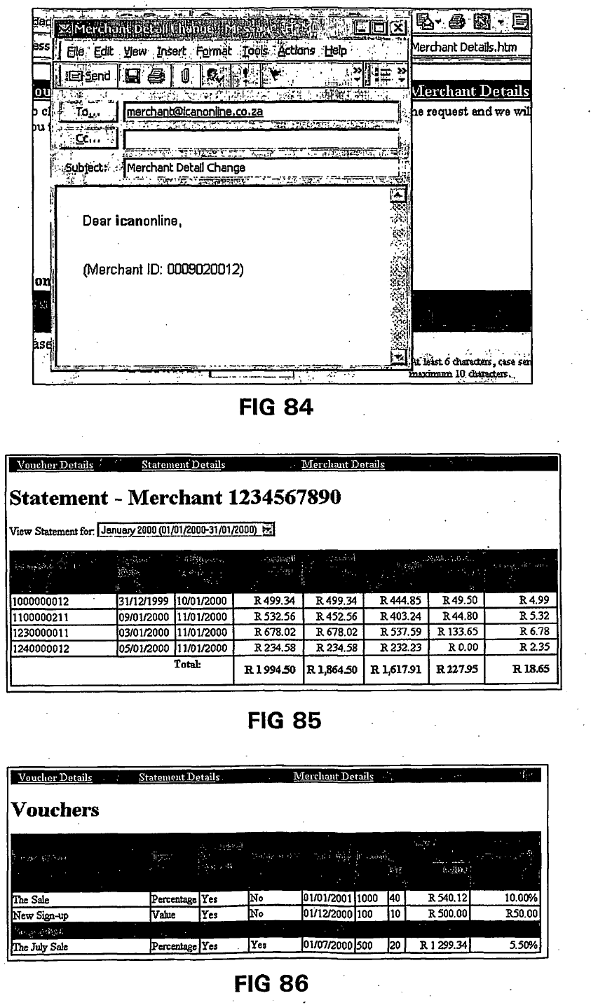

FIGS. 83 to 86 show typical screen layouts available to merchants forming part of the system 10 thereby to enable the merchants to view a summary of associated transactions online. Typically, the system 10 runs a weekly batch at the end of each week to update statement tables so that transactions are shown on a weekly basis. Month end summaries are also provided. The system 10 also allows a merchant to change selected details (see FIG. 84) by e-mailing or phoning the system administrator. Navigation of the web site of the system 10 to each associated web site, namely the Internet banking server 16, the online shopping facility 22, and the web site 24 is handled with an Off Site Viewer (OSV) which is a frame containing the entire site and linked back to the system site. The system 10 provides facilities for new service providers, service account creations, client detail amendments, or the like.

PROCESSES Examples of various processes of the Client Administration System are set out below.

TBM navigation

Navigation out of the TBM site, for example to Moneymax, is handled within an Off Site Viewer OSV. This is a frame containing the entire Moneymax site and a link back to the TBM site.

TBM initiated procedures

Procedures initiated by TBM for Client Account Administration expose a standard interface allowing other Services to easily plug into the process. TBM is only responsible for initiating these remote procedures and action their response.

New Service Provider

If a service provider is added that requires client data that TBM does not hold:

TBM client data will be amended to include these fields.

The user will receive an Airmail message when he logs on with a link to a popup window that will capture all the additional information required.

New users to TBM will have had to enter these details at their point of registration.

Service Accounts Creation

When the TBM account has been authenticated, known service provider accounts will be created. The users will be prompted to indicate whether they are existing users at the service provider and provide their login and password for each service provider.

Existing User at service provider:

Login and password will be validated, and the TBM database will store the service provider login for the Client.

New user at service provider:

A new account is created at the service provider. The username defaults to the TBM username. Conflicts are resolved by appending an incremented number to the username. If the username reaches it's maximum length, the last character will be truncated before appending the number. The service provider may indicate that they wish the TBM system to determine the user account number. In which case, the account number allocation method will have to be specified. For example, users may be allocated account numbers from 1 to 10 000, consecutively. The TBM system exposes user fields and the functionality that creates the account at the service provider formulates the account number and passes it to and from the TBM system and the Service provider. The procedures at the service provider which create accounts will return a unique identifier for the specific client. TBM will use this identifier to resolve the client at the Service Provider. The procedure at the service provider that creates accounts will be responsible for defaulting values for fields:

Password, PasswordHint This procedure also translates the following fields to their lookup values (if available): Language Country Province AddressSuburb Title Procedures that do not execute successfully generate an email to recipients (specified in the system parameters) which highlights the process that failed and generate the relevant error message. The system parameters page (see Ebroom spec) contains a field for email addresses for the Service Provider Interaction Administrators.

Client D tail am ndments

These include changes to user information. TBM first requests authorisation from NBS for amendment. This is an immediate process that calls the NBS Internet Banking popup window. If authorised, these details will be submitted to the Service Providers via the interface. These amendments will only be passed “down” to the Service Providers. TBM will not accept changes from the Service Providers. The procedures at the Service Providers have their specific rules, determining whether newer details should be overwritten.

Functionality that Services provide

TBM Login—the login page allows TBM user logins. Account Creation Process—A process that adds a new user, and authenticates existing user accounts. These processes are initiated by TBM after new users are authenticated. Calls to TBM to retrieve client's Banking Details. Calls to TBM to query client's availability of funds, and perform payment transactions. MMX skips first time registration code validation. MMX automatically deselects all daily e-mails. Netcover provides interface to quote functions.

Service Provider Login

Login screen to either TBM or Moneymax. Users of Moneymax who are not TBM members may only log in to Moneymax. When TBM users log on to TBM, their service provider login is passed to the Service Provider if the TBM account validates successfully.

| Field | Type | Label | Rules |
|---|---|---|---|
| Username | Text | Username: | TBM username rules, see TBM |
| Password | Password | Password: | TBM user password rules, see |
| TBMLogin | Button | Login | 1 |
| Username | Text | Username: | MMX username. See Maxtrader |
| Password | Password | Password: | MMX password. See Maxtrader |
| MMXLogin | Button | Login | 2 |

1. This process calls the TBM logon process which will either

validate the user successfully and return his username for the Service Provider to login the user.

Return a login error.

2. Authenticate user. The Service Provider logon functionality.

MaxBroker Trading

Broker Selection

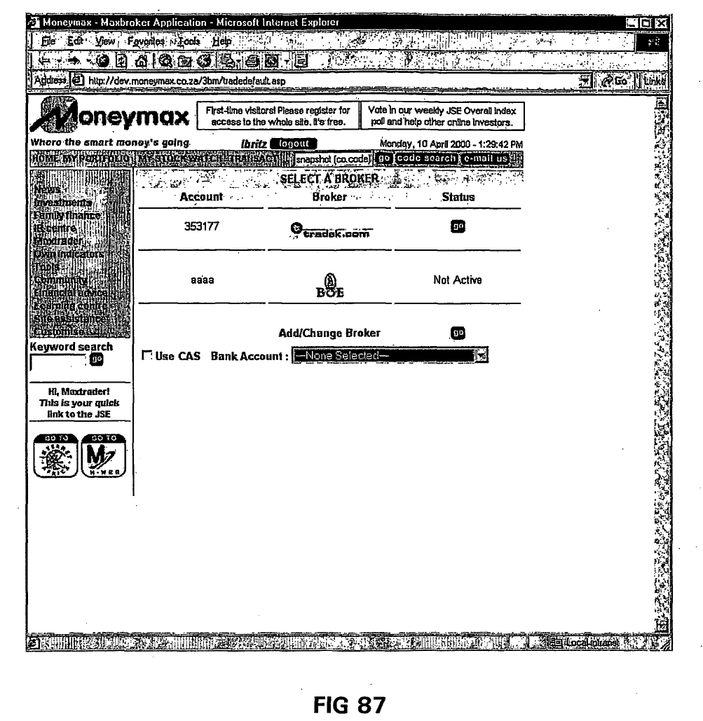

Flow: this page is reached from selecting MaxBroker from the TBM, Portfolio screen. Changes to the broker selection page (see FIG. 87) include the facility for choosing a TBM (not CAS) account to be used when purchasing shares. This setting over-rides the Bank details that the Broker account is related to. Again, if the Use TBM option is selected and the user is not logged onto TBM, a new login window will be opened. Upon successfully logging in, the Broker page will be refreshed and house the users TBM Bank details.

MaxBroker Trade Confirmation

The MaxBroker Trade Confirmation page (see FIG. 108) indicates if the user is paying by means of his TBM account, and the amount to be reserved. This transaction amount is calculated by a formula incorporating all charges and facilitating purchases at Market value. The TBM user may use the “Use Voucher” process button to take him through the voucher payment system. Once he has completed satisfying the funds required by the transaction, the trade order processing continues. This processing includes the broker interface. If the amount cannot be satisfied, the screen below will load, and display an appropriate message indicating the available funds and the required funds. The user then has the option to Edit his order. If the User chooses Process Order, the payment engine checks for available funds in the TBM account. If sufficient funds are available, processing of the trade continues. If such funds are not available, the payment engine will notify the user of insufficient funds and the funds that are available. The user will then be returned to the screen below. The user has the option to Edit his order.

Portfolio Browse (see FIG. 90) The Maxtrader/MaxBroker summarised portfolio information is displayed in a portfolio page. Together will other users information.

MaxBroker accounts and estimated outstanding values are displayed per broker, across his accounts for the broker.

Maxtrader Play portfolios will not be reflected in the consolidated position.

MAXBROKER accounts that have no investments will not be reflected.

The Maxbroker accounts will also state the date/time of when the data was received.

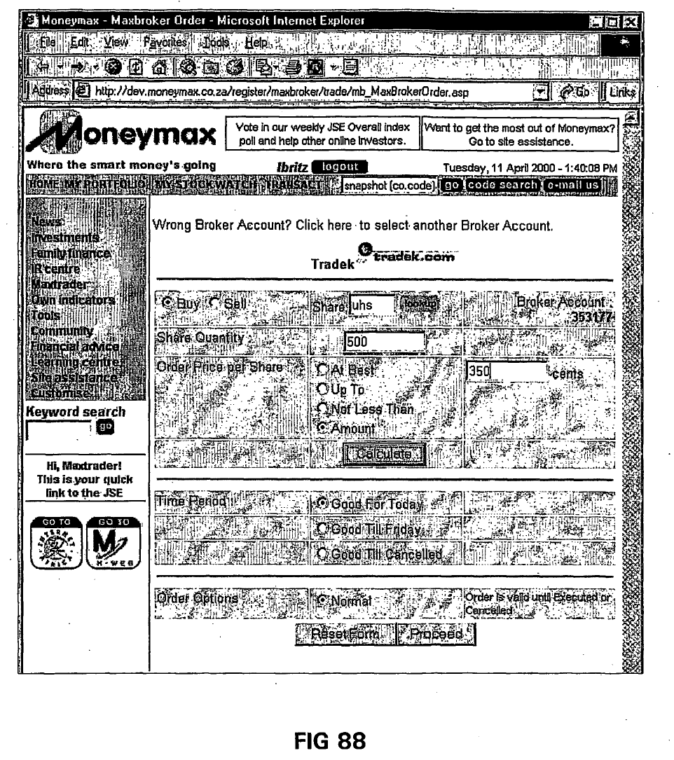

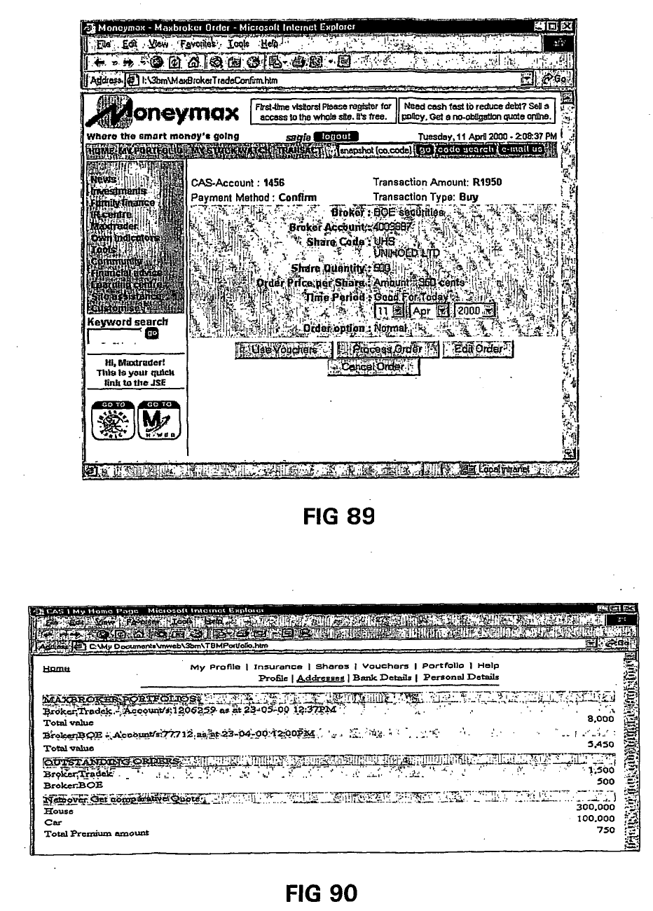

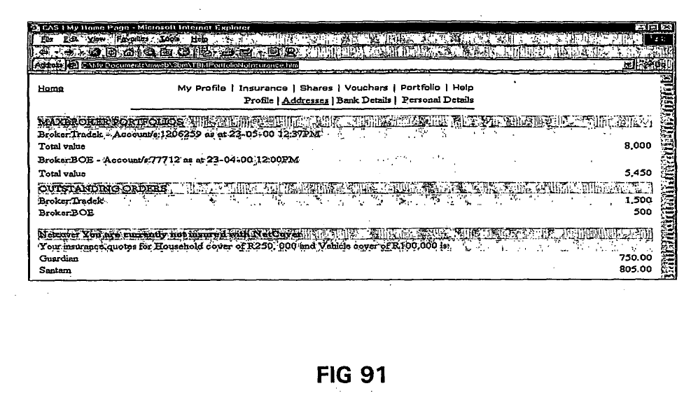

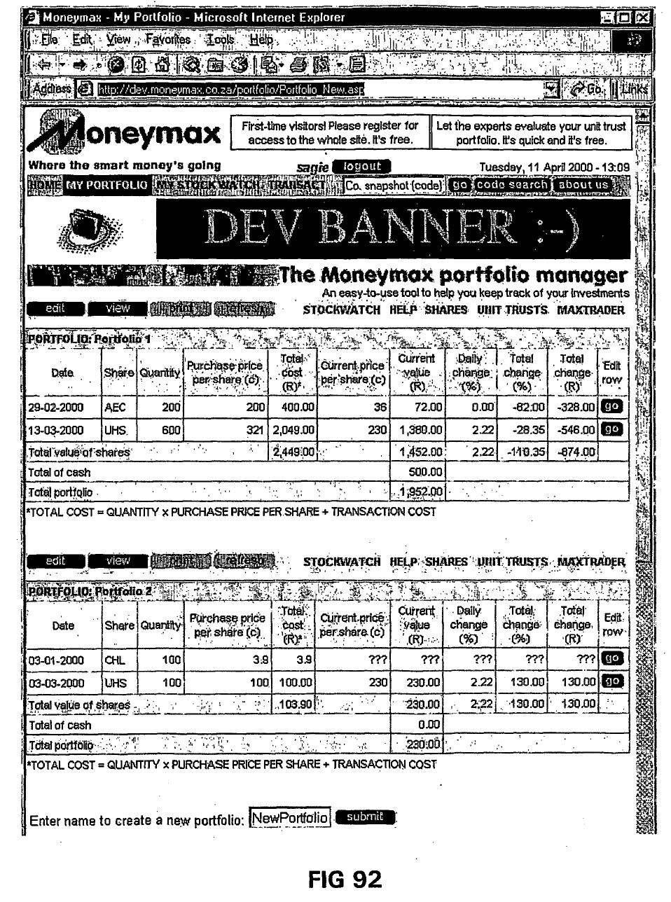

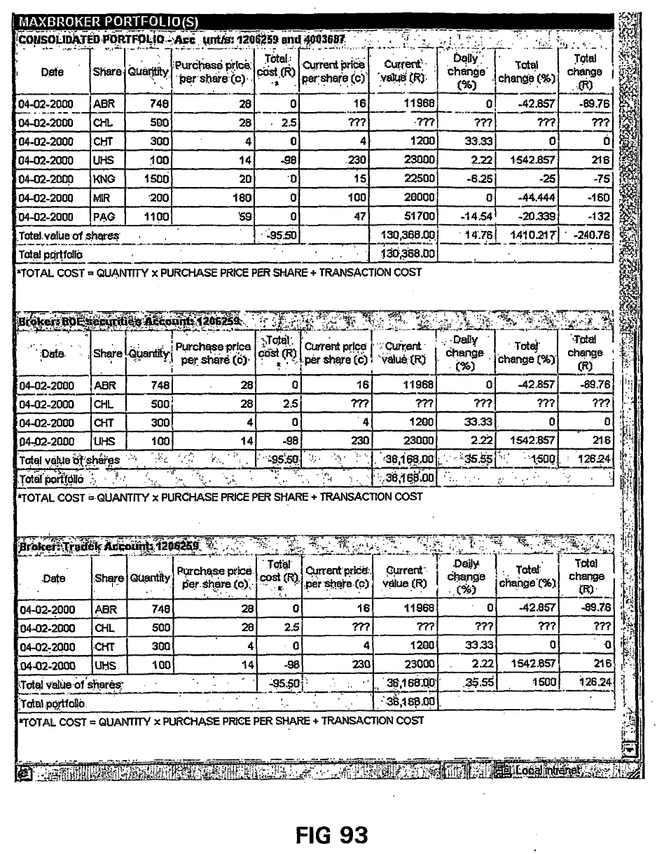

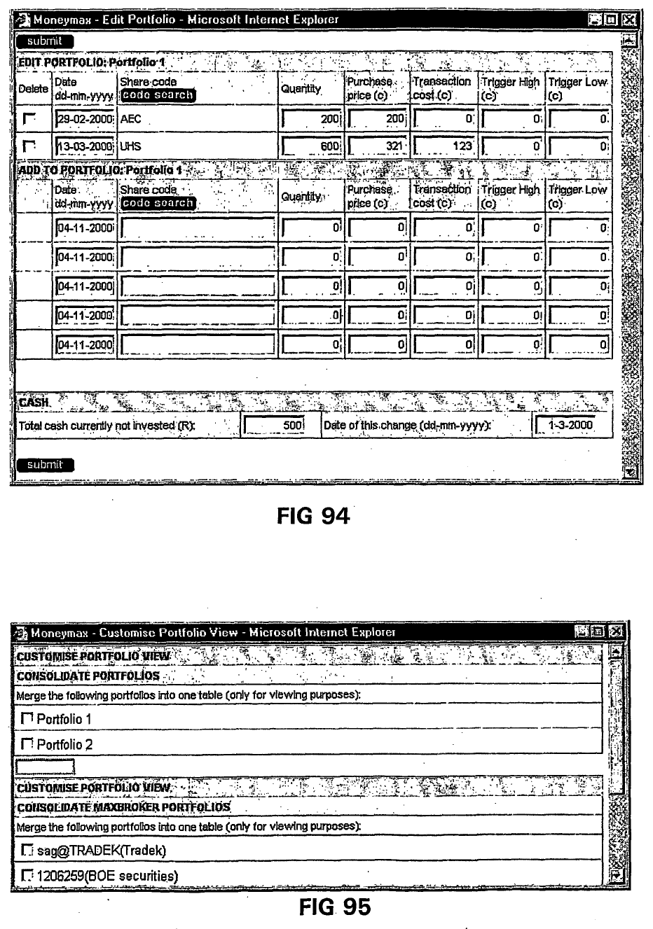

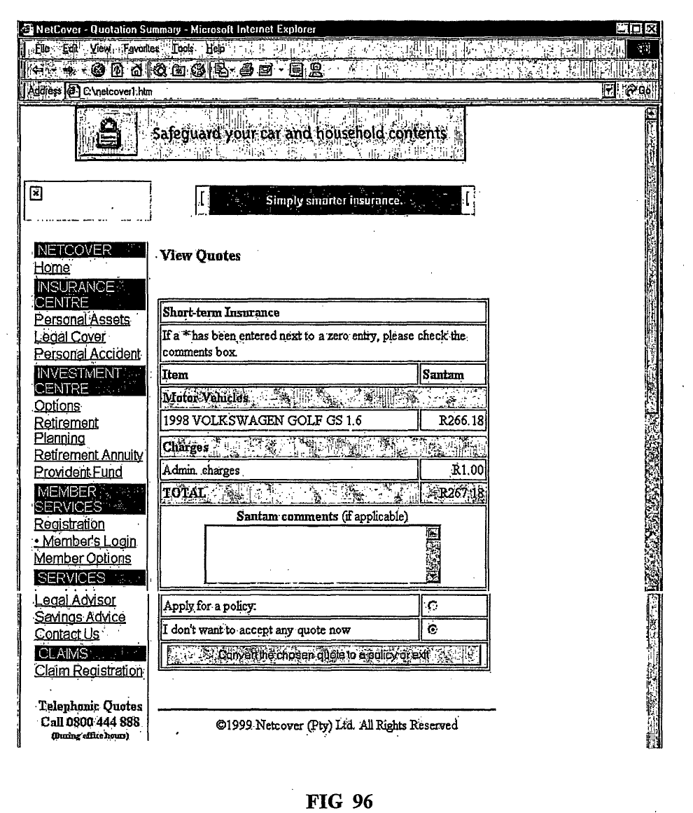

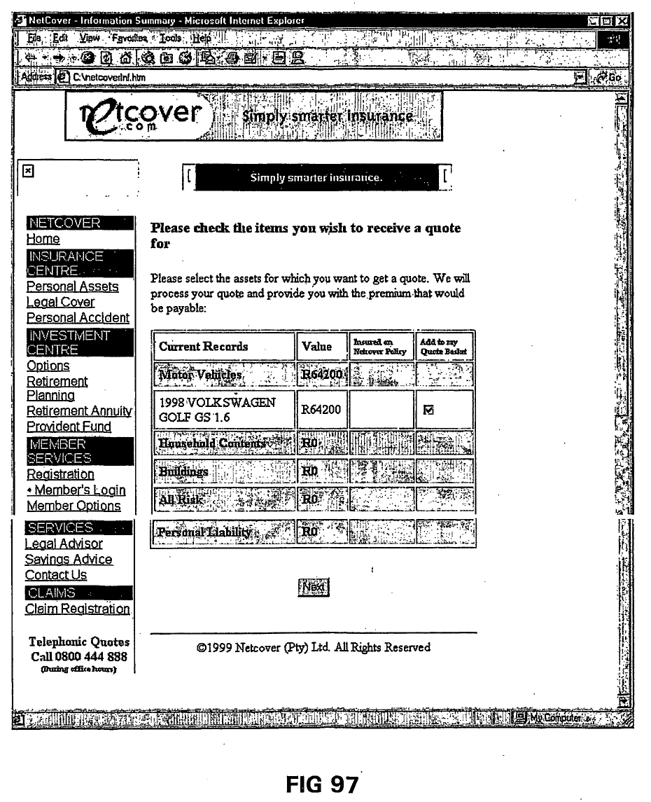

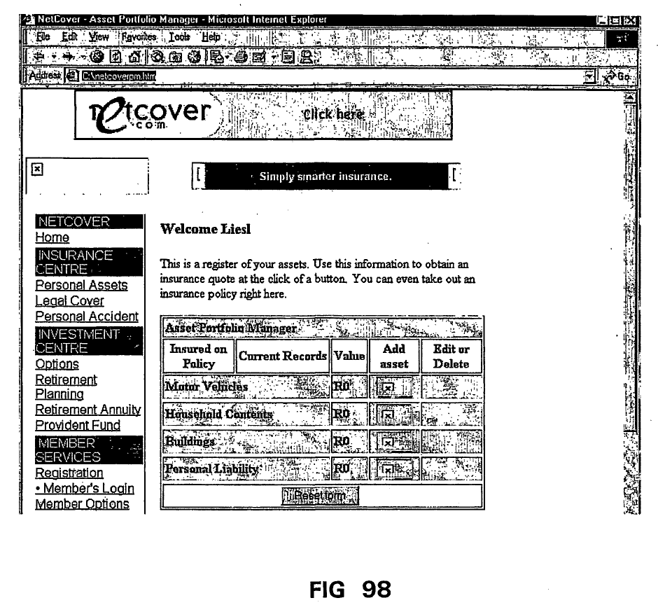

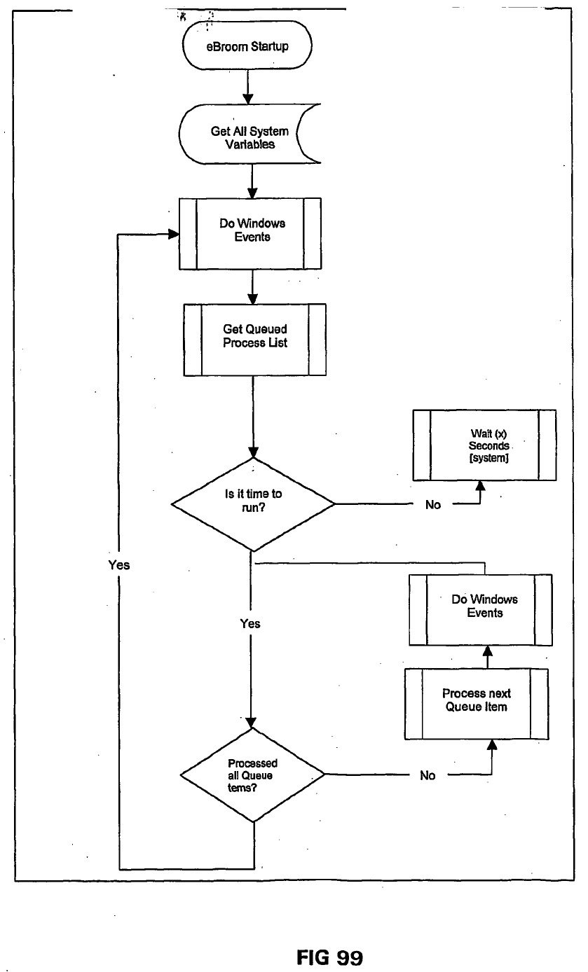

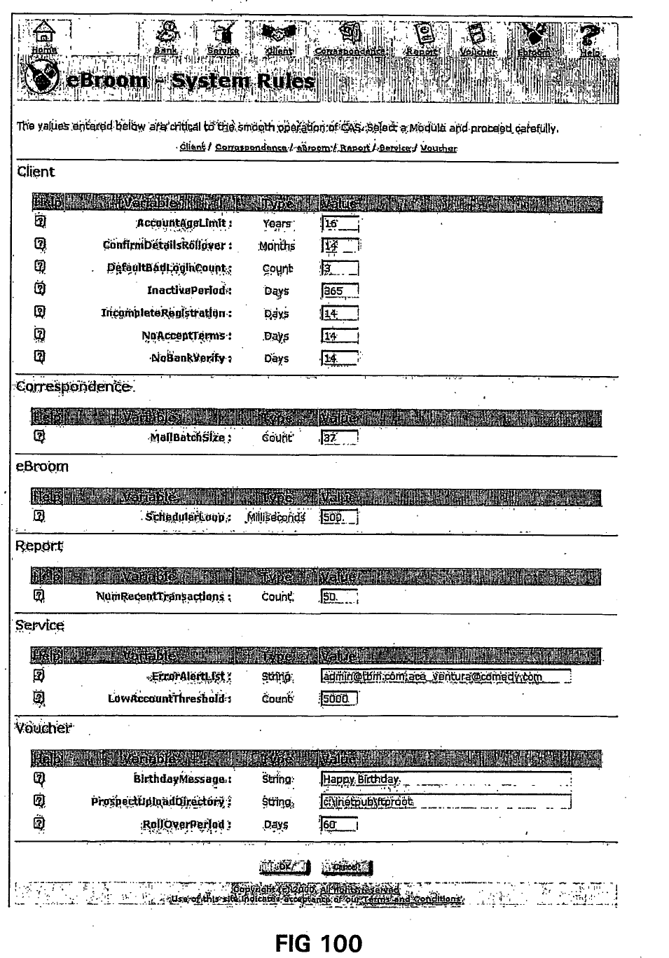

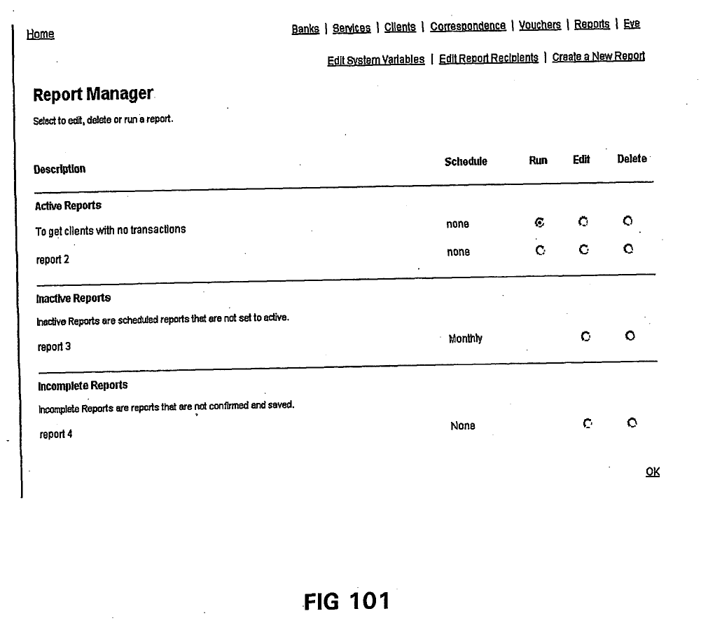

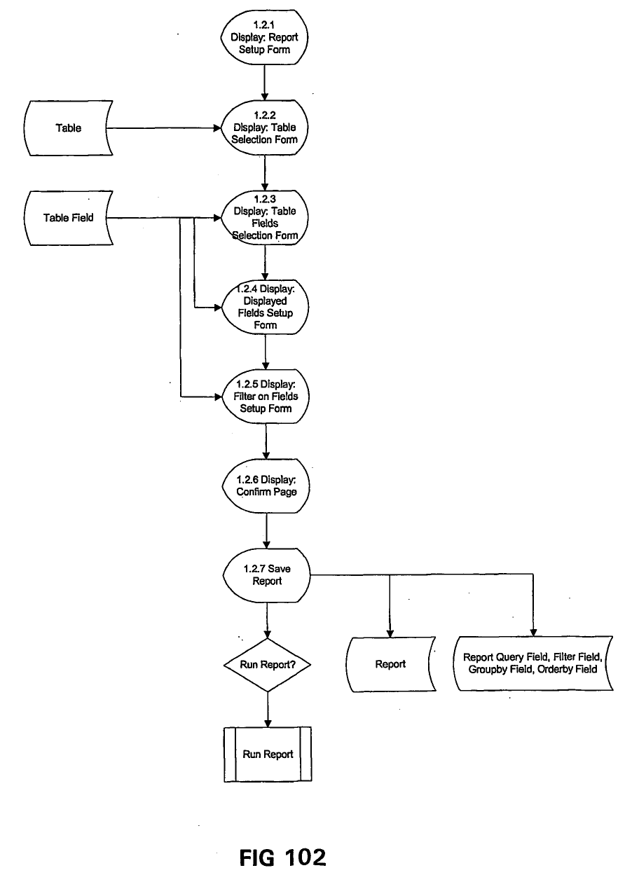

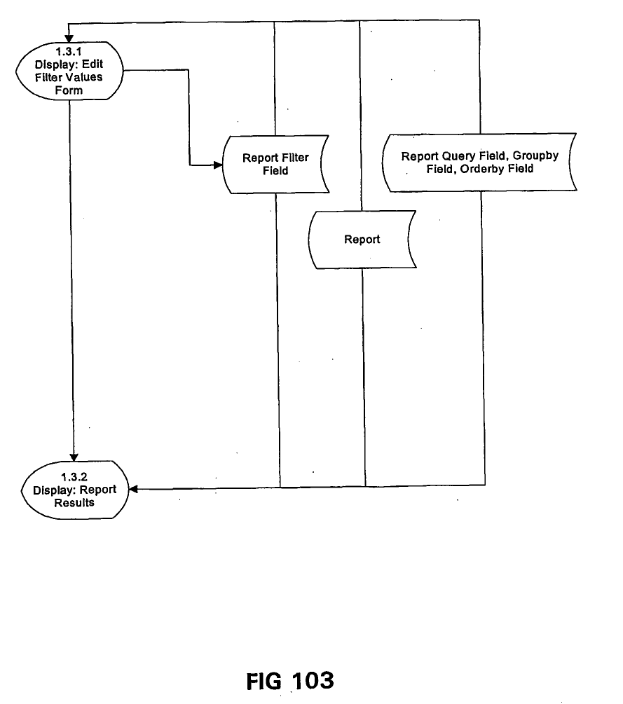

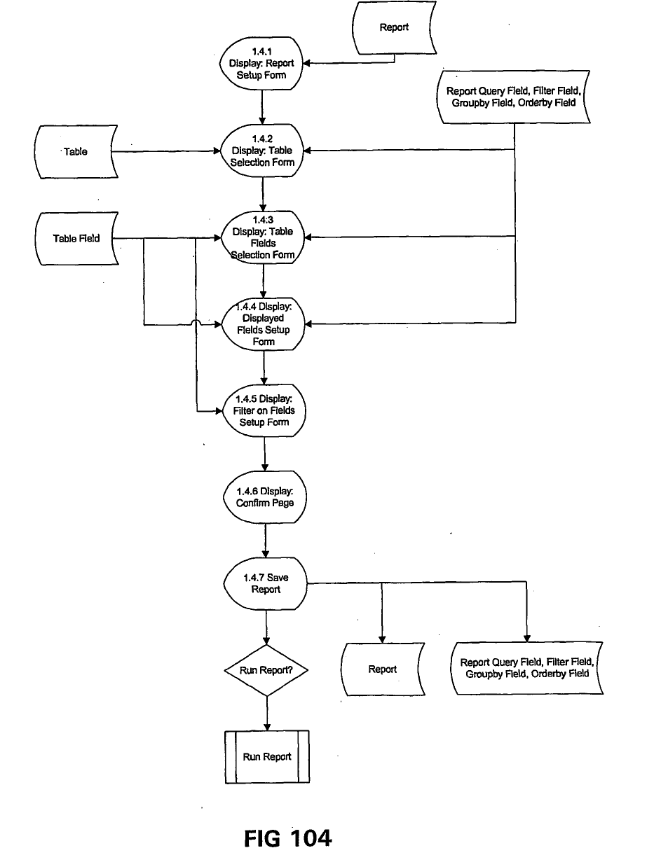

Netcover section: there is a link to the Netcover Comparative quote page if the client has Netcover insurance. If not, quotes for the client for specific cover (fixed amounts) are displayed (see FIG. 91). For example, FIG. 87 shows a screen layout of the stockbrokerage web site 26. FIG. 88 indicates a further screen layout of the stockbrokerage web site 26. If the user selects to make payment by means of their TBM account, the amount is then reserved. The user may select a use voucher button to allow payment using a voucher. Once the user has completed satisfying the funds required by the transaction, the trade order will then be processed. FIGS. 89 to 96 provide further screen layouts of the stockbrokerage web site 26. FIGS. 97 to 99 provide sample screen layouts of the system 10 when accessing the comparative insurance web site 28. The system 10 includes a housekeeping module or eBroom for scheduling various tasks relating to the vouchers, correspondence manager, service interaction, client administration, and reporting to clients. The eBroom module is responsible for the day to day housekeeping of the CAS database 88. The eBroom module is run on an SQL server and is run physically close to the back end database. Tasks performed by the e-broom module include mailing registration codes, forgotten passwords, password hints, or the like. Further, the eBroom maintains the CAS database 88 to ensure system integrity and acts as a mediator for modules when changes in one module would affect another module. The eBroom performs no business processes itself and is priority driven. Accordingly, all processes in the eBroom module are allocated a priority at a system level which determines which tasks are performed first and which tasks are run during off-peak times (see process overview in FIG. 100). An example of a screen layout for the eBroom module is shown in FIG. 101. As mentioned above, the system 10 also includes a report manager for generating various reports related to operation of the system 10. A default page (see FIG. 102) shows a list of existing reports and typically, an administrator selects to run, edit, or delete an existing report or alternatively create new reports. The report list is grouped into active reports 610, inactive reports 612 and incomplete reports 614 (Examples of screen layouts of the report manager are shown in FIGS. 102 to 104). The inventors believe that the invention, as illustrated, provides a new data processing system 10 with enhanced functionality.

1. A data processing system which includes a plurality of remote merchant servers of at least one merchant, which are operable to offer at least one of predetermined goods and services, to users of remote devices, online;
at least one remote banking institution server of at least one banking institution, which is operable to facilitate payment for goods and services which are purchased online from the merchant by users of the remote devices; and
a central computing facility including at least one central server which is operable to communicate with the remote devices and with the merchant servers and the banking institution server, the central server including a banking institution interface for interfacing with the banking institution server and a merchant interface for interfacing with the merchant servers, thereby to facilitate online transactions and communications between the banking institution, the merchant and the users of the remote devices, the central computing facility being operable to monitor data processing carried out between each remote device and the banking institution server and to retrieve user banking data relating to a particular user, from the banking institution and merchant transaction data from the merchant with whom the user transacts and to communicate the banking data and the merchant transaction data to a remote device that is accessible to the user, thereby to provide the user with a consolidated data position.

2. A data processing system as claimed in claim 1, wherein the central computing facility is operable to maintain a record of transactions carried out by users with the merchant servers and the banking institution server, the central computing facility including a user administration database in which said banking data and merchant transaction data pertaining to each user, is stored.

3. A data processing system as claimed in claim 1 or claim 2, wherein the merchant servers and the banking institution server are arranged in modules, thereby allowing merchant servers of different merchants and banking institution servers of different banking institutions to be added and removed from the system with relative ease.

4. A data processing system as claimed in any one of the preceding claims, wherein each merchant server has a system payment facility which when selected by a user to pay for goods or services, directs the user to the central server of the central computing facility which is operable to transmit an instructional message to the banking institution server to instruct the banking institution to reserve funds for the transaction.

5. A data processing system which includes a plurality of remote merchant servers of at least one merchant, which are operable to offer at least one of predetermined goods and services, to users of remote devices, online;
at least one remote banking institution server of at least one banking institution, which is operable to facilitate payment for goods and services which are purchased online from the merchant by users of the remote devices; and
a central computing facility including at least one central server which is operable to communicate with the remote devices and with the merchant servers and the banking institution server, the central server including a banking institution interface for interfacing with the banking institution server and a merchant interface for interfacing with the merchant servers, each merchant server having a system payment facility which when selected by a user to pay for goods or services, directs the user to the central server of the central computing facility which is operable to transmit an instructional message to the banking institution server to instruct the banking institution to reserve funds for the transaction.

6. A method of controlling data processing in a data processing system including a plurality of remote merchant servers of at least one merchant, which are operable to offer at least one of predetermined goods and services, to users of remote devices, online; at least one remote banking institution server of at least one banking institution, which is operable to facilitate payment for goods and services which are purchased online from the merchant by users of the remote devices; and a central computing facility including at least one central server which is operable to communicate with the remote devices and with the merchant servers and the banking institution server, the method including providing on each merchant server, a system payment facility which, when selected by a user to pay for goods or services, directs the user to the central server of the central computing facility which then sends a real-time instruction to the banking institution server to reserve funds required for the transaction.

7. A method as claimed in claim 6, wherein the central computing facility transmits an instructional message to the banking institution server to reserve funds for the transaction, whereafter the banking institution verifies the availability of funds for the transaction and if sufficient funds are available, reserves the funds required for the transaction and thereafter releases the funds to a designated payee to complete the transaction.

8. A central computing facility which includes at least one central server which is operable to communicate with a) a plurality of remote devices,
b) a plurality of remote merchant servers of at least one merchant which are operable to offer at least one of predetermined goods and services, to users of the remote devices, online,
c) at least one remote banking institution server of at least one banking institution, which is operable to facility payment for goods and services which are purchased online from the merchant by users of the remote devices, the central server including a banking institution interface for interfacing with the banking institution server and a merchant interface for interfacing with the merchant servers, thereby to facilitate online transactions and communications between the banking institution; the merchant and the users of the remote devices, the central computing facility being operable to monitor data processing carried out between each remote device and the banking institution server and each merchant server, and to retrieve banking data relating to a particular user, from the banking institution and merchant transaction data from the merchant with whom the user transacts and to communicate that banking data and the merchant transaction data to a remote device that is accessible to the user, thereby to provide the user with a consolidated data position.

9. A central computing facility as claimed in claim 8, which is operable to maintain a record of transactions carried out by users, with the merchant servers and the banking institution server, the central computing facility including a user administration database in which said banking data and merchant transaction data pertaining to each user, is stored.

10. A new data processing system substantially as described in the specification.

11. A data processing system substantially as described in the specification, with reference to and as illustrated in the accompanying diagrammatic drawings.

12. A new central computing facility substantially as described in the specification.

13. A central computing facility substantially as described in the specification, with reference to and as illustrated in the accompanying diagrammatic drawings.

14. A new method of controlling data processing substantially as described in the specification.

15. A method of controlling data processing substantially as described in the specification, with reference to and as illustrated in the accompanying diagrammatic drawings.
